(19) United States
(12) Patent Application Publication
(10) Pub. No.: US 2017/0011013 A1
(43) Pub. Date: Jan. 12, 2017

(54) ELECTRONIC FILE STRUCTURE, NON-TRANSITORY COMPUTER-READABLE STORAGE MEDIUM, ELECTRONIC FILE GENERATION APPARATUS, ELECTRONIC FILE GENERATION METHOD, AND ELECTRONIC FILE

(71) Applicant: Hiroyuki TANAKA, TOKYO (JP)

(72) Inventor: Hiroyuki TANAKA, TOKYO (JP)

(21) Appl. No.: 15/158,618

(22) Filed: May 19, 2016

(30) Foreign Application Priority Data
May 26, 2015 (JP) PCT/JP2015/065709
Jan. 12, 2016 (JP) 2016003253

(51) Int. Cl. G06F 17/22; G06F 17/24

(52) U.S. Cl. CPC G06F 17/2235; G06F 17/24

(57) ABSTRACT

Herein disclosed is an electronic file structure configured to include a setting region having a name of an anchor indicative of a predetermined location, and a name of a hyperlink that refer to the anchor, which are not present on the same file at an initial stage of generation, the setting region is independent from a material. A verbatim jump is enabled by combining a plurality of different electronic files respectively having higher segments of names of the hyperlinks and the anchors replaced in a round robin manner into one.

### CROSS-REFERENCE OF RELATED APPLICATION

The present application claims a right of priority from the PCT Application No. PCT2015/065709, filed on May 26, 2015, accepted by the Japan Patent Office as a receiving office, which is hereby incorporated by reference herein in its entirety. Furthermore, Patent-Literature 5 which is a prior art of the applicant was published on May 27, 2015 in the gazette, and thus the above-described application which is incorporated into the present application was filed on the date before the publication date of the earliest application in the Patent-Literature 5. Therefore, in regards to common part between the present application and PCT application 2015/065709 which serves as a basis for claim to priority, the time of determination of novelty and inventive step is the day before the publication date of gazette of Patent-Literature 5, and thus novelty and the like are not denied by reason of the presence of Patent-Literature 5. Further, with respect to expanded prior art effect (expanded novelty) as stipulated in “Japan Patent Act Article 29-2” based on the Patent-Literature 5 as well, the applicant (inventor) of the present application is identical to the applicant of Patent-Literature 5, and it cannot constitute a foundation to deny the novelty. Moreover, in regards to different part (part where identity to the above common part cannot be recognized) between the present application and PCT application 2015/065709 which serves as a basis for claim to priority, the time of determination of novelty and inventive step will be the filing date of the present application, but the present application has the very novelty and inventive step over the Patent-Literature 5, and the novelty and the like are not denied by reason of the presence of the Patent-Literature 5.

In Japanese application, based on which the present application claims priority right, names of hyperlinks (the term “a name of a hyperlink” will be defined in [0049]) and anchors have been described by using a variety of fonts specific to the application in Japanese language. However, the font representable in the present English application is restricted since the present application is filed in English and examination will be carried out in English. For example, Japanese full width characters are not representable in the English application. In this occasion, it would be possible to paste such characters, which cannot be represented in English, on the specification as images, but those pasted characters would become apparent at different positions from their original positions in the specification, and therefore they might often suspend readers from understanding. Thus, the applicant decided to accept the restrictions of the English application in terms of the fonts, and widely modified the notations used in the Japanese specification. For example, upon attaching < > which suggests tags of XML and describing names of hyperlinks and anchors therein, full width characters were replaced with half width characters as follows. A Japanese full width character <ₒ> was modified to <°>, and another Japanese full width character < [symbol] > was modified to <^{a}>. A Japanese full width character < [symbol] > which suggests a short table of contents was modified to <table>, and another Japanese full width character < [symbol] > which suggests a long table of contents was modified to <TABLE>. Furthermore, a Japanese full width katakana character < [symbol] > which suggests regulation was modified to <‡>. Therefore, wordings in the specification differ from those appearing in drawings. Since the invention is a technical idea, the applicant states in advance that there is no need to carry out the thus modified characters merely in Japanese fonts similarly to embodiment(s) described later, and it is also possible to carry out the modified portions with half width characters in place of full width characters, when implementing the present invention. This means, <°><^{a}> are merely illustrations, and any characters, for example, <¹><²><³> or others may be applicable. However, it is to be noted that, since character strings such as those shown in FIG. 9G are repeated regularly, the number of characters increases.

### BACKGROUND OF THE INVENTION

1. Field of the Invention

The present invention relates to an electronic file structure that enables a user to multilaterally jump by automatic creation of hyperlinks and anchors therein, an electronic file generation apparatus and an electronic file generation method for generating the electronic file, and a non-transitory computer-readable storage medium having stored therein a computer program for controlling the electronic file generation apparatus.

### COPYRIGHT RESERVATION

All or any part of documents disclosed for the purpose of this patent application is protected by the Copyright Law. Therefore, any document (s) or publication (s) created by translating all or any part of the specification, claims, and drawings attached to the present application without prior permission of the applicant who is an author of the specification, claims, and drawings attached to the present application is an infringement of the copyright. Further, →E is a trademark of the applicant registered in Japan, Europe, China and Russia.

2. Description of the Related Art

(Role of Hyperlink)

With a technique known as hyperlinks, a text or an image in a specified range of a material of an electronic file is associated in advance with an anchor location in another electronic file or an another location in the same electronic file, and when the text or image in the designated range is selected by a viewer, the display screen jumps to a concerned location of the material referred to by the anchor that should be compared and/or associated with the text or the image. Such a hyperlink can be embedded in the material, and allows the viewer viewing the display screen to instantly jump to the concerned location having rich information or supplemental information of the material, thereby assisting the viewer in understanding the material.

(Method for Creating Anchors and Hyperlinks)

Although the methods for creating anchors and hyperlinks are different from each other depending on software to be used, it is known that document creators can create hyperlinks and anchors with Microsoft (hereinafter, MS) Word (registered trademark), which is well-known electronic file creating software as disclosed in a URL of Non-Patent Literature 1, for example, by carrying out the following steps 1 to 8 in the Word document. MS Word as used herein may include MS Word 2007 or later version compatible with XML as well. While implementing the present invention disclosed in the present application, there is no particular difference in handling between MS Word 2007 or later version and MS Word 2003 or earlier version. A bookmark is intended to mean an anchor on MS Word, but not limited thereto.

### “Inserting a Bookmark”

In the current document, performing the following operations:
Step 1: Select a character string or item to which a bookmark should be assigned to, or click on where a bookmark should be inserted.
Step 2: On the [Link] in the [Insert] tab, click [Bookmark].
Step 3: Under [Bookmark Name], type a name.
Both characters and numbers can be used for the bookmark names, but no number can be used for the first character. Also, no space can be used. However, name can be divided by using an underscore (_) in such a manner, for example, “First Chapter_heading”
Step 4: Click [Add] to add a link.
Step 5: Select the character string or object that should be displayed as the hyperlink.
Step 6: Click with a right-button of mouse, and then click a button image (Hyperlink) on the shortcut menu.
Step 7: Click [within this Document] as [Link Destination].
Step 8: In the list, select the heading or bookmark at the link destination.

(TOC Switch)

Non-Patent Literature 2 discloses a TOC (Table of Contents) switch which allows a user to jump to a specific location of the material related to the table of contents.

(The Concept that Names should Follow the Attribute Rules)

Non-Patent Literature 3 mentions that the names of hyperlinks and anchors in the web must be created according to the attribute rules. Non-Patent Literature 3 describes that ID and NAME tokens must start with a letter ([A-Za-z]) and may be followed by any number of letters, digits ([0-9]), hyphens (“-”), underscores (“_”), colons (“:”), and periods (“.”). This description means that ID and names must start with a letter A or the like, and may be followed by any number of letters, digits ([0-9]), hyphens (“-”), underscores (“_”), colons (“:”), and periods (“.”). As will be seen from this description, numeric values are frequently restricted.

(The Way of Management of Names)

In an XML format electronic file, anchors may be managed by not only names but also numeric IDs. The names may start with ABC and so on created by a creator of the electronic file, whereas the IDs are available in two types. One type of the ID is a number automatically assigned to each of electronic files by a schema in accordance with the XML specification. The files are numbered with natural numbers starting with 0 in accordance with a forward or backward location within a file. The processing is carried out mechanically. Another type of ID is a fixed ID that replaces the name. For example, in the case of MS Word, the management is performed by names and automatically numbered IDs (names and ids in FIG. 15).

(Relationship with External Links Using ASCII)

The Web has been developed centering on external links, and URL has been designed using ASCII characters as the principal components. While hyperlinks mainly serve as external links for making references to different documents, an internal link that makes references to documents or the like within the same file. The internal link tends to be subordinate to the external links.

(Prior Patents Disclosed in Patent Literatures 2 to 5)

There are provided a plurality of patents which disclose an idea of automatically creating hyperlinks. Patent Literature 2 discloses a process of creating hyperlink and anchor texts based on relevance of words and phrases. Patent Literature 3 also discloses a process of performing the same processing targeted for advertisements on Web. Patent Literature 4 discloses a process of automatically creating hyperlinks in multimedia files. Patent Literature 5 discloses a process of automatically creating anchors. This disclosure relates to a technology of automatically creating names of anchors based on search inputs into search engine.

(Non-Patent Literature 4)

Non-Patent Literature 4 (PDF that contains comparisons made by Europe Patent Office among the texts of EPC in English, German, and French) discloses an attempt to compare the texts of EPC with one another in respective languages by dividing a screen into two sections at left and right.

(Patent Literature 1)

Patent Literature 1 discloses an idea how to array names in ascending order based on the name rules. However, a large number of names are necessary to allow a user to multilaterally jump to a plurality of target locations. Patent Literature 1 fails to describe how to create the names so as to proliferate a large number of names. Furthermore, Patent Literature 1 fails to disclose combinational jumps utilizing the plurality of names.

Patent Literature 1 discloses a method of editing names of hyperlinks after opening field codes in the paragraph [0057] onwards, and further a method of operating anchors based on XML in the paragraph [0061] onwards. However, Patent Literature 1 does not disclose a replacement method of how names of hyperlinks and names of anchors should be replaced in order to effectively establish multilateral jump functions between them. This means that Patent Literature 1 fails to disclose a replacement method of how to replace names so as to enable multilateral jumps among the plurality of links. Here, the jump, jumping or jump function herein referred to is intended to mean an action or a function which allows a reader or a user to jump from a location to another location. The multilateral jump, jumping or multilateral jump function herein referred to is intended to mean an action or a function which allows a reader or a user to jump multilaterally from a location to another location.

### CITATION LIST OF PRIOR ART LITERATURES

### Patent Literatures

[Patent Literature 1] WIPO WO/2005/066834
[Patent Literature 2] U.S. Pat. No. 7,617,121
[Patent Literature 3] U.S. Pat. No. 5,794,257
[Patent Literature 4] WIPO WO/2005/066846
[Patent Literature 5] JP2014-161614

### Non-Patent Literatures

[Non-Patent Literature 1] http://office.microsoft.com/ja-jp/Word-help/Ha010165929.aspx (Searched on Nov. 23, 2015)
[Non-Patent Literature 2] http://documents.epo.org/projects/babylon/eponet.nsf/0/00E 0CD7FD461C0D5C1257C060050C376/$File/EPC_15th_edition_2013.pdf (Searched on Jan. 9, 2016)
[Non-Patent Literature 3] http://www.w3.org/TR/html401/types.html#type-cdata (Searched on Jan. 9, 2016)

### SUMMARY OF THE INVENTION

### Problems to be Solved by the Invention

There are problems to be solved by the present invention as described below.

(Problem 1: Configuration 1; Configuration 5; Configuration 7 (A); Configurations 13 to 17: Automatic Generation of Both Anchors and Hyperlinks at the Same Time)

For some time past, there has been a problem that it has been not possible to automatically generate both anchors and hyperlinks at the same time. More specifically, it has been not possible to allow both anchors and hyperlinks to provide jump functions so that a user can not only jump from a location designated by a hyperlink to a location designated by an anchor but also return from the location designated by the anchor to the location designated by the hyperlink easily at the same time without any restriction. Furthermore, there has been a problem that there is not provided such an electronic file which can solve the above-mentioned problems.

(Problem 2: Configuration 2: Reliable Conversion Focused on Only Some Sections or Segments of Names)

Furthermore, it is facilitated to reuse names of already completed hyperlinks and anchors if the names of the already completed hyperlinks and anchors can be easily changed. According to the present invention, even though files including hyperlinks and/or anchors having names and files including the hyperlinks and/or anchors having names partially changed from the original names are combined together, the jump functions can be maintained as they are (see 6.40). In addition to this, the number of tags of hyperlinks and anchors in XML is greater than the number of those in HTM, and thus it is impossible to visually read and check the names of hyperlinks and/or anchors. Under these situations, a question arises as to how to ensure that error-free conversion can be performed focused on only a section or segment, i.e., a part of a name of each of hyperlinks and/or anchors, without exerting any influence on the material.

(Problem 3: Configuration 3: Method of Facilitating Check of Names)

There is available a technique of mouse-over. By moving a mouse over characters or the like of a material in an electronic file, the mouse-over is carried out and names of hyperlinks behind the characters appear. However, this method is not efficient since the mouse is required to be placed on a target location of the hyperlink at which a user would like to read or check. Also, the name of the hyperlink can be read only around the location where the mouse is placed.

Furthermore, if the above-mentioned problems can be solved, it becomes possible to automatically generate a large number of hyperlinks. This means that it becomes necessary to check a large number of hyperlinks more efficiently and more easily with a method different from the mouse-over. Then, a question arises as to how it is possible to solve the above-mentioned problems and to create a suitable electronic file. Under these circumstances, a question arises as to how to create an electronic file which can solve the aforementioned problems.

(Problem 4: Configuration 4: Configuration 6: Configuration 11: Creation of Names that are Hard to be Falsified)

In recent years, more importance is placed on authenticity of documents. Thus, it is desirable to create a hyperlink structure in an electronic file that is hard to be falsified (10.61.01). A question arises as to how it could be realized to create names hard to be falsified.

(Problem 5: Configuration 7(B): Automatic Generation of Files in which Materials in Multiple Languages can be Compared in an Easy-to-Read Way)

It would be quite convenient if a material could be examined multilaterally. However, a conventional screen has a configuration, for example, as shown in Non-Patent Literature 3 (PDF that contains comparisons among the texts of European Patent Convention, hereinafter referred to as “EPC”, made by European Patent Office, in English, German, and French). For the sake of comparison, the EPC texts on the screen are divided into left and right for English and German and arranged by Articles, by Rules, or the like. This sort of screen makes it easy for a user to compare the English texts with the German texts by Articles, by Rules or the like. However, French texts are singly arranged at pages different from English and German texts, and displayed separately from them. Furthermore, nothing is displayed on the screen opposite from the French texts, thereby making it difficult for a user to read and compare the French texts with other texts. Then, a question arises as to what should be done to make such texts of multiple languages easy to be seen.

(Problem 6: Configuration 7(C): Automatic Creation of Files which can be Examined from Multilateral Points of View)

Furthermore, in recent years, viz., so-called Multiculturalism Age, since traffic means and communication means have progressed, rich Websites that can explain information with multiple languages are needed. For example, there are many foreigners in a town where the applicant lives. Since the way of putting garbage out, the way and date of collecting the garbage, are different from community to community, there is a desire to create Web pages where people can communicate and share information with one another. Electronic files using hyperlinks and anchors that can explain from such multilateral perspectives need to be created. Then, question arises as to how to create such appropriate electronic files.

(Problem 7: Configuration 7(D): Automatic Creation of Jumps Covering all Multilateral Links)

Some hyperlink destinations in different files may refer to unexpected or undesired (non-related) articles, and may take user's time unnecessarily. However, if the hyperlinks are formed extensively over materials so as to cover all multilateral links, and if the hyperlinks may cause s user to anticipate jump destinations, the user can be freely navigated back and forth between the materials, thereby making it possible for a user to understand and/or for a creator to convey complex information in any languages on an extremely accurate basis. As a result thereof, the values of hyperlinks and the material synergistically increase. However, it is found, when an attempt is made to actually create such files manually, each time materials to be referred is incremented by one, the number of multilateral links is increased at a considerable pace. In the case in which the number of references to be covered by jump functions is increased in this manner, it is no longer possible to handle such hyperlinks manually. This means that such a great number of hyperlinks are required to be created automatically. Then another question arises how such a great number of hyperlinks or jump functions could be created.

(Problem 8: Configuration 8: Individual Instructions from Users)

If creation, addition, or deletion of hyperlinks can be performed upon receiving instructions individually from a user in a manner other than the automatic generation by the generating apparatus, it will be convenient even for maintaining such a multilateral view system. Again, a question arises as of how it should be made possible.

(Problem 9: Configuration 9: Replacement of Names that Enables Jump Functions)

Even if hyperlinks and anchors could be automatically created in electronic files, there would be no meaning unless jump functions thereof are established and enabled. A question arises as of how names should be replaced in an order that jump functions can be automatically created on an electronic file.

(Problem 10: Configuration 10: Requirement to Create a Stable Display Area where a User can Compare and Examine Texts Even while Operating Smartphones)

A Screen of a recent smartphone has a small display area. For this reason, by dividing the screen into left and right sections, information can be compared and examined on the left and right screen. In such a case, viewable regions become narrow, accordingly, characters displayed on the regions become small, and as a result, the screens become difficult to be seen. A question arises as to how it is possible to create such table screens that allow a user to compare and examine materials on smartphone.

(Problem 11: Configuration 12: Requirement to Produce in Large Amount of Hyperlinks and Anchors in a Short Time)

It is required to automatically generate hyperlinks and anchors in a short time. The automatic generation includes an implicit expectation that names are replaced automatically in a large scale. A question arises as to how the hyperlinks and anchors could be generated. In particular, a question arises as to how to create such complicated regions as shown in the setting region 4 in FIG. 1 disclosed in Patent-Literature 5, hereinafter simply referred to as “verbatim”, which allows a user to jump to the materials in different languages, efficiently to the degree thoroughly eliminating useless time. Patent-Literature 5 is the invention of the present applicant.

### Means for Solving Problems

In view of the above-described backgrounds, the present invention has the following configurations in order to solve the above problems.

(Configuration 1: Independent Claim: Structure)

An electronic file structure (FIG. 2) according to the present invention is configured to include a setting region having a name of an anchor indicative of a predetermined location, and a name of a hyperlink that refer to the anchor, which are not present on the same file at an initial stage of generation, the setting region is independent from a material, wherein a verbatim jump is enabled by combining a plurality of different electronic files respectively having higher segments of names of the hyperlinks and the anchors replaced in a round robin manner into one (12.60).

(Configuration 2: Dependent Claim: Growth Points (11.70))

In the electronic file structure according to the present invention, by utilizing the fact that names of the anchors and the names of the hyperlinks are divided into several segments and having “growth point(s)”, when the segment of the name is changed (6.40), an existing segment is changed by selecting the segment having the growth point, and adding a new segment thereto (10.32).

(Configuration 3: Dependent Claim: Auto Word Wrap Function (11.10))

In the electronic file structure according to the present invention, when the names of the hyperlinks in verbatim regions are opened from field code side, character strings of the names of hyperlinks are aligned by means of auto word wrap function so that the differences among the character strings are properly laid out. This means that character strings of the names of hyperlinks can be viewed so as to be aligned in a way which is easy to find their difference through auto word wrap function (5.80.02).

(Configuration 4: Dependent Claim: Prevention of Falsification (10.60))

In the electronic file structure according to the present invention, a part of the names of anchors and a part of the names of hyperlinks in verbatim regions employ character types the use of which is prohibited by World Wide Web Consortium.

(Configuration 5: Independent Claim: Non-Transitory Computer-Readable Storage Medium for Storing a Computer Program)

A non-transitory computer-readable storage medium for storing a computer program for controlling an electronic file generation apparatus operative to generate an electronic file structure configured to include a setting region having a name of an anchor indicative of a predetermined location, and a name of a hyperlink that refer to the anchor, which are not present on the same file at an initial stage of generation, the setting region is independent from a material, wherein a verbatim jump is enabled by combining a plurality of different electronic files respectively having higher segments of names of the hyperlinks and the anchors replaced in a round robin manner into one.

(Configuration 6: Dependent Claim: Prevention of Falsification (10.60))

In the non-transitory computer-readable storage medium for storing the computer program for controlling the electronic file generation apparatus according the present invention, a part of names of anchors and a part of names of hyperlinks in a verbatim region employ character types the use of which is prohibited by World Wide Web Consortium.

(Configurations 7(A) Through 7(D): Independent Claim: Apparatus)

An electronic file generation apparatus operative to combine a plurality of electronic files into one, thereby enabling a verbatim jump is enabled multilaterally. The electronic file generation apparatus comprising: a name generation unit operative to generate, in a source electronic file, a verbatim setting region having a name of an anchor allowing a user to be jumped to from a hyperlink to be set up in a destination electronic file that has not yet been created at an initial state, but will be combined with the source electronic file into one through final combination, and a name of a hyperlink allowing a user to jump to the destination electronic file that is not yet created at the initial state, but will be combined into one through the final combination; a name proliferation unit; a name changing unit operative to execute round robin proliferation of higher segment to the names; a storage unit operative to store a plurality of electronic files that have been changed by the name changing unit; and a final combining unit operative to execute final combination of the plurality of the electronic files stored in the storage unit into one electronic file. Upon the final combination, the names of the hyperlinks and the names of the anchors are combined with each other (6.70), thereby enabling verbatim jumping among the setting regions.

(Configuration 8: Dependent Claim: Individual Instructions from Users)

The electronic file generation apparatus according to the present invention, further comprising: an instruction information receiving unit (6.10) operative to receive any of a setting region generation instruction, a proliferation instruction, a name changing instruction, an evacuation setting instruction, a save instruction, a combination instruction, and a final combination instruction from a user.

(Configuration 9: Dependent Claim: The Name Changing Unit (12.22.02))

In the electronic file generation apparatus according to the configuration 7, while the round robin proliferation of higher segment is executed by the name changing unit, the names of the hyperlinks belonging to a hyperlink groups in the verbatim region excluding a link of interest are replaced in a manner such that, a name of a hyperlink which becomes the same as a name of an anchor is excluded from the hyperlinks group and a name of a hyperlink which has been previously excluded from the hyperlinks group is restored at a position at which the previously excluded hyperlink has been placed upon processing carried out in an increasing order of an character code of the hyperlinks group of the verbatim, and a new verbatim is created sequentially on a new electronic file while the hyperlinks are excluded and restored one after another.

(Configuration 10: Dependent Claim: Desired to Create Display Area that Allow Users to Mutually Compare and Examine Materials on Smartphones)

In the electronic file generation apparatus according to the present invention, the verbatim setting region is copied to another file in a manner that the hyperlinks are arrayed in an order (7.01) that anteroposterior relationship among the hyperlinks in the setting region is not reversed.

(Configuration 11: Dependent Claim: Prevention of Falsification (10.60))

In the electronic file generation apparatus according to configuration 7, a part of the names of anchors and a part of the names of hyperlinks in verbatim regions may employ character types the use of which is prohibited by World Wide Web Consortium.

(Configuration 12: Dependent Claim: Large Volume Production in a Short Time Period (6.20))

The electronic file generation apparatus according to the present invention is the electronic file generation apparatus according to configuration 7, further comprising: a name proliferation unit operative to create one file by combining data before change and data after change.

(Configuration 13: Independent Claim: Method)

An electronic file generation method comprising the steps of: generating, in a source electronic file, a verbatim setting region having a name of an anchor allowing a user to be jumped to from a hyperlink to be set up in a destination electronic file that has not yet been created at an initial state, but will be combined with the source electronic file into one through final combination, and a name of a hyperlink allowing a user to jump to the destination electronic file that is not yet created at the initial state, but will be combined into one through the final combination; proliferating names; executing round robin proliferation of higher segment to the names; storing a plurality of electronic files that have been changed by the name changing unit; and executing final combination of the plurality of the electronic files stored in the storage unit into one electronic file, wherein upon the final combination, the names of the hyperlinks and the names of the anchors are combined with each other, thereby enabling verbatim jumping among the setting regions.

(Configuration 14: Dependent Claim: End Users)

An electronic file according to the present invention is an electronic file which is generated in accordance with the electronic file structure according to any one of configurations 1 to 4.

(Configuration 15: Dependent Claim: End Users)

An electronic file according to the present invention is an electronic file generated by executing the computer program stored in the non-transitory computer readable storage medium according to any one of configurations 5 to 6.

(Configuration 16: Dependent Claim: End Users)

The electronic file according to the present invention is An electronic file generated by the electronic file generation apparatus according to configurations 7 to 12.

(Configuration 17: Dependent Claim: End Users)

The electronic file according to the present invention is an electronic file generated by the electronic file generation method according to claim 13.

### Advantageous Effects of the Invention

The present invention not only allows hyperlinks and anchors in electronic files to be automatically created, but ensures that jump functions provided by the hyperlinks and anchors is enabled. For this purpose, the present invention provides infinite switches serving as industrial switches consisting of hyperlinks and anchors in the field of digital field. This means that, if anchors are assumed to be street numbers, names of the hyperlinks and anchors may be infinitely and automatically assigned as street numbers while the street numbers are managed digitally. The applicant intends to carve out ages when the street numbers can be digitally referred by the hyperlinks. In this manner, many pieces of digital data are shifted from descriptive data written without spaces where the hyperlinks are not present, to data manageable in the circulation of the hyperlinks and the anchors that are automatically created and provide jump functions.

For example, in a case of a law book, even if definitions, requirements, purports, and effects of one provision are separated by several hundred pages, a user easily refer to and carefully read each of them by means of multilateral links. Therefore, it is possible to realign the contents of the law book in the order of, for example, definition, requirements, purports utilizing a multilateral jump at user's disposal operating hyperlinks and anchors arranged in verbatims or sciences. For example, it is possible to repeatedly read and intensively memorize the definition. It is possible to compare and examine necessary and sufficient properties of the requirements. Furthermore, the purports alone can be independently used for checking similarity and singularity of the continuously described purports. The effects alone can be independently used for organizing commonality and differences among systems having similar effects from continuous description of effects. In this way, law books can be replaced with database of law books that allow a user to easily make references utilizing hyperlinks and anchors.

For example, taking an e-book as an example, the way of reading may change in such a way of relaxed reading. A user may turn pages in such away of reading as quickly and repetitively switching using a multilateral jump function provided by hyperlinks and anchors, purposefully and reasonably aiming at deepening understanding of a particular matter. This means that the value of literatures may change from a means for sequential reading and understanding to a means for allowing a reader to think while comparing and making references using hyperlinks as a simple collection of knowledge or information.

The setting regions of hyperlinks and anchors according to the present invention can be created automatically, and as a result, the need to take much labor to create regions one by one can be eliminated. In this case as well, the present invention revolutionizes a display method. For example, conventionally, displays of multinational treaties or conventions in multiple languages were handled by displaying a screen divided into left and right parts. However, the present invention is applicable to database, and it is possible to allow a user to multilaterally jump from one material to another materials of, for example, other languages, while maintaining a visual position of a screen region as it is. Therefore, if the present invention is applied to smartphones launched in recent years, it is possible to allow a user to intensively compare and examine information with other contained in database by multilaterally jumping one material to another even though the screens of the smartphones are limited in size.

### DEFINITION

(0.00 Definition and Precondition; Names)

In the present specification, a hyperlink does not have any name. However, it is too long to mention a name of a destination anchor of the hyperlink. Therefore, the destination anchor of the hyperlink is sometimes referred to as the “(underlying) name of the hyperlink”. A jump function is enabled when a name of an anchor is designated as a destination of a hyperlink. Therefore, in the present specification, “A jump function is enabled when names of a hyperlink and an anchor coincide”. Also, a text of the hyperlink usually displayed in the screen is referred to as “the (apparent) name of the hyperlink”. The “underlying” and “apparent” may be omitted when it is clear which is meant.

(0.10 Definitions; Name Rules)

A name rule in a narrow sense is defined as assigning names of anchors so that each name suggests a location of a material and the names are arrayed in ascending order of character codes when the names are arrayed in location order to ensure that the hyperlinks are correctly combined. Hereinafter, a rule related to anchor names is referred to as “a name rule”. Furthermore, a name rule in a broad sense is defined as assigning names of anchors so that each name suggests a location of a material to ensure that the hyperlinks are correctly combined, however, the names are not necessarily arrayed in ascending order of character codes when the names are arrayed in location order. Therefore, an anchor A of the setting region 4 in FIG. 1 is based on either of the name rules. The requirement of the name rule in a broad sense is not strict. This means that the name rule in a broad sense can be satisfied as long as the names suggest where to be copied in other material. Even when the two rules are applied in the same file, since each rule plays its own role independent from the other rule, there is no case that one rule contradicts against the other rule.

(0.20 Definition; Hyperlink)

Generally, a hyperlink designates an already existing destination. This is called “a hyperlink in a narrow sense”. Hereinafter, however, it is assumed that a hyperlink may designate a destination that is not yet included in the same file (i.e., the hyperlink cannot yet work). This is called “a hyperlink in a broad sense”. Needless to mention, the hyperlink in a broad sense includes the hyperlink in a narrow sense when a plurality of files are combined into one file by the final combination unit (79 in FIG. 5) and the jump destinations are included in the same file.

(0.30 Definition; Verbatim)

A verbatim refers to a part (the setting region 4 in FIG. 1) composed of an anchor and hyperlinks arranged in accordance with the name rule in a narrow sense or in a broad sense. Assuming that a plurality of materials having contents corresponding to one another is provided; a plurality of verbatims is arranged in a plurality of corresponding locations of each material. The hyperlinks in the verbatim respectively refer to corresponding locations in other materials respectively designated by the anchors. The anchor in the verbatim designates a location of a material serving as a jump destination of hyperlinks in other materials, thereby enabling a multilateral jump function among the materials. The part of the hyperlinks of the verbatim (the setting region 5 in FIG. 1) is called a hyperlinks group. For example, in case of multilateral international treaties or conventions, the hyperlinks group refers to a setting region 5 for a multilateral jump function among corresponding articles in different languages.

(0.40 Definition; Science, TOC Link)

A part (“↑FMap” in the example in FIG. 1) that is indicated in the first setting region B of the setting region 3 in FIG. 1 is called “a TOC (Table of Contents) link”. A whole area that begins with the TOC link and ends with an anchor is called a science (the setting region 3 in FIG. 1). The verbatim is a part which allows a user to comparatively examine a material or a document of a particular file with other materials or documents of related files while maintaining a displayed system, and the TOC link is a part which allows a user to intensively comparative and examine a material or a document of a file with other part of the same file such as, for example, a related description or the like. At this point, two or more TOC links in different system may be further created and each of the anchors A which serve as jump destination from the both TOC links may be located in the same identical line, of which configuration is called a science in a narrow sense (e.g., the region 97 in FIG. 25). This is because all sciences are used for replacement of think and/or view systems and comparative examine. Hereinafter sciences will be described in detail, and therefore verbatim may be briefly mentioned for the purpose of avoiding tedious repetition, since a science illustrated in the setting region 3 obviously includes therein a verbatim illustrated in the setting region 4. Therefore, it is needless to mention that, as the exemplary embodiments of the invention, it is possible to provide only the verbatim part.

(0.50 Definition; Link, Symbol)

Furthermore, links illustrated in the setting regions 6 to 11 in an arrangement of a hyperlinks group illustrated in the setting region 5 are called links 1 to 6, respectively. In the case of the example in FIG. 1, “→E” is a link1, “→C” is a link 2, “→J” is a link 3, “→G” is a link 4, “→R” is a link 5, and then “→S” is a link 6. Furthermore, the one in a state where a hyperlink is not set up may be referred to as “symbol”.

(0.60 Definition; Apparent, Underlying)

Hereinafter, “apparent text” is intended to mean a displayed text when the corresponding MS Word is opened in an ordinary method in a state of DOCX file. “underlying text” is intended to mean a displayed text when mouse-over is carried out or when a DOCX file is opened, and further in an edition state of field codes (an edition state is performed by a simultaneous press of ALT+F9 from a keyboard, and thereafter replacement is performed by disabling fuzzy search), or a displayed text when a bookmark icon (Insert a Bookmark) is opened. It should be noted that MS Word is a mere practical example, and any software may be applicable, so long as it can operate hyperlinks and anchors.

(Definition; Apparent and Underlying Names; Definition of Name is Described in 0.00).

It is to be noted that upon referring to names herein, the names may refer to as not only apparent names of, for example, hyperlinks, but also names readable from a field code. The names readable from the field cod side may include, for example, <°>, <°°>, <^{aa}>, and/or <^{a}>. Similarly, in the case of anchors also, the names readable from the field cod side may include, <°>, <°°>, <^{aa}>, and/or <^{a}>. Such name(s) readable from the field code are also referred to as “underlying name(s)”. In contrast, displayed texts of the hyperlinks may be sometimes attached with arrows, for example, “↑F” or “→E”. The name displayed on the screen is referred to as “apparent name”.

### BRIEF DESCRIPTION OF THE DRAWINGS

FIG. 1 is a diagram illustrating setting regions of an electronic file according to an exemplary embodiment according to the present invention;

FIG. 2 is a diagram for briefly explaining jumping of hyperlinks in a setting region 4 illustrated in FIG. 1;

FIG. 3A is a diagram of hyperlink edit screen;

FIG. 3B is a diagram of edit screen of bookmarks (means anchors on MS Word);

FIG. 4 is a diagram illustrating a hardware configuration example of the generation apparatus that generates an electronic file 1 which constitutes the region 1 in FIG. 1;

FIG. 5 is a diagram illustrating functional configuration of electronic file generation apparatus according to an exemplary embodiment according to the present invention;

FIG. 6A is a configuration diagram illustrating respective segments in a name of an anchor on field code side (hereinafter, simply referred to as “underlying name”);

FIG. 6B is a configuration diagram illustrating a part of segments in an underlying name;

FIG. 6C is a configuration diagram illustrating a part of segments of an underlying name having many segments;

FIG. 6D is arrangement diagram in which highest segments of the underlying names are arrayed according to the name rule;

FIG. 6E is a diagram of the setting region 3 in FIG. 1 when anchor names in respective lines include <1F>, <2E>, <3C>, <4J>, <5G>, <6R>, <7S>;

FIG. 7 is a flowchart in the First Process where the generation apparatus illustrated in FIG. 4 generates the setting region 3 in FIG. 1;

FIG. 8 is a detailed flowchart in the First Process where the generation apparatus illustrated in FIG. 4 generates the setting region 3 in FIG. 1;

FIG. 9A is a diagram illustrating an apparent name created as the region 6 in FIG. 1 in step S2 in FIG. 7 or step S2 in FIG. 8;

FIG. 9B is a diagram illustrating apparent names obtained by copying region 6 to region 7 in FIG. 1 in step S3 in FIG. 7 or step S3 in FIG. 8;

FIG. 9C is a diagram illustrating apparent names when selecting and inverting characters of region 7 in FIG. 1 to replace the apparent name in step S3 in FIG. 7 or step S3 in FIG. 8;

FIG. 9D is a diagram illustrating apparent names after inverting characters of region 7 in FIG. 1 and replacing the apparent name with “C” in step S4 in FIG. 7 or step S4 in FIG. 8;

FIG. 9E is a diagram illustrating apparent names of a hyperlinks group arranged in regions 6 to 11 in FIG. 1 for enabling a multilateral jumping after final combination in steps S1 to S6 in FIG. 7 or steps S1 to S6 in FIG. 8;

FIG. 9F is another diagram illustrating apparent names of science arranged as region 3 in FIG. 1 in the entire step in FIG. 7 or FIG. 8;

FIG. 9G is a diagram illustrating a scene in which names of hyperlinks of the science in FIG. 9F is opened and viewed from field code side are orderly arrayed in respective lines owing to the auto word wrap function, and an anchor is arranged at the end of the seventh line;

FIG. 10 is a diagram for explaining the case where hyperlink is inserted first, when anchor is not yet present;

FIG. 11 is a flowchart illustrating processing when it is necessary to proliferate in the Second Process, the setting region 3 in FIG. 1 generated in FIG. 7 and FIG. 8;

FIG. 12A is a flowchart illustrating processing for combining two files respectively having (01) and (02) in the lowest segment of names (hereinafter, abbreviated as “the lowest segment 87”) in FIG. 6A or FIG. 6C;

FIG. 12B is a flowchart illustrating processing for combining two files respectively having (01, 02) and (03, 04) in the lowest segment, performed next to FIG. 12A;

FIG. 12C is a flowchart illustrating processing for combining two files respectively having (01, 02, 03, 04) and (05, 06, 07, 08) in the lowest segment, performed next to FIG. 12B;

FIG. 13 is a warning diagram displayed when changing an extension of an electronic file from DOCX to ZIP;

FIG. 14 is a diagram illustrating document.xml included in a ZIP file obtained by changing the extension of a DOCX file to ZIP;

FIG. 15 is a photograph (No. 1) substituted for drawing indicating evidence by which it can be confirmed that hyperlinks and anchors have been concurrently changed in step S14 in FIG. 11, since the replaced underlying names can be orderly displayed, by using names in FIGS. 35A and 35B, and can be read by visually comparing contexts of the names;

FIG. 16 is a flowchart illustrating processing in the Third Process for replacing the segments 84 (hereinafter abbreviated as “the highest segments”) in FIG. 6A or FIG. 6C included in names generated in the First Process in FIGS. 7 and 8, and proliferated in the Second Process in FIG. 11;

FIG. 17A is a flowchart illustrating processing of the setting region 6 and the setting regions A and B in FIG. 1;

FIG. 17B is a flowchart illustrating processing of the setting region 7 and the setting regions A and B in FIG. 1, performed after the processing in FIG. 17A is completed;

FIG. 17C is a flowchart illustrating processing of the setting region 8 and the setting regions A and B in FIG. 1, performed after the processing in FIG. 17B is completed;

FIG. 18 is a photograph (No. 2) substituted for drawing indicating evidence by which it can be confirmed that changes of only anchor names have been made in step S26 in FIG. 16, since the replaced underlying names can be orderly displayed, by using names in FIGS. 35A and 35B, and can be read by visually comparing contexts of the names;

FIG. 19A is a diagram illustrating evacuation of apparent names in the region B and the region 6 in FIG. 1, to be performed in steps S22 and S23, before changing processing of anchor is performed in step S26 in FIG. 17A;

FIG. 19B is a diagram illustrating apparent names in the setting region 3 in FIG. 1, when the names, on which evacuation change has been performed in FIG. 19A, are changed to different names in steps S27 and S28 in FIG. 17A;

FIG. 19C is a diagram corresponding to FIG. 19A and illustrating evacuations of underlying names of hyperlinks in the region B and the regions 6 to 11 in FIG. 1, to be performed in steps S24 and S25, before changing processing of anchors is performed in step S26 in FIG. 17A, and is a diagram corresponding to FIG. 19A;

FIG. 19D is a diagram illustrating underlying names in FIG. 19B, when the names, on which evacuation changing of names has been performed in FIG. 19C, are changed to different names in steps S29 and S30 in FIG. 17A;

FIG. 20A is a diagram illustrating a method for replacing French hyperlinks with reference to an edition dialog when hyperlinks are associated in sequence with anchors already laid by hand work;

FIG. 20B is a diagram illustrating a method for replacing Chinese hyperlinks to be performed subsequent to FIG. 20A;

FIG. 20C is a diagram illustrating a method for replacing Japanese hyperlinks to be performed subsequent to FIG. 20B;

FIG. 21 is an architectural concept diagram when replacement of building drawings is performed, unlike FIG. 1;

FIG. 22 is a diagram illustrating a table of contents of drawing collection in which drawings in plane projection are collected and organized from building drawings in FIG. 21;

FIG. 23 is a diagram illustrating a table of contents of drawing collection in which drawings in front projection are collected and organized from building drawings in FIG. 21;

FIG. 24 is a diagram illustrating a table of contents of drawing collection in which drawings in side projection are collected and organized from building drawings in FIG. 21;

FIG. 25 is a diagram of setting regions assuming that the fire broke out from a part of building in FIG. 21, and a drawing of the building two minutes after the fire broke out;

FIG. 26 is a diagram illustrating a state where any of two anchors located on right-top in FIG. 25 is selected, and names are arrayed in a location order;

FIG. 27 is a diagram illustrating a state where left side from two anchors located on right-top in FIG. 25 is selected, and arrayed in a name order of the present system;

FIG. 28 is a diagram illustrating a state where right side from two anchors located on right-top side in FIG. 25 is selected, and arrayed in the name order of the new system;

FIG. 29 is one example of another electronic file that includes a material having different story lines, unlike FIG. 1, respectively selectable by different lines of hyperlinks and two anchors;

FIG. 30 is one example of another electronic file that includes a material having different story line, unlike FIG. 1, selectable by different lines of hyperlinks and three anchors;

FIG. 31 is one example of an electronic file using dots for dividing segments of underlying names, unlike FIG. 1;

FIG. 32 is one example of an electronic file for comparing opinions of many people, unlike FIG. 1;

FIG. 33 is a display example of hyperlinks in unaligned field codes;

FIG. 34A is another diagram of the setting region 3 in FIG. 1;

FIG. 34B illustrates a display example of names in which hyperlinks are aligned by auto word wrap function when field codes (underlying names) in FIG. 34A are opened, and edit processing can be easily performed;

FIG. 34C illustrates a name when an anchor arranged at the end in FIG. 34B is viewed by opening FIG. 3B or document.xml (FIG. 14);

FIG. 35A is a list up to Rule 4 Clause 11, which is the first half part, of the underlying names for English up to PCT Rule 9, created so that the names are orderly aligned by replacements as illustrated in FIG. 15, FIG. 18, and FIG. 34B; and

FIG. 35B is a list up to PCT Rule 4 Clause 12 onwards, continued from FIG. 35A.

### DETAILED DESCRIPTION OF THE EMBODIMENTS

### Configuration of Specification

Firstly, an example of electronic files according to the present patent, i.e., name rules, configuration of hardware, configuration of a generation apparatus, conditions before entering into production stage in the name of “currently being prepared” will be described below. Thereafter, a program control and a generation method composed of three processes will be described. Finally, examples of other electronic files different from the above described electronic files, points to be noted, and comprehensive image of large-volume production will be described.

### 1. One Example of Electronic File

(1.00 Embodiment Using Multilingual Treaties or Conventions)

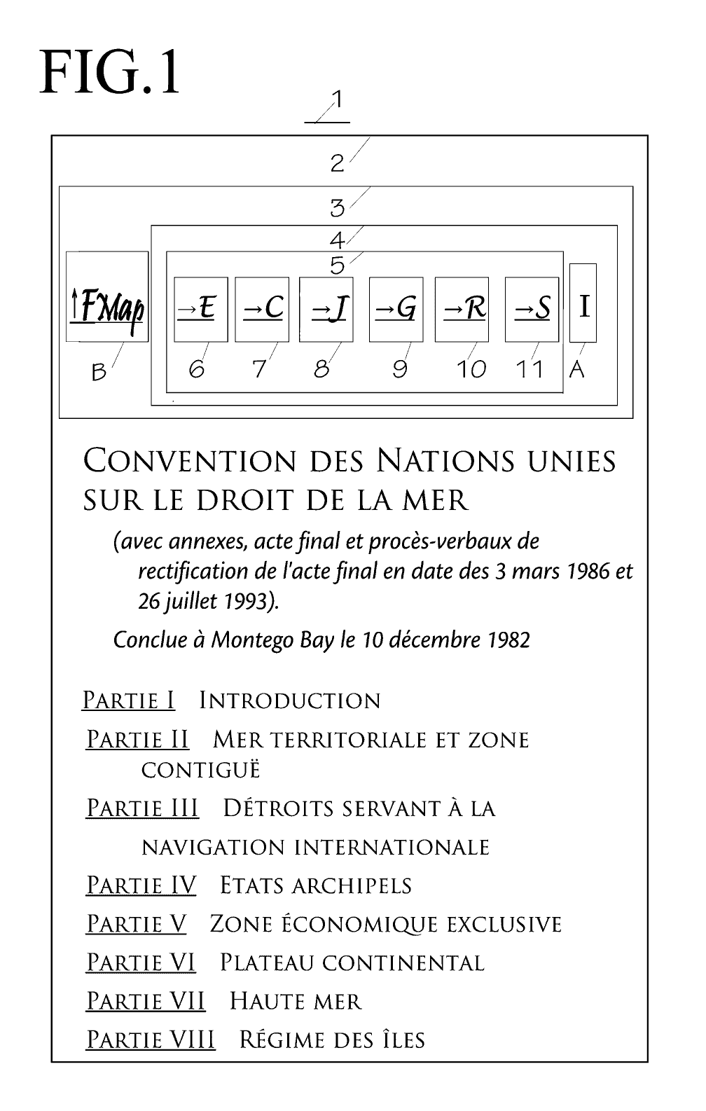

FIG. 1 is a diagram illustrating a part of an electronic file 1 according to one exemplary embodiment according to the present invention. The electronic file 1 illustrated in FIG. 1 is an electronic file designed to compare treaties or conventions translated into a plurality of languages. This means that, in the electronic file 1 illustrated in FIG. 1, full texts of main patent treaties or conventions translated into seven languages (French, English, Chinese, Japanese, German, Russian, and Spanish) are contained in one MS Word file, and French version, English version, Chinese version, Japanese version, German version, Russian version, Spanish version are described in this order.

(1.10 Jump Function of the Setting Regions in FIG. 1)

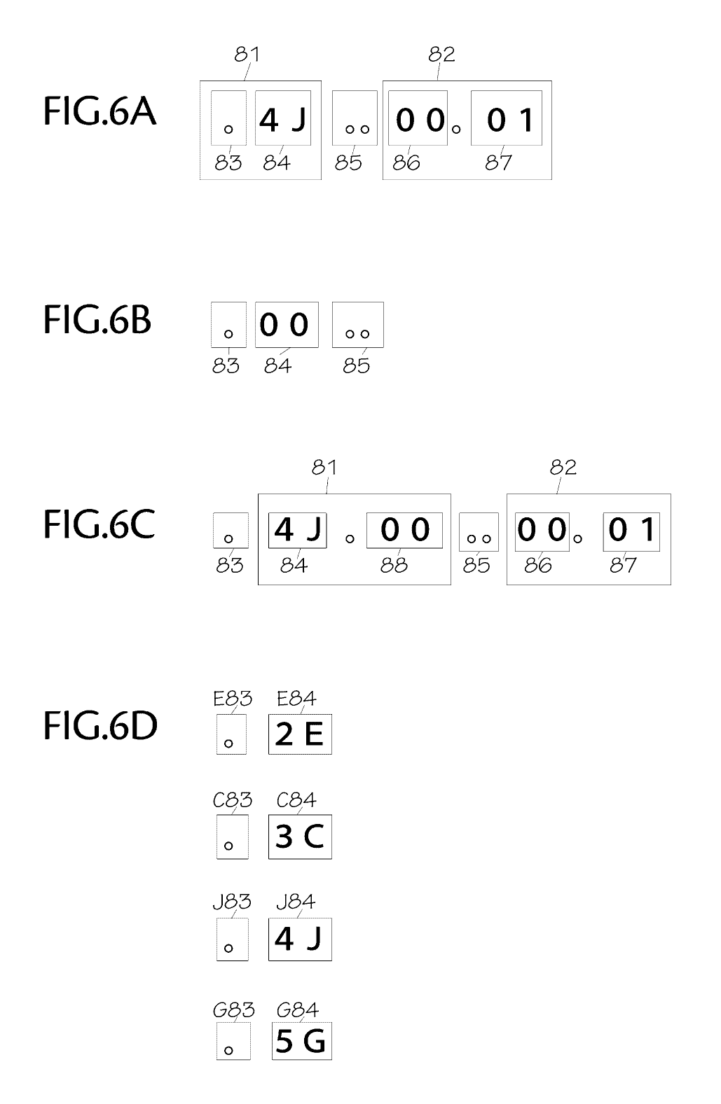

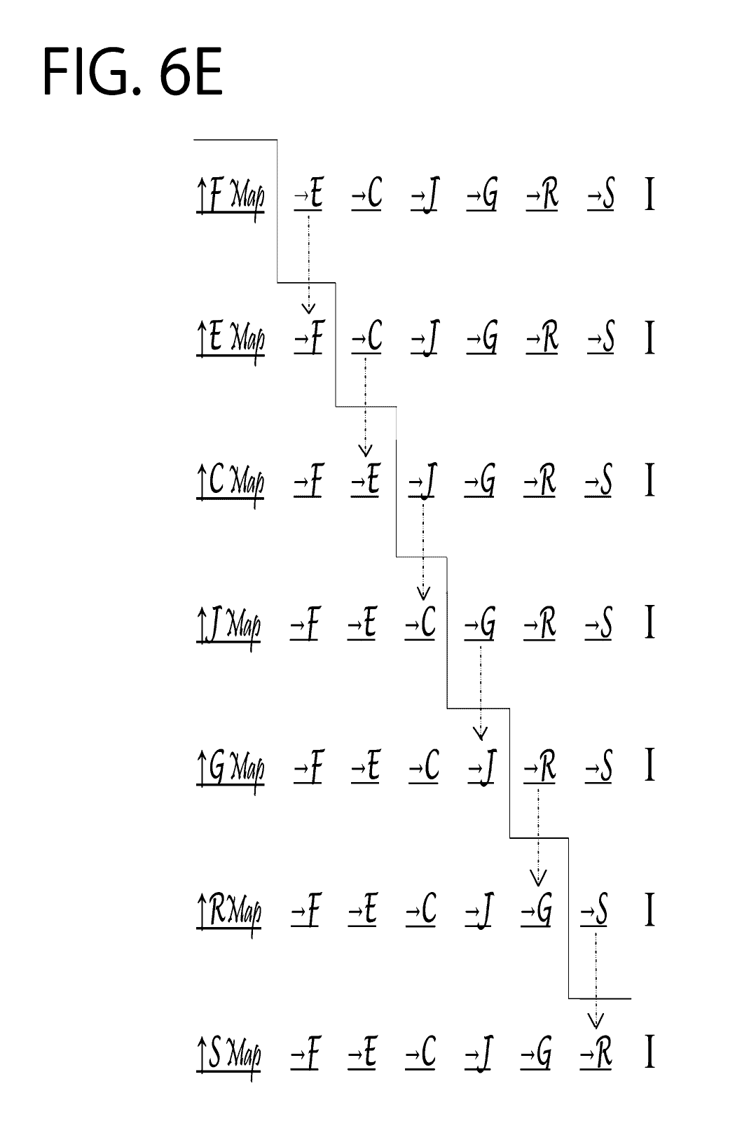

Next, a relationship between the anchor A and the individual hyperlinks of the hyperlinks group included in the verbatim with regard to jumping will be described. The link 1 (→E in FIG. 1) illustrated in the setting region 6 of a verbatim in FIG. 1 allows a user to jump to a corresponding page (the second line in FIG. 6E) in English version, the link 2 (→C in FIG. 1) illustrated in the setting region 7 allows a user to jump to a corresponding page in Chinese version (the third line in FIG. 6E). Similarly, the link 3 (→J in FIG. 1) illustrated in the setting region 8 to Japanese version (the fourth line in FIG. 6E), the link 4 (→G in FIG. 1) illustrated in the setting region 9 to German version (the fifth line in FIG. 6E), the link 5 (→R in FIG. 1) illustrated in the setting region 10 to Russian version (the sixth line in FIG. 6E), and the link 6 (→S in the figure FIG. 1) illustrated in the setting region 11 to Spanish version (the seventh line in FIG. 6E) allow a user to jump to corresponding pages in versions of respective languages (the third line in FIG. 6E). Further, the anchor A in FIG. 1 serves as a destination in the French version page allowing a user to jump back from a linked page of other language versions. At that time, the anchor A in FIG. 1 is located identically to the anchors I each arranged at the end of respective lines shown in FIG. 6E. The anchors may not be displayed on a screen in some cases depending on the display setting of Word (registered trademark).

### 2. Description Directed to the Setting Region 4 (Verbatim Part) in Electronic File

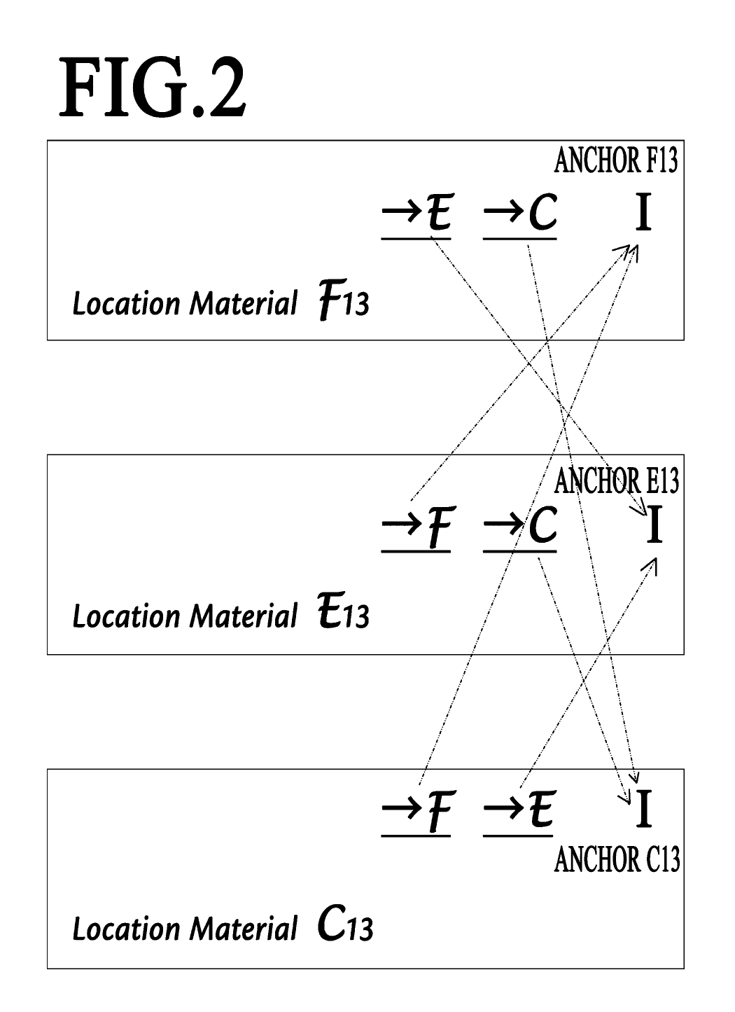

FIG. 2 is a diagram for briefly explaining a relationship with regard to a jump function using an anchor and two hyperlinks for each verbatim, different from the hyperlinks group illustrated in FIG. 1. A location material F13, a location material E13, and a location material C13 illustrated in FIG. 2 are similar in contents but different from one another in descriptive languages.

(2.00 Apparent Name and Underlying Name in FIG. 2)

In the location material F13, the location material E13, and the location material C13 in FIG. 2, hyperlinks are set up so as to allow a user to jump to materials suggested by apparent names, thereby enabling multilateral jumping. For example, on a page of the location material F13, hyperlinks “→E” and “→C” and an anchor F13 are set up. On a page of the location material E13, hyperlinks “→F” and “→C” and an anchor E13 are set up. Further, on a page of the location material C13, the hyperlinks “→F” and “→E” and an anchor C13 are set up. These pages may be set up respectively apart from each other by about several thousand pages.

(2.10 Jump Function and Effect of F13 and →E in FIG. 2)

The multilateral jump function is performed as follows. Upon selecting the hyperlink “→E” on a page where the location material F13 in FIG. 2 is described, a jump occurs to the anchor E13 on a page where the location material E13 is described. This will switch a display content on a screen from the location material F13 to the location material E13. Next, upon selecting the hyperlink “→F” on the page where the location material E13 is described, a jump occurs returning from E13 to the anchor F13 set up on the page where the location material F13 is described. In this manner, the display content is switched to the location material F13 from the location material E13. A similar multilateral jump function can be performed between location materials F14 and E14 (not shown) or the like in multinational Conventions.

(2.20 Jump Function and Effect of F13 and →C in FIG. 2)

Similarly, upon selecting the hyperlink “→C” on the page where the location material F13 in FIG. 2 is described, a jump occurs to the anchor C13 on the page where the location material C13 is described. In this manner, the display content is switched on the screen from the location material F13 to the location material C13. Next, similarly upon selecting the hyperlink “→F” on the page where the location material C13 is described, a jump occurs back to the anchor F13 that is set up on the page where the location material F13 is described. In this manner, the display content is changed on the screen back to the location material F13 from the location material C13. A similar multilateral jump function is available between location materials F14 and C14 (not shown) or the like in the multinational treaties or conventions.

(2.30 Order Rule of the Setting Regions in FIG. 2)

When a series of jump commands in FIG. 2 are performed on a smartphone screen, a position of the link “→E”, present in the location material F13, and a position of the link “→F”, present in the location material E13 used to jump back to the location material F13 after the jump operation from the link “→E” are arranged in a manner that they are located visually almost at the same positions in corresponding sciences. This is derived from a rule, hereinafter referred to as “order rule”, defined as a rule of hyperlinks, which will be described in detail later. Referring back to the case of FIG. 1, although the verbatim region has seven hyperlinks, the hyperlinks group has only six links (see the setting region 5 in FIG. 1), and a TOC link (the setting region B in FIG. 1) is arranged on a left-hand side of the hyperlinks group. This means that, among seven links F, E, C, J, G, R, and S illustrated in the setting region 4 in FIG. 1, while any one link of the links F, E, C, J, G, R, and S is “excluded” from the setting region 4 (hereinafter referred to as “exclusion of the link of interest”) and arranged in the setting region B in FIG. 1 even at the jump destination, the remaining six links positioned respectively at 6 to 11 that constitute a hyperlinks group (the setting region 5 in FIG. 1) are arranged in the same anteroposterior order. The TOC link refers to the table of contents of the current material (herein referred to as “attention material”), and the other links in the hyperlinks group refer to the materials other than the attention material.

(2.30 Underlying Names in Accordance with the Order Rule)

In order to create the underlying names in accordance with the order rule, the underlying names are arrayed in ascending order of character codes thereof in the hyperlinks group of the verbatim region. As a result of this, even when an attention hyperlink is excluded from the verbatim region, other hyperlinks will be arrayed in ascending order of the character codes thereof in the verbatim region, thereby maintaining the anteroposterior order of the array.

(2.31 Effect of the Order Rule)

For this reason, positions of hyperlinks are maintained approximately at the same in the positions of the science (the setting region 3) in FIG. 1 as the both setting regions of a jump source and a jump destination. This means that the hyperlinks are maintained approximately the same even in distance therebetween between the jump source and the jump destination. Thereby making it possible for a user to easily repeat multilateral jump function with intention to review and examine the materials, naturally being aware of positional consistency of the hyperlinks.

(2.40 the Number of Hyperlinks that Governs Movement of Verbatim)

Meanwhile, the basic number of hyperlinks necessary to perform respective multilateral jump functions in terms of all materials and to allow them to correctly function can be acquired in accordance with a combination formula, which will be easily understood by imagining a pentagon like the Star of David having outer peripheral sides, each angle of which represents a root node of hyperlinks. In such a polygon, the number of straight lines passing through a concerned angle (hereinafter referred to as “self-angle”) and the other angles other than the self-angle of the polygon is smaller by one than the total number of the angles of the polygon. This means that the total number of straight lines passing through any of two angles of the polygon can be acquired by the formula (N(N−1))/2, which is the formula of acquiring the number of diagonal lines and opposite lines of the polygon. The number of hyperlinks that can be bilaterally established is acquired by multiplying (N(N−1))/2 by 2. Here, N stands for the number of links arrayed in one verbatim. Thus, for example, the number of hyperlinks in the case of merging materials of at least seven languages into one electronic file is 6×7=42. From the foregoing, it is to be understood that the number of hyperlinks equivalent to N (N−1) wherein N is the number of links respectively indicative of languages arrayed in a verbatim is required to constitute the verbatim in the setting region 4 in FIG. 1.

(2.50 Arrangement of Sciences in Lines Independent of Materials)

A conventional hyperlink allows only a one-way link. On the other hand, the verbatim of the setting region 4 set up in the electronic file 1 that contains full texts of main treaties or conventions in seven languages illustrated in FIG. 1 is different from a conventional type of setting method of a hyperlink, which just leads to a destination of a material having rich explanation, and ends up leaving the user behind upon arriving at the destination, just assisting a user's understanding. According to the present invention, in the electronic file 1, a tool for the multilateral jump function named “science” is provided as a single line independently and differently from the material. Consequently, the materials are not affected by the presence of sciences and can maintain the same as they are in terms of arrangement while the multilateral jump function is available. Furthermore, the fact that the science has become an element independent from the material leads to the fact that the science itself including hyperlinks and anchors can be freely added, pasted, modified or deleted line by line without affecting the material. Thus, usability and reusability of sciences at the time of proliferation is enhanced since the sciences are spatially independent from the material.

(2.51 Lines on which Sciences are Placed)

It is preferable that an anchor should not be placed on a line beneath the hyperlinks group within the same verbatim. Some viewer software may count a line number of an anchor at a jump destination, stop jumping at a line where the anchor is placed, and display the line at the top of screen. This might cause a user to lose sight of the hyperlinks group which allows the user to return from the jump destination back to the jump source. However, the science including the anchor may not necessarily be placed at a first line of a page. For example, when Parts, Articles, or the like newly start, sciences may start following those titles. The sciences do not need to be arranged at each page of an electronic file. However, since the science has a function of verbatim, the science may be preferably arranged within a predetermined page interval for convenience of the multilateral jump function.

### 3. Name Rule

(3.00 Mechanism of Displaying MS Word as an Editor of XML)

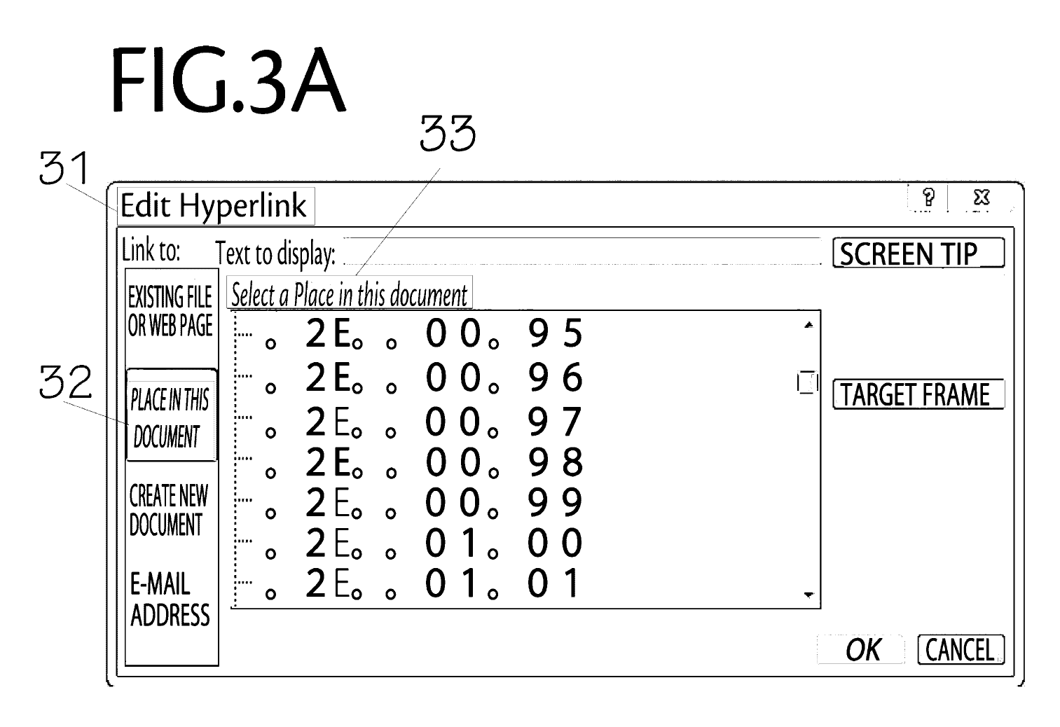

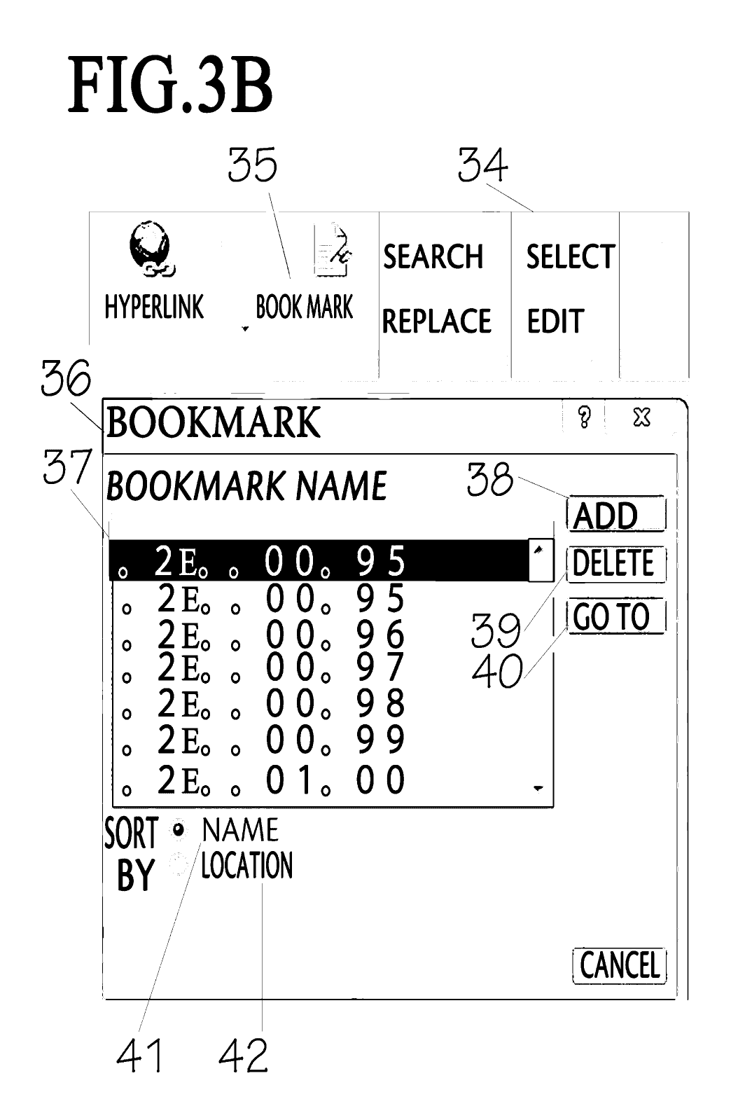

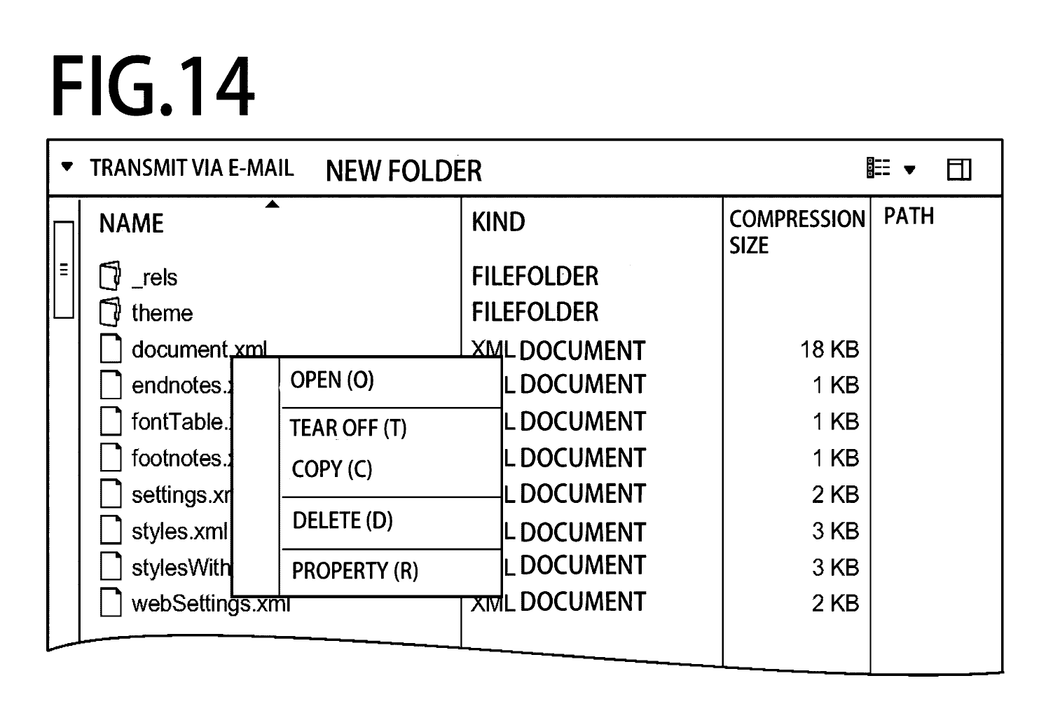

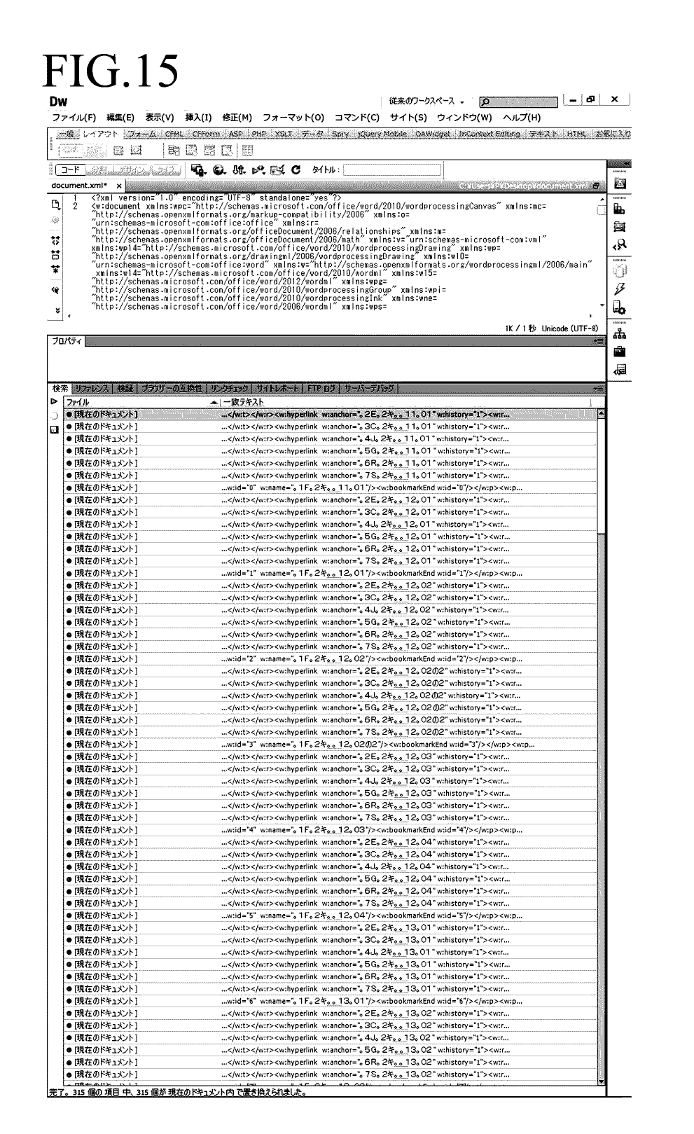

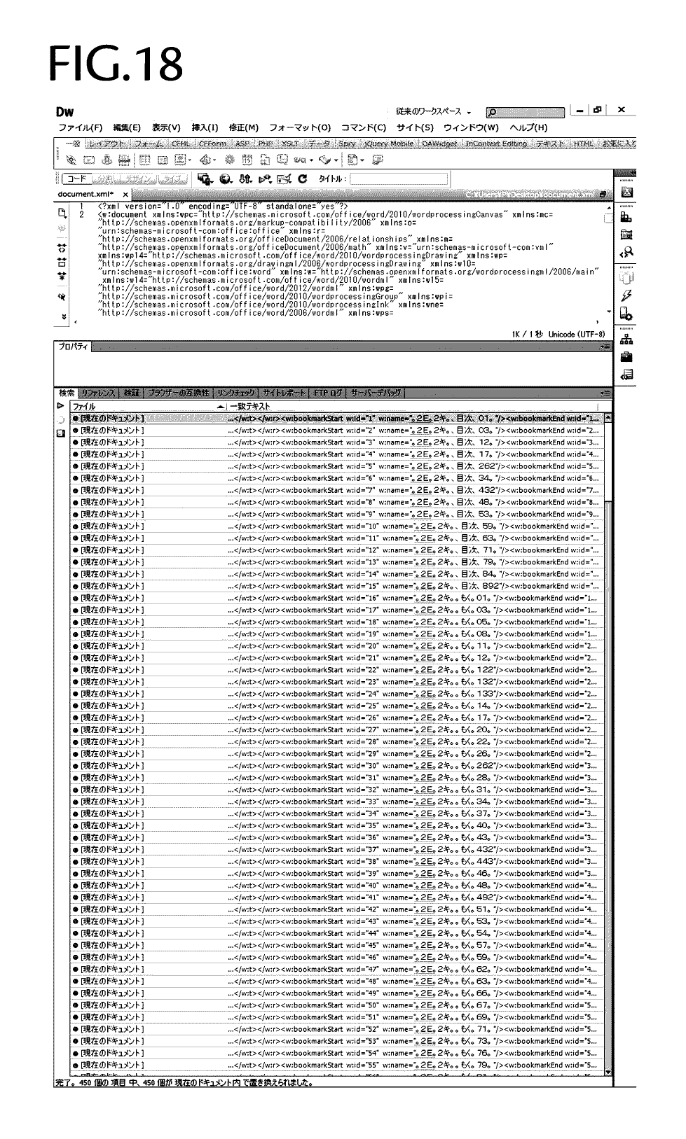

In the electronic file (DOCX file) in FIG. 1, XML files (e.g., document.xml) are included (FIG. 14). Further, information of anchors illustrated in FIG. 3B is managed with ID numbers assigned within the document.xml file (FIG. 18). In the document.xml included in the MS Word file, the ID numbers in the file are sequentially attached (“w:id” in FIG. 15 and FIG. 18), each time an anchor is created. Then, setting information of the anchor A in the setting region 4 of the electronic file 1 can be viewed at the dialogs in FIGS. 3A and 3B in a state in which DOCX file is open.

(3.10 Hyperlink Edit Screen and Anchor Edit Screen)

FIGS. 3A and 3B are diagrams each illustrating an example of edit screen of the electronic file in FIG. 1. FIG. 3A is a diagram illustrating an example of a hyperlink edit screen. FIG. 3B is a diagram illustrating an example of an anchor edit screen.

(3.11 Anchor Edit Screen)

A screen 34 illustrated in FIG. 3B includes thereon a screen 36 that is displayed upon selecting an icon 35 named “Bookmark” located on the screen top of MS Word. A bookmark is intended to mean an anchor in MS Word. On the screen 36, a list of bookmark names is displayed in a region 37. Further, a bookmark can be added by an add button 38, and an already-created bookmark can be deleted by a delete button 39. Furthermore, upon selecting a jump (go to) button 40 after a particular bookmark is selected in the region 37, the button allows users to jump to the point of the material where the bookmark has been placed. As for sorting order of the list of bookmark names shown on the screen 36, the bookmark names can be rearranged by designating either a name button 41 for name order or a location button 42 for location order. In other words, the bookmark edit screen illustrated in FIG. 3B is designed so that, if a location order (the button 42 in FIG. 3B) is selected, anchors are arrayed in the location order, and if the name order (the button 41 in FIG. 3B) is selected, information of the anchors is sorted and displayed in the order of character codes independent from the locations.

(3.12 Hyperlink Edit Screen)

While, on the other hand, a screen 31 illustrated in FIG. 3A is a screen displayed upon selecting an item named “Edit Hyperlink” in a context menu that appears after a hyperlink illustrated in FIG. 1 is right-clicked with a mouse. In FIG. 3A, upon selecting a display 32 named “Place in this document”, names of a plurality of anchors set up within the electronic file are displayed in a list, in a region 33 named “Select a Place in this document”. On the screen, a hyperlink can be set up by selecting an anchor name being displayed in the region 33 so that clicking on the hyperlink allows user to jump to a predetermined place in the electronic file.

(3.20 Anchor Names are Displayed in the Order of Character Codes)

However, an appearance order of names in the hyperlink edit screen (display 32 in FIG. 3A) is the same as the name order (the button 41 in FIG. 3B) since the location order (the button 42 in FIG. 3B) cannot be selected from the hyperlink edit screen (display 32 in FIG. 3A). The name order is equivalent to the order of character codes. This means that the specification of MS Word, which follows the XML editor, allows the hyperlink to be edited only in the order of character codes of the names of anchors. ASCII of Western fonts has only 256 characters, and the higher the number the larger the numerals become, and since the numerals become gradually larger in name order, a dialog of edition (Edit Hyperlink) of hyperlinks for the purpose of association based on the location order might not need to be daringly prepared.

(3.30 Purports; Name Rules and Verbatim)

The anchors are sequentially described in the location order of a particular language, and, verbatims are sequentially described in location orders of the other languages. Therefore, it is preferable to create the anchors A in the setting region 4 in FIG. 1 in accordance with the name rules. As a result of this, the display order of anchors coincides with the location order, thereby making it possible for users to easily edit hyperlinks in the location order.

(3.40 Names Unsuitable for Large Volume Production)

In the region 33 in FIG. 3A, anchor names are displayed only in the order of character codes thereof, which is different from the location order. While, on the other hand, when hyperlinks are edited, there is a need of searching for anchor names in the location order. For this reason, in the case where anchor names are proliferated at random, even if information that suggests the locations is available, the anchor names cannot be sorted based on such information. As a result, it becomes almost impossible to combine the hyperlinks with the anchors.

(3.50 Names Suitable for Large Volume Production)

However, the above-problem can be solved, if the names are arrayed in the same order in a manner easy to read and understand, regardless of whichever arraying method may be employed. Since anchors and hyperlinks will be sequentially combined, they will be easily combined if easy-to-read anchor names appear in the location order. Furthermore, in view of large-volume production, it is logically convenient to create a variety of names using numbers sequentially increasing in line with the locations. Large-volume production can be simplified if names are created with numbers which increase sequentially because they can be arrayed sequentially. Accordingly, the name rule in the narrow sense (0.10) is more preferable than the name rule in the broad sense.

(3.51 Considering Actual Example of Names in Accordance with the Name Rule in the Narrow Sense)

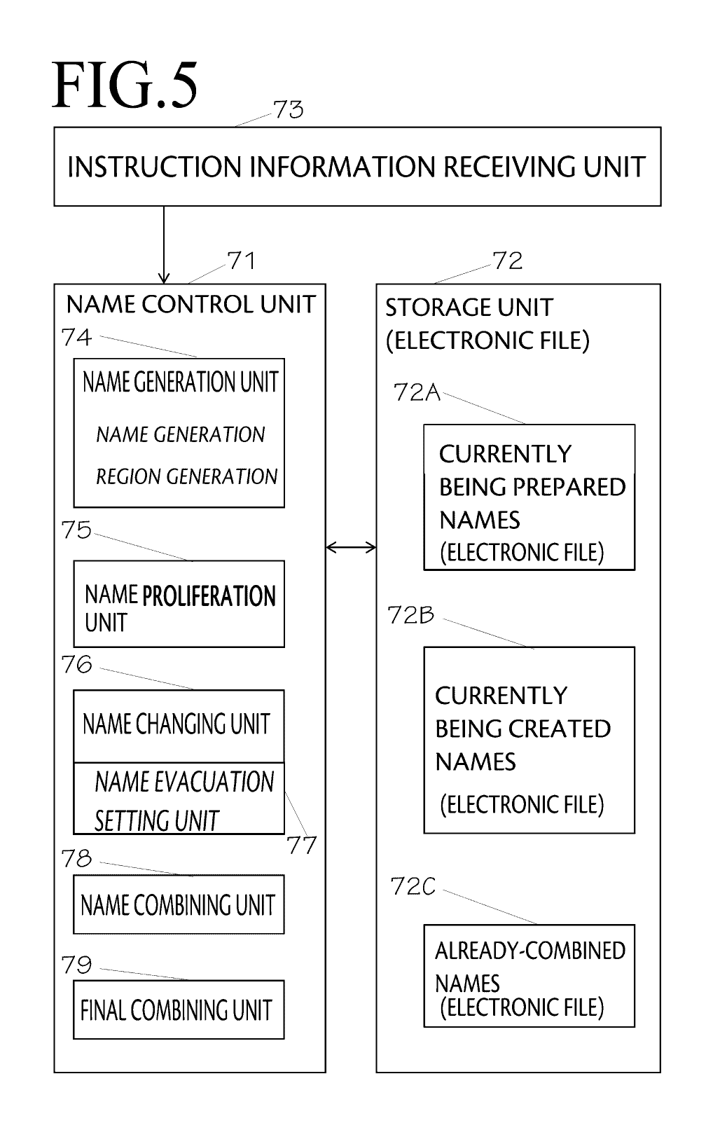

As described above, typically, the currently being prepared names 72A in FIG. 5 are created in accordance with the above name rule in the narrow sense. Here, actual example which follows the name rule will be described below. For example, it is herein assumed that a user firstly creates anchor names of Articles of the PCT, which is a multilateral international treaty, then, creates anchor names of Regulations under the PCT, and finally creates anchor names of tables of contents of Regulations under the PCT. Since material such as Regulations under the PCT is large in volume, tables of contents are made of not only one layer but two layers. This means that Short Table of Contents and Long Table of Contents constitute respective layers along with anchors thereof. In this case, in view of the name rule in the narrow sense, the names of entire anchors should be arrayed in the same order, regardless of whether the names are sorted by location or by name (character code). This means that, according to the name rule in the narrow sense, even if the anchors are sorted by name, the anchors will be arrayed in the location order such that Short Table of Contents of Regulations under the PCT and Long Table of Contents of Regulations under the PCT are placed between Articles of the PCT and Rules of Regulations of the PCT.

(3.60 Considering Actual Example of Names in Accordance with the Name Rule in the Broad Sense)

Here, the name rule in the broad sense is examined. Even if materials are arrayed in the order of Articles of the PCT, Short Table of Contents of Regulations under the PCT, Long Table of Contents of Regulations under the PCT, and/or Rules of Regulations under the PCT, it is only necessary that the names are arrayed in ascending order within a range of each block, and can suggest sufficient meaning. As long as practically sufficient, even the name rule in the broad sense may be employed. For example, in the case of Japanese language, names may be created in the order of Japanese characters representing numbers 1, 2, and 3, which will be arrayed in the order of 1, 3, and 2, since it is the order of character codes of the Japanese characters. The XML editor is not limited to the one produced by MS Word related company. It may suffice to employ another XML editor produced by a corporation following the name rule in the broad sense.

(3.70 the Best Name Rule)

However, in view of creating a plurality of files separately in a folder, the files are arrayed in the order of extension type, size, creation date, or the like so that user can jump from a file to another file within the same folder. It is preferable to create files in the order of name within the same folder since the files cannot share the concept of “location order”, only the name order can serve as the best arrangement order. Thus, description hereinafter will be directed to the name rule in the narrow sense. Although the name rule in the narrow sense is convenient, it is not necessary to prohibit any use of the name rule in the broad sense within a certain range.

### 4. Description Directed to Hardware Configuration

Subsequently, the electronic file generation apparatus (hereinafter simply referred to as “the generation apparatus”) for generating the electronic file 1 will be described.

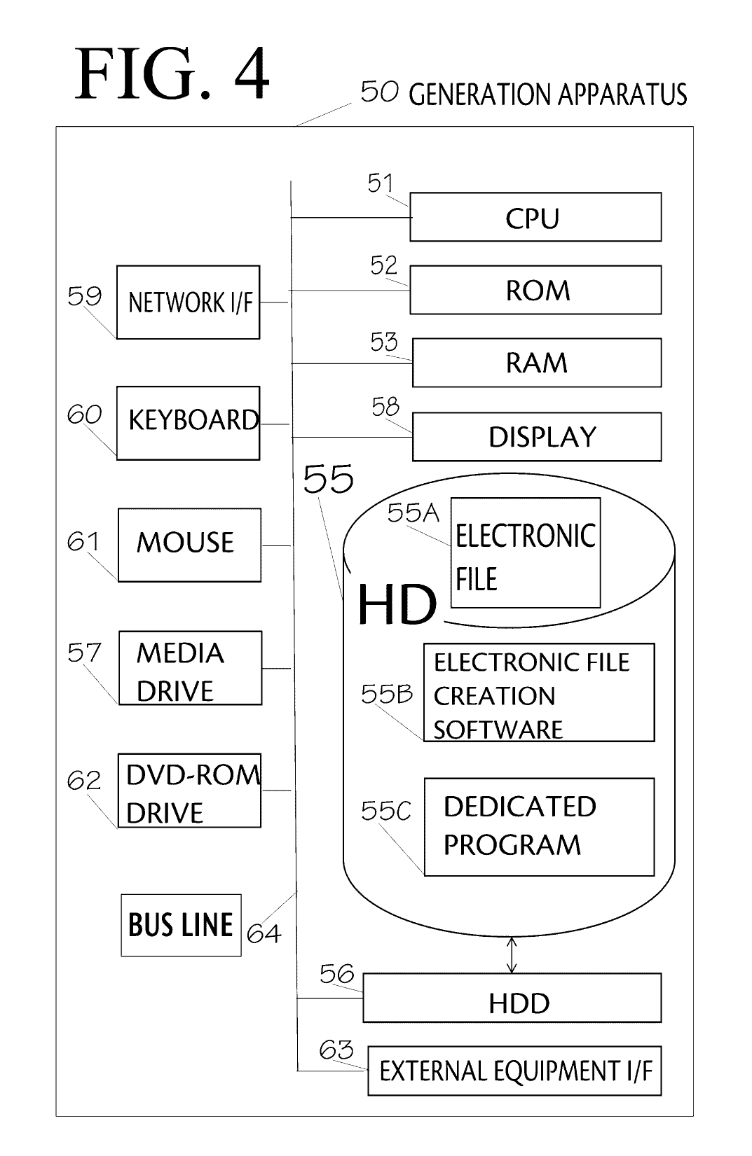

(General Remarks on FIG. 4)

FIG. 4 is a block diagram illustrating hardware configuration example of the electronic file generation apparatus 50 for generating the electronic file 1 described in FIG. 1 through FIGS. 3A and 3B. The generation apparatus 50 is an information processing apparatus such as, for example, a notebook Personal Computer (hereinafter referred to as “PC”), a desktop PC, a tablet terminal, and a smartphone. The generation apparatus 50 is loaded with applications for creating electronic files, tables, presentation materials, etc., OS (Operating System) and the like. A user can create electronic files by activating, for example, an electronic file creation software such as MS Word.

(Description Directed to the Generation Apparatus 50 in FIG. 4)

As illustrated in FIG. 4, the generation apparatus 50 comprises a central processing unit (CPU) 51, a read-only memory (ROM) 52, a random-access memory (RAM) 53, a hard disk (HD) 55, a hard disk drive (HDD) 56, a media drive 57, a display 58, a network interface (I/F) 59, a keyboard 60, a mouse 61, a DVD-ROM drive 62, an external equipment I/F 63, and a bus line 64.

(Description Directed to CPU 51 in FIG. 4)

The CPU 51 is a unit used to integrally control respective devices and controllers connected to the bus line 64. The CPU 51 loads necessary programs or the like on the RAM 53 upon executing processing, and realizes various types of operations by executing the programs or the like.

(Description Directed to ROM 52 in FIG. 4)

The ROM 52 is a device configured to store therein various types of programs and the like necessary for realizing a function of executing a basic input/output system (BIOS) or operating system (OS) serving as a control program of the CPU 51. The RAM 53 is a device that functions as a main memory, a work area, and the like of the CPU 51.

(Description Directed to HD 55 in FIG. 4)

The HD 55 is a device that stores an electronic file 55A, an electronic file creation software 55B, a dedicated program 55C and the like. Among those, the electronic file 55A is a file capable of storing XML format texts and numerals, for example, a DOCX file, created by MS Word. Further, the electronic file creation software 55B may be any software as long as it can create anchors and hyperlinks and is capable of operating XML format texts and numerals. The electronic file creation software 55B may be, for example, MS Word, Apache OpenOffice Writer, or LibreOffice. The dedicated program 55C is a program capable of operating XML format texts and numerals, but the dedicated program 55C may be a stand-alone software or may be a program incorporated into MS Word. The dedicated program 55C can execute, as required, apart or all of the processing based on various types of user instructions, which will be described later.

(Description Directed to HDD 56 in FIG. 4)

The HDD 56 is a device that controls read or write of various types of data and the like with respect to the HD 55 in accordance with control of the CPU 51.

(Description Directed to Media Drive 57 in FIG. 4)

The media drive 57 is a device that controls read or write of data with respect to a recording medium such as a flash memory. The display 58 is a device that displays various types of information such as cursors, menus, windows, characters, images, videos, etc. A touch panel function may be incorporated into the display 58. The network I/F 59 is a device that performs data transmission by utilizing a communication network.

(Description Directed to Keyboard 60 in FIG. 4)

The keyboard 60 is a device provided with a plurality of keys for inputting characters, numerals, various types of instructions, and the like. The mouse 61 is a device for performing selection or execution of various types of instructions, selection of processing target, movement of cursor, and the like. The DVD-ROM drive 62 is a device that controls read or write of data with respect to DVD-ROM as an example of an attachable and detachable computer-readable recording medium for storing a computer program. Hereinafter, a computer-readable recording medium for storing a computer program is referred to as a “computer-readable recording medium” or simply as a “storage medium”.

(Description Directed to External Equipment Interface 63 in FIG. 4)

The external equipment interface (hereinafter simply referred to as “I/F”) 63 is a device that transmits and receives data to and from an external equipment. The bus line 64 is a grouping of signal lines each electrically connecting various types of hardware described above with each other.

(Supplemental Description of FIG. 4)

The recording medium may be a computer-readable recording medium such as digital versatile disk (DVD), DVD-R, DVD-RW, DVD-RAM, compact disk (CD), CD-R, CD-ROM, CD-RW, blue ray disk. The generation apparatus 50 may be provided with a drive for driving the computer-readable recording medium. Herein, the generation apparatus 50 is configured to include the HD 55 and the HDD 56, but in addition to these, or in place of these, the generation apparatus 50 may be configured to include a flash memory and a solid-state drive (SSD).

### 5. Generation Apparatus 50

Hereinafter, functional configuration of the generation apparatus 50 and currently being prepared names will be described.

(5.00 Currently being Prepared Names)

The description hereinafter is directed to functions to be performed when the generation apparatus 50 operates and eligibility requirements of name data. Further, names as herein used refer solely to underlying names viewed from field code side.

(5.01 Components of the Generation Apparatus 50 in FIG. 5)

FIG. 5 is a diagram illustrating functional configuration when electronic file creation processing is performed in the generation apparatus 50 according to an exemplary embodiment of the present invention. As illustrated in FIG. 5, the generation apparatus 50 comprises a name control unit 71, a storage unit 72, an instruction information receiving unit 73, a name generation unit 74, a name proliferation unit 75, a name changing unit 76, a name evacuation setting unit 77, a name combining unit 78, and a final combining unit 79.

(5.02 Software for the Generation Apparatus 50 in FIG. 5)

Functions of the components illustrated in FIG. 5 are realized by the CPU 51 illustrated in FIG. 4 deploying on the RAM 53, the electronic file creation software 55B such as MS Word stored in the HD 55 and dedicated program 55C such as macro. Hereinafter, respective functions of the generation apparatus 50 will be described.

(5.03 Name Control Unit 71 in FIG. 5)

The name control unit 71 controls integrally the entire name generation processing of the generation apparatus 50. Specifically, the name control unit 71 is capable of supplying respective instructions input by the instruction information receiving unit 73 to any of the name generation unit 74, the name proliferation unit 75, the name changing unit 76, the name evacuation setting unit 77, the name combining unit 78, and the final combining unit 79, causing processing results from each unit to be output on the display 58, or to be stored in the HD 55 via the HDD 56. In FIG. 5, the name control unit 71 is shown to include all of the name generation unit 74, the name proliferation unit 75, the name changing unit 76, the name evacuation setting unit 77, the name combining unit 78, and the final combining unit 79, but the name control unit 71 may be configured not to include the name evacuation setting unit 77. Further, unlike FIG. 5, the name control unit 71 may be provided independently of the name generation unit 74, the name proliferation unit 75, the name changing unit 76, the name evacuation setting unit 77, the name combining unit 78, and the final combining unit 79.

(5.10 Electronic File 72A in FIG. 5; General Remarks)

The electronic file 72 is a storing/saving destination when names are created, proliferated, and combined. In other words, in an electronic file 72A, some of original names, which will become underlying names incorporated into anchors and underlying names incorporated into hyperlinks upon creation of names, are saved just as raw texts (hereinafter, the electronic file 72A may be referred to as “currently being prepared names 72A” or “names 72A” as appropriate).

(5.11 Electronic File 72B in FIG. 5; General Remarks)

Further, in the electronic file 72B, the names of anchors and hyperlinks are stored in XML format. In the case of MS Word, in the process of proliferation, the name of an anchor is displayed enclosed with double quotations, viz., <w:bookmarkStart w:id=“Number” w:name=“NAME”/> as displayed in the seventh line of matching text in FIG. 15. The name of a hyperlink is displayed enclosed with double quotations, viz., <w:hyperlink w:anchor=“NAME” w:history=“Number”/> as displayed in the first to sixth lines of matching text in FIG. 15. Both hyperlinks and anchor are saved in a state of science in the setting region 3 or verbatim in the setting region 4. Hereinafter, the electronic file 72B is referred to as “currently being created names 72B” or “names 72B” as appropriate. In each processing step of the name control unit 71, saving format of the names will be changed as appropriate.

(5.12 Electronic File 72C in FIG. 5; General Remarks)

Further, the electronic file 72C is a file in a state where multilateral jumping functions of the setting region 3 or 4 is enabled. Hereinafter, the electronic file 72C is referred to as “already-combined names 72C” or “names 72C” as appropriate. Names used in 5.00 through 5.99 entirely refer to the underlying names as seen from field code or in XML format, not the apparent names displayed when DOCX file is opened.

(5.13 Storage Unit 72 in FIG. 5: Positioning)

Furthermore, the currently being created names 72B can save data temporarily copied by the name generation unit 74, the name proliferation unit 75, and the name evacuation setting unit 77. Further, the currently being created names 72B can save data newly created by the name changing unit 76, and the name combining unit 78. Also, the storage unit 72 can supply the above described data to the CPU 51 according to instructions from the name control unit 71.

(5.20 Currently being Prepared Names 72A: Sample of Names)

The currently being prepared names 72A in FIG. 5 are names before the generation apparatus 50 operates. In accordance with the instructions of the name control unit 71, the currently being prepared names 72A will be incorporated into proliferation step and become anchor names, then become hyperlink names. FIGS. 6A and 6C are diagrams for explaining a configuration of the currently being prepared names 72A in FIG. 5 as an example. The name illustrated in FIG. 6A is a sample of the name corresponding to a Japanese material of the Convention on Maritime Law of multilingual treaties or conventions, and the name illustrated in FIG. 6C is a sample of the name corresponding to a Japanese material of main treaties or conventions relating to patents of multilingual treaties or conventions.

(5.21 Eligibility Requirements of the Currently being Prepared Names)

In order to create the currently being prepared names 72A, there are several rules to be followed. First, the names 72A shall follow the name rule. This means that, even if names of anchors arranged in location order are extracted into another file in location order, and then, the names are sorted in name order, the order of the names will not change in terms of anteroposterior relationship. The order of the names can be confirmed by sorting the names in advance on spreadsheet software. The order may be also confirmed in MS Word by simultaneously pressing ALT key and X key upon selecting a character to be converted, and viewing the character code thereof. Furthermore, the name is required to be capable of suggesting what the name refers to. However, since matching of underlying name is the only requirement for jumping, the name is not required to strictly denote what the name refers to. Subsequently, the eligibility requirements of the currently being prepared names 72A will be described hereinafter.

(5.30 <°> in Leading Punctuation 83)

The first character in the first area of the name shown in FIGS. 6A through 6D (this part functions as a leading control region, hereinafter referred to as a “leading punctuation”) is <°>. The leading punctuation 83 <°> functions to prevent the name from starting with a numeral since MS Word does not allow any anchor name to start with a numeral regardless of whether the numeral is ASCII or full width character. In some cases, it is preferable to use <^{a}> in place of <°>. Since <^{a}> is arrayed prior to <°> when the names are sorted in the name order, and therefore it is more suitable to use <^{a}> as a character in the first area of the name in order to create a table of contents that should come prior to Articles of the PCT. For more details, refer to 7.51.07.

(5.31 Using <^{a}> and <°> to Punctuate Segments of Name)

The reason for using characters such as <°> and <^{a}> to punctuate the segments of the name is that these characters have a background with a large blank, which allows user to easily recognize segment boundaries of the name. This means that these characters including, but not limited to, <°> and <^{a}> are useful for user to make replacement of name segments free of mistakes in an enormous enumeration of characters such as document.xml in XML format (processing in FIG. 15 and FIG. 18). However, for the sake of improvement of operability, it is preferable to use characters such that word processors do not restrict the use thereof as a leading character of the name of anchors.

(5.40 Dividable into Segments)

Next, the names 72A each must be composed of several segments representing data layers. The segments are required to be punctuated by <°> and/or the like to ensure that any change or replacement of a segment can be performed without errors. These punctuations may belong to adjacent segments or may be separated from the adjacent segments. For example, in FIGS. 6A and 6C, the leading punctuation 83 <°> may belong to the highest segment 84 or may be separated from the highest segment 84. In FIG. 6C, the punctuation 85 <°°> may belong to the second highest segment 88 or may belong to the second lowest segment 86. Furthermore, <°> appearing prior to the lowest segment shown in FIGS. 6A and 6C may belong to a segment 86. This means that as for <°> attached to the name, it does not matter which segment <°> belongs to.

(5.41 Dividing a Segment into Short Segments)

However, when the number of characters in a segment is large, CPU is heavily loaded during automatic replacement processing.

(5.50 Subject Region)

Next, the description hereinafter is directed to the fact that a name is divided into segments and easy to be replaced. The highest segment 84 in FIG. 6A or 6C is a segment that constitutes a part of a subject region 81. The last letter of the highest segment 84 within a subject region 81 according to the present exemplary embodiment suggests the language of the material referred to by the name. For example, in the electronic file 1 illustrated in FIG. 1, characters such as <F> for French, <E> for English, <J> for Japanese are used.

(5.51 First Letter of Subject Region)

In contrast, a numeral is employed as the first letter of the highest segment 84 in FIG. 6A and FIG. 6C, and the second highest segment 88 in FIG. 6C. The numeral is required to create the links 1 to 6 (the region 5 in FIG. 1) in ascending order of character codes. Since <F>, <E>, <C>, <J>, <G>, <R>, and <S> are not arrayed in the order of character codes, numerals 1 to 7 are attached as respective sort keys to be arrayed in the order of character codes, thereby satisfying the order rule.

(5.52 Sort Key of the Second Highest Segment)

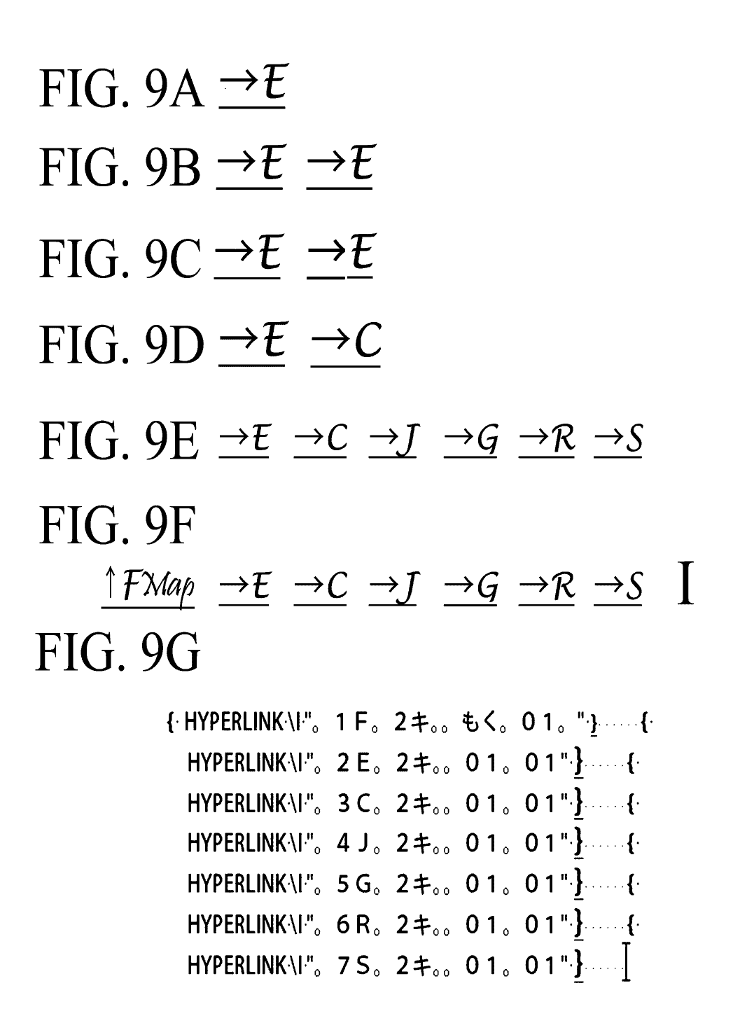

In an electronic file containing most of famous patent-related treaties or conventions, whereas the highest segment 84 in FIG. 6C suggests the language, the second highest segment 88 in FIG. 6C suggests the name of convention. The first letter of the segment functions as a sort key to be sorted in the order of character codes and the last letter of the segment functions to suggest the convention to be represented. Basically, the first letter serves only as the sort key. However, there may be a case in which a numeral is sufficient to suggest what the segment represents. For example, in FIG. 9G, the second highest segment 88 is <2‡>, which suggests Regulations under the PCT. Though not illustrated, <0‡> suggests Paris Convention and <1‡> suggests the PCT. Therefore, the first letter can not only serve as the sort key but also function as a part of the name.

(5.60 Other Use of <°><^{a}>)

As already described above, <°> is used not only as the leading punctuation 83 (FIGS. 6A to 6D) but also as the punctuation between segments in order to eliminate the probability of any mistake caused by replacement or change. For example, in the case of <2E°> and <2‡°°> shown in FIG. 18, the punctuation can also serve as the sort key. In the case of, for example, <°^{a}table> and <°°TABLE> shown in FIG. 18, the punctuations <°^{a}> and <°°> serve as the sort key to clearly indicate a boundary between <table> and <TABLE>, or a turning point from <table> to <TABLE>, as will be defined later.

This means that, it is convenient, for example, in order to create tables of contents of patent-related multinational treaties or conventions, if <^{a}> is placed at the same positions counting from the leading punctuation 83 of respective columns, the columns started with <^{a}> is arrayed prior to the columns started with <°>.

(5.70 Lower Level Region)

Finally, a lower level region, i.e., the Article/Clause region 82 of the name will be described. The Article/Clause region 82 represents each Article/Clause of treaties or conventions. The lower level region is constituted by second lowest and lowest segments 86 and 87. The second lowest and the lowest segments 86 and 87 in the Article/Clause region 82 in FIG. 6A and FIG. 6C are each constituted by 2 digit numerals, which represent a bullet numbering of a specific item, thereby suggesting the item. For example, <°°01°01> is used to suggest Rule 1.1 of Regulations under the PCT regardless in which language the material is written. Even though the Article/Clause region 82 has different names in respective languages in section of the highest level, Rule 1.1 is created as <°°01°01> common to any languages.

(5.71 Control in the Lower Level Region)

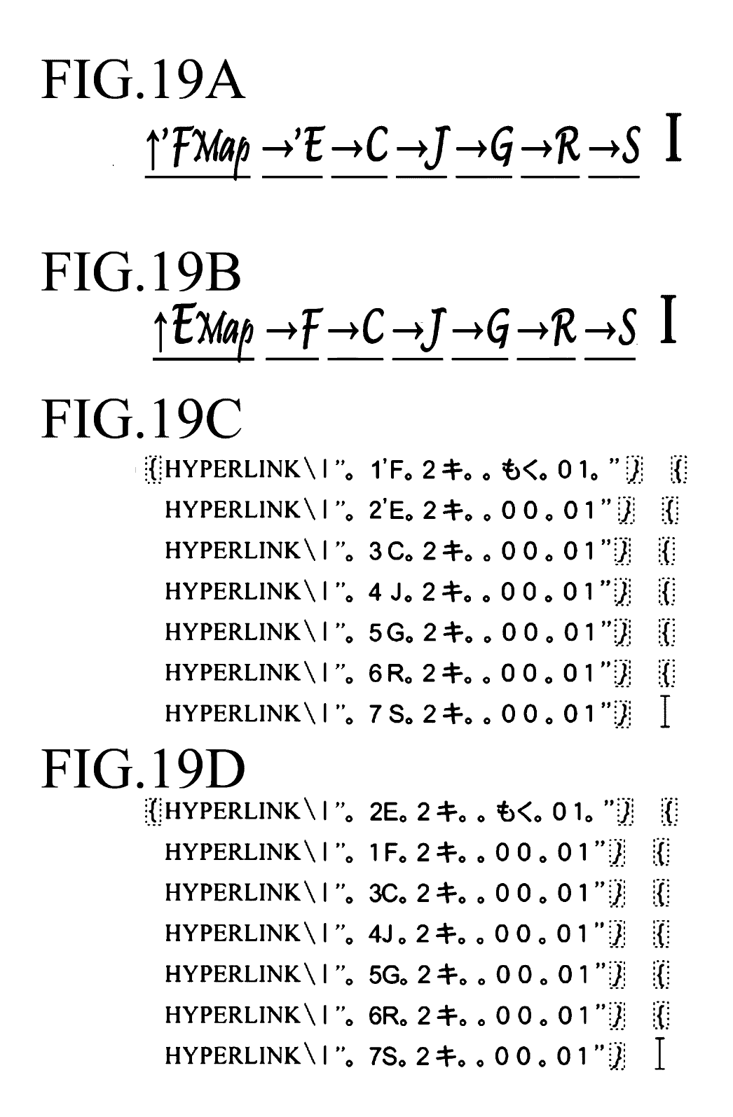

The lower level region 82 serves as a control region acting as both meaning control region and numeric values sorting region. After adding a numeric values serving as a sorting function, Names of Articles/Clauses are arrayed in the order of appearance of the names of Articles/Clauses. The string length of the lower level region, i.e., the Article/Clause region 82 should be preferably constant for readability. In the present embodiment, since the number of the bullet numbering does not exceed 100, the second lowest and the lowest segments are aligned with 2 digits to serve as sort keys. Also, since the second lowest and the lowest segments are aligned with 2 digits, user's eye line can be kept stable with respect to other Articles/Clauses (in FIG. 9G and FIG. 15, FIG. 18, FIGS. 19C and 19D).

(5.80 Turning Points and Sorting in Hierarchical Order)

In the present embodiment, there are four major hierarchical layers: Title; Short Table of Contents; Long Table of Contents; and specific materials, and there is a need of creating verbatims for each layer. Since it is also required to array the entire verbatims in the above order, a layer sort key is required to follow the subject region 81. Although numerals 1 to 4 may suffice for this purpose, in the present embodiment, the punctuation 85 (which will be also referred to as “a growth point” hereinafter) in FIGS. 6A and 6C is employed as the sort key in addition to the visual role to make it possible for user to easily distinguish the segments, as described above.

The growth points (the segment 85 in FIGS. 6A and 6C) are created at the same positions with respect to columns counting from the leading control region (the region 83 in FIGS. 6A through 6D) which is the head of underlying name. In this case, names may be arrayed in the order of the character codes in such a manner as <^{aa}> for title heading of convention, <^{a}°> for Short Table of Contents, and <°^{a}> for Long Table of Contents, and <°°> for material.

Even when vertical positions of the next lower levels start with the same <01> respectively, if the character codes of sections of the growth points used in the above order do not end, the next <01> will not start. As a result, the names can be controlled using different sections. This means that, by causing the sections to have hierarchical control function of names, even if numeric values that should begin with the same 1 are used in any of titles, Parts, Articles, Clauses, respectively, it becomes possible to define and classify regions at any level they have been described. Assuming that <°> of the leading punctuation (the region 83 in FIGS. 6A and 6C) be a decimal point, it is possible to consider that the character codes are arrayed in such a manner that they were aligned after the decimal point.

(5.80.01 Turning Points in Regulations Under the PCT)

Hereinafter, the turning points will be described in details. In the case of Regulations under the PCT as an example, it is necessary to consider four types of the turning points in regards to Titles, Parts, Rules, and Clauses, as described above. Then, the four types are arrayed in the order of Titles, headings of respective Parts, headings of respective Rules, and headings of respective Clauses, and the each of character codes will be defined so that the order may not be reversed. More particularly, in the example of Regulations under the PCT, the punctuation 85 may be, for example, <^{aa}> for Title, <°^{a}> for Parts (Short Table of Contents), <°°> for Rules (Long Table of Contents) and Clauses (specific materials), in the order of character codes thereof. When imagining an entire sequence of the underlying names of the anchors, a point where the punctuation 85 changes from <°^{a}> to <°°> and the like is referred to as “a turning point”, which represents a boundary of layers. However, the basic role of the punctuation 85 is to visually punctuate between segments and does not necessarily serve as the layer sort key. For example, the punctuation 85 does not change at the fourth turning point, the reason of which will be described later.

(5.80.02 String Length of Names and Well-Organized Display)

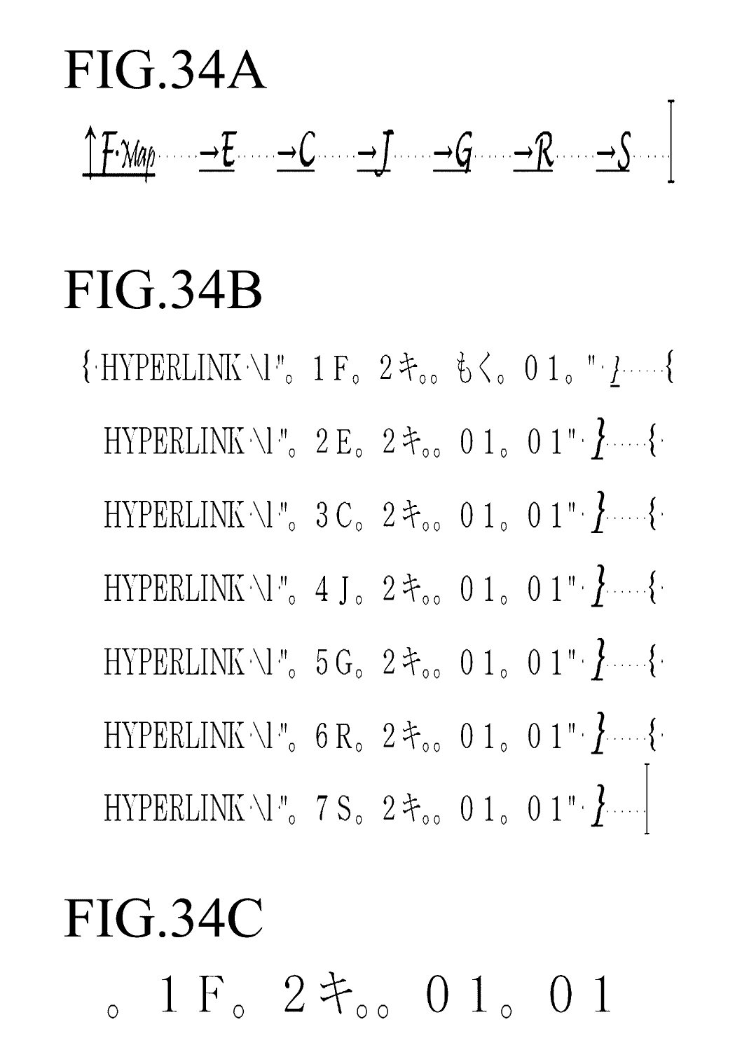

There is a problem of sub-numbers, which irregularly lengthens the names. In the case of Regulations under the PCT, for example, branch provisions of additions/revisions are increasing in number in recent years. It is also necessary to orderly align the names (FIG. 34) by adjusting the number of characters, and using an auto-word wrap function. For example, since there is a long name provision like Rule 90bis, 3bis in the Regulations under the PCT, it is necessary to create underlying names so that they can be orderly aligned by the auto-word wrap function. However, in the case of architectural drawings as will be described later, in which there is no Article/Clause region, names are never proliferated in the lowest segments by using the Second Process. Description hereinafter will be directed to the turning points centering on the highest segments will be considered.

(5.81 Science for Title as Turning Point)

To begin with, Title of Regulations under the PCT is described at the outset of the material in each language, under which Short Table of Contents is described as the content. Further, at the location of Title, a science, from which user can jump to corresponding Titles (Regulations under the PCT) in other languages, is arranged. Following the underlying names of the hyperlinks in the science, the underlying name of the anchor A (A in FIG. 1), to which user can jump from the hyperlinks in the other languages, is created. The anchor A constitutes the first turning point. For example, an anchor A in a science for French has a name such as <°1F°2‡^{aa}RULE of PCT> including “F” that suggests French, and an anchor A in a science for English has a name such as <°2E°2‡^{aa}RULE of PCT> including “E” that suggests English.

(5.82 Science for Short Table of Contents as Turning Point)

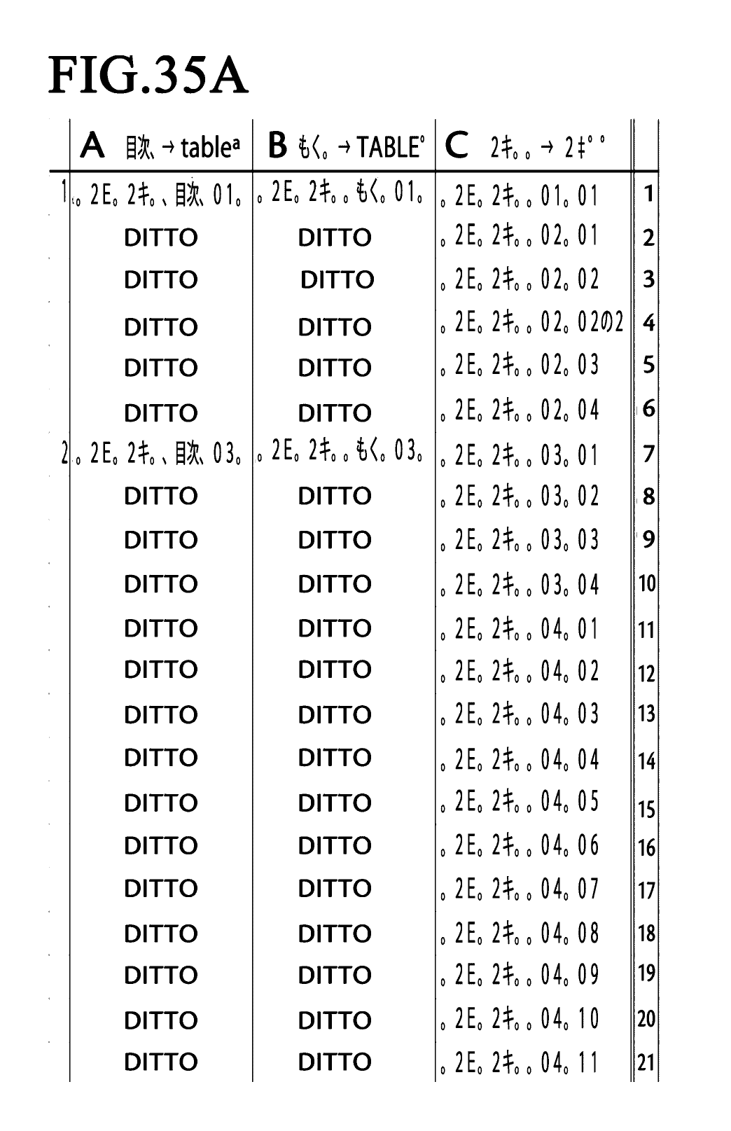

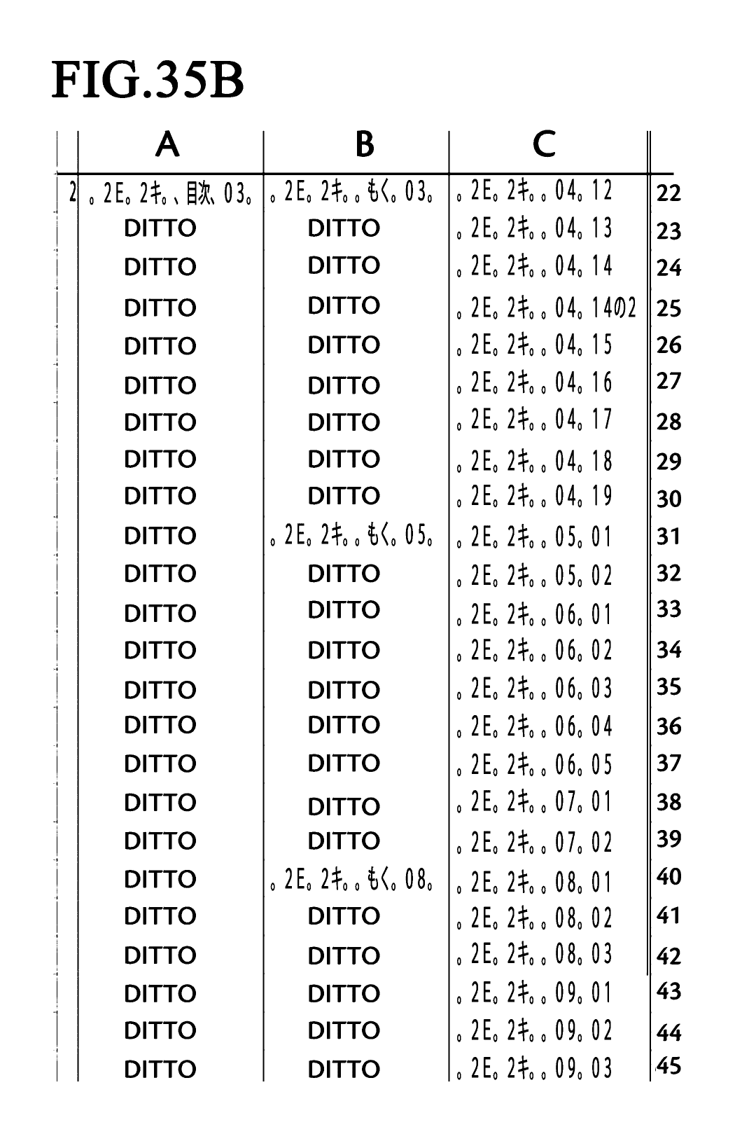

Next, in Short Table of Contents, which is the second hierarchical layer, Rule titles are described as the content. Furthermore, at several locations in Short Table of Contents, sciences, from which user can jump to corresponding locations in Short Table of Contents of other languages, are arranged. Following the underlying names of the hyperlinks in each science, the underlying name of the anchor A (A in FIG. 1) is created. The first anchor for Short Table of Contents constitutes the second turning point. For example, an anchor A of a science for French has a name such as <°1F°2‡°^{a}table^{a}01°>, and an anchor A of a science for English has a name such as <°2E°2‡°^{a}table^{a}01°> (the column A in FIG. 35A). Since the punctuation <°^{a}> is larger in character code than <^{aa}> used for Title, the entire anchors in Short Table of Contents can appear following the anchor for Title in the “Edit Hyperlink” window of FIG. 3A.

(5.83 Sciences for Long Table of Contents as Turning Points)

Furthermore, in Long Table of Contents, which is the third hierarchical layer, Clause titles are described as the content. At several locations in Long Table of Contents, sciences, from which user can jump to corresponding locations in Long Table of Contents of other languages, are arranged. Following the underlying names of the hyperlinks in each science, the underlying name of the anchor A (A in FIG. 1) is created. The first anchor for Long Table of Contents constitutes the third turning point. For example, an anchor A in a science for French has a name such as <°1F°2‡°°TABLE°01°>, and an anchor A in a science for English has a name such as <°2E°2‡°°TABLE°01°> (the column B in FIG. 35A). The punctuation <°°> is larger in character code than <°^{a}> used for anchors in Short Table of Contents, which causes the entire anchors in Long Table of Contents to appear following the anchors in Short Table of Contents in the “Edit Hyperlink” window of FIG. 3A.

<table> suggests Long Table of Contents. Upon arraying according to the character codes, <TABLE> of which the character code always starts prior to <table>. Since <°°> is placed in front of <TABLE> like <°°TABLE>, <°°TABLE> will be always placed later than the name <°^{a}table> of the table of content in Kanji. In this manner, if layers including sections are created, it is possible to easily place 2 earlier than 1.

(5.83.01 Sciences for Materials as Turning Points)

Following the heading of each Clause, which is the fourth hierarchical layer, a specific Regulation under the PCT is described as the material. Further, at the location of the heading of each Clause, a science, from which a user can jump to corresponding Clauses in other languages, is arranged. The reason for creating the science for each Clause is that, in the case of Regulations under the PCT, each Clause of Regulations under the PCT may have considerable length of texts. Following the underlying names of the hyperlinks in each science, the underlying name of the anchor A (A in FIG. 1) is created. The first anchor for the material constitutes the fourth turning point. For example, an anchor A in a science for French has a name such as <°1F°2‡°°01°01>, and an anchor A in a science for English has a name such as <°2E°2‡°°01°01> (the column C in FIG. 35A). At this time, the punctuation 85 is <°°> and not different from that for Long Table of Contents. Here, not the punctuation 85, but the second lowest segment 86 serves as the layer sort key. It is to be noted that the <0 1> in the column C in FIG. 35A is constituted of full-width numerals and therefore larger in character code than <TABLE> in column B in FIG. 35A, which causes the entire anchors for Clauses to appear following the anchors for Long Table of Contents in the “Edit Hyperlink” window of FIG. 3A. Furthermore, in the column C in FIG. 35A, as represented like <°°01°01>, <°°01> represents Rule 1, and <°01> represents Clause 1, thereby making it possible for the hierarchical layers to be easily distinguished.

(5.84 Completion of Turning Points)

As described above, after the turning points have been respectively prepared for Title, Parts (Short Table of Contents), Rules (Long Table of Contents), and Clauses (specific materials), and currently being prepared names have been created, then the operation enters into the stage of processing by the instruction information receiving unit 73 (FIG. 5), and the currently being prepared names are processed according to rules of large-volume production and turn into anchor names and hyperlink names.

(5.85 Definition of Turning Points)

To describe again, the turning points refer to, in the case of Regulation under the PCT, the starting points of the new hierarchical layers in the sequence of the anchor names for Title, Parts (Short Table of Contents), Rules (Long Table of Contents), and Clauses (specific materials). The anteroposterior relationship among the turning points is never violated owing to the presence of the punctuation 85 as the layer sort key.

Even if a numeric value such as <1> or <0 1> or character appears in each of the sections, the numeric value or character maintain stable at a position to ensure that the array of hierarchy is fixed at any time and anteroposterior relation is never changed. Furthermore, upon performing operation of the names by using these turning points, the turning points are created in a state easy to view what the names mean. This means that, the turning points can be defined as a tool to hierarchize the names with respect to segments of the names based on the name rules. For example, the fact that <^{a}°01> is arrayed posterior to <^{aa}99>, ignoring a visible magnitude of numeric number, leads to the fact that the currently being prepared names have started.

(5.86.1 Actual Example of the Prepared Names)

The description hereinafter is directed to the prepared names by way of actual examples. FIGS. 35A and 35B show the underlying names for English, of Regulations under the PCT for respective countries, and the column A contains the underlying names for Short Table of Contents, the column B contains the underlying names for Long Table of Contents, and the column C contains the underlying names for the materials, each of which will be located in the second line in FIG. 34B. On the other hand, each of the above names will appear “→E” as the apparent name suggesting “English” in the science in FIG. 34A.

(5.86.2 Explanation of FIGS. 35A and 35B)

The columns A to C in FIGS. 35A and 35B are used to constitute three types of sciences as follows. First, columns B and C respectively constitute the TOC link and the anchor of the science for the material, i.e., the name shown in column C can be interpreted as the anchor, and the name shown in column B can be interpreted as the TOC link allowing a user to jump to Long Table of Contents. Next, columns A and B respectively constitute the TOC link and the anchor of the science for Long Table of Contents, which is the destination of the above jump, i.e., the name shown in column B can be interpreted as the anchor, and the name shown in column A can be interpreted as the TOC link allowing a user to jump to Short Table of Contents. Finally, column A constitutes the anchor of the science for Short Table of Contents, which is the destination of the above jump, i.e., the name shown in column A can be interpreted as the anchor. Here, the TOC link allowing a user to jump to the science for Title is uniquely given in advance, and therefore not shown.

(5.86.3 Observation Based on FIGS. 35A and 35B as List of Anchor Names)

Viewing FIGS. 35A and 35B as a list of anchor names, following the first anchor name (not shown) for Title, the entire names in Column A (Short Table of Contents), the entire names in Column B (Long Table of Contents), and the entire names in Column C (materials) are arrayed in this order, the first rows of Columns A to C being the second to fourth turning points. The above sequence of anchor names is exactly arrayed in the order of character codes thereof because of the presence of the layer sort keys (the punctuation 85 and the second lowest segment 86).

This means that each column has different names like <table> for the column A, <TABLE> for the column B, and <01> for the column C at the ninth column counting from each head of the names. At a position where the last name of the column A ends, the name of the column B starts, and at a position where the last name of the column B ends, the name of the column C starts. In this manner, the names are set up to be arrayed in accordance with the name rule. Thus, it can be determined that a scene where a numeric value of, for example <01> or the like, appears at a ninth position counting from the head of the names is as a turning point.

(5.86.4 Fourth Turning Point at Top Row of Column C in FIG. 35A)

As already described above, at the fourth turning point from Column B to Column C, the punctuation 85 does not change from <°°>, but the second lowest segment 86 changes from <TABLE> to <0 1>. Here, the character code of full-width <0> is greater than that of <T>. Thus, at the fourth turning point, the second lowest segment 86 serves as the layer sort key.

In the case where names of anchors are on the column B and column C in FIGS. 35A and 35B, the characters that determine the anteroposterior order of the both are <table> on the column B and a full-width <01> of material on the column C, at the ninth column counting from the heading of names. This means that, since <table> starts with a character smaller in character code than the full-width <01>, it could be used as names of the anchor of the Long Table of Contents.

(5.86.5 Third Turning Point at Top Row of Column B in FIG. 35A)

As already described above, at the third turning point from Column A to Column B, the punctuation 85 changes from <°^{a}> to <°°>. Here, the character code of <°> (00B0) is greater than that of <^{a}> (00AA). Thus, at the third turning point, the second letter of the punctuation 85 serves as the layer sort key.

In the case where names on the column A and the column B are used for names of anchors, if characters <table> (the column A) and <TABLE> (the column B) respectively placed at the ninth column counting from the headings of names are compared, <table> (the column A) is larger in character code than <TABLE> (the column B) although names are placed in the ascending order of character code.

(5.86.6 Second Turning Point at Top Row of Column A in FIG. 35A)

As already described above, at the second turning point from the anchor name for Title (not shown) to Column A, the punctuation 85 changes from <^{aa}> to <°^{a}>. Here, the character code of <°> (00B0) is greater than that of <^{a}> (00AA). Thus, at the second turning point, the first letter of the punctuation 85 serves as the layer sort key.

In conclusion, <°^{a}> and <°°> placed prior to the start of table (Short Table of Contents) and TABLE (Long Table of Contents) determines the anteroposterior order of names. Though not seen in numeric values, both <°^{a}> and <°°> have character codes, and <°^{a}> is smaller in character code than <°°>. This means that even though the names are sorted in the order of the character codes and placed in the ascending order of the character codes, for example, in the case where <00> is placed posterior to <99> having an absolute value larger than that of <99>, <°^{a}> and <°°> having character codes respectively placed at positions prior to <99> and <00>. In this manner, a portion where a segment having a new hierarchy at the nodes of sections of names (e.g., <^{aa}><^{a}°><°^{a}><°°>) newly appears can be a portion where currently being prepared names have newly started.

(5.87 First Turning Point at the Beginning of Entire Sequence of Anchor Names)

Though not illustrated, the anchor name for Title has been described as the first turning point. This means that the anchor name for Title should not be preceded by any other names in the order of character codes. In the present embodiment, the punctuation 85 is configured to be <^{aa}> in the anchor name for Title to ensure the anteroposterior relationship.

No matter whether a hyperlink or anchor the name is, the name has a decimal point that starts with the leading punctuation <°>, and may have delimiters in-between at respective columns so as to be sorted in the order of character codes. Furthermore, in a state where a digit of a given column of a name after the decimal point is occupied by <^{aa}>, even though any numeric value having a large digit numeric value may follow <^{aa}>, the name will not be placed prior to the predetermined position at which the name should be placed.

(5.87.01 Turning Points for Entire Languages)

The above-described four turning points, viz., Title <^{aa}>, Short Table of Contents <^{a}°>, Long Table of Contents <°^{a}>, and the material <°°>, are created in the English version alone. Since similar descriptions can be created for other language versions, the total number of turning points will be 28, which is calculated by multiplying four by seven. Here, as a language sort key for arraying entire anchor names in an order of language, the first letter of the highest segment 84 should function as well as within the hyperlinks group in the verbatim, as already described above. Thus, the currently being prepared names 72A is prepared in a manner so that anteroposterior relationship among the names 72A is maintained regardless of whether being sorted by name or location.

(5.87.02 Characters Suitable for Punctuations)

As already described above, punctuations such as the leading punctuation 83 and the punctuation 85 mainly plays a visual role allowing a user to clearly distinguish between the segments within underlying names when the processing shown in FIGS. 15 and 18 is viewed. For this purpose, in the present embodiment, characters having large blank background such as <^{a}> and <°> are employed. However, characters suitable for the punctuations are not limited to them, any character having a blank area not less than the half of the character area, such as, for example, superscript or subscript character may be employed.

Furthermore, the verbatims or sciences of different layers such as Title, Short Table of Contents, Long Table of Contents, and the material can be created by adding two characters such as <^{aa}><^{a}°><°^{a}><°°> respectively at the same positions counting from <°> of the respective leading punctuations. In this manner, it becomes possible to mutually compare and examine underlying names while checking the processing shown in FIG. 15 and FIG. 18.

(5.87.03 Aggregation Problem)

Meanwhile, there is a problem of aggregation of table of contents links (simply referred to as “TOC links”) (region B in FIG. 1). A TOC link of the material allows a user to return to a TOC link of Long Table of Contents, the TOC link of Long Table of Contents allows a user to return to Short Table of Contents, and the TOC link of Short Table of Contents allows a user to return to Title. During this process, thinning, i.e., aggregation of the TOC links is necessary for the sake of economy of sciences. For example, in FIG. 35A, the continuous rows of Column B has “DITTO” while the continuous rows of Column C has anchors such as “01” and “02”. Similarly, TOC links from Long Table of Contents (Column B) to Rule titles in Short Table of Contents (Column A) are aggregated as shown in continuous rows of “DITTO” in Column A. Here arises a problem of determining aggregation interval, which will be determined based on the number of items included in each table of contents and the length of material texts.

Furthermore, the thinning interval, hereinafter referred to as “aggregation interval”, should be determined. In the case of Short Table of Contents and Long Table of Contents intervening between the Title and the material, the aggregation interval should be determined based on the number of items and the length of sentences of the material arranged under the respective tables of contents.

(5.87.04 Method of Determining Aggregation Interval)

In the present embodiment, the texts in German and Russian versions tend to be large (sometimes twice larger than the same texts in Chinese version) in volume. Therefore, it is preferable to aggregate the number of destinations of the TOC links for the sake of referential convenience in German and Russian versions.

If there are too many items, it takes long time to scroll the texts, and user's memory will be dissipated. On the other hand, if there is extremely small number of items, they will be compiled and an intermediate table of contents will be further placed at the midpoint of finally arriving at the title, but it is also loss of time. As the way how to determine the arrangement, especially German, Russian notations may take twice more sentences than Chinese, and therefore the TOC link can be created on a steady basis by considering how many titles of Parts, Rules, Clauses, having items of how many characters under the umbrella of the table of contents link centering on German, Russian. DITTO in FIGS. 35A and 35B is the corresponding portion

(5.90 Full Width Characters)

Full width (2-byte) characters are seldom used in Western material while ASCII characters are exclusively used for Western sentences. Even in Japanese material, basically, ASCII characters are used in XML format. Therefore, it is preferable to use full width characters as the underlying names of anchors and hyperlinks since it is quite easy to find the full width (2-byte) characters, thereby avoiding conversion errors caused by user's operation. Furthermore, since full width characters are applied with fonts or font styles different from ASCII characters, it is possible to have the field codes less affected by any change in ASCII font or font style (for example, difference in size or shape of character area).

The full width characters are usually not used in the case where materials are written in Western sentences. Therefore, when, for example, the names are inserted into Rules/Clauses of the materials as a result of revisions or like, if the names are written in the full width characters, it is easy to modify or correct them.

(5.91 Precautions to be Taken Inputting Full Width Characters are Inputted)

In the case of MS Word of Microsoft, since an icon of “Aa” (Change Case) is provided in a home ribbon, it is only necessary to choose “Full-Width” from the drop down list. Especially, it is necessary to pay special attention because an alphanumeric character is likely to be inputted in a half width character. Since full width alphabets are used not often in word processors, there may be a case in which although alphanumeric characters are inputted in full width characters, they are automatically converted into half width characters. Even if automatic correction is disabled, numeric values are input in full width characters, and alphabets are subsequently inputted, MS Word function will eventually change the numeric values into half width characters. Whether already inputted characters are full width or half width characters can be determined based on the fact that half width character notations are often applied with font style names used in Western sentences.

(5.92 Character Having Blank Area not Less than the Half of Character Area)

The MS Word file in XML format is not created to be manually edited, and therefore has extremely low readability. However, by using full width characters punctuated by characters, which include not only a full width character but has a blank area not less than the half of the character area, the underlying names of anchors and hyperlinks can easily attach user's attention, thereby making it easy for a user to edit and modify the underlying names. As already described above, the anchor name and the hyperlink name can be distinguished by XML tags, i.e., the anchor name is enclosed between the bookmarkStart tag and the bookmarkEnd tag, while the hyperlink name is embedded in the hyperlink element. Furthermore, when the names are created with <°>, which is a character not only of full width but also having a blank area not less than the half of the character area, the range of changes can be easily identified. This means, although sciences are scattered in XML, the materials, which are completely embedded in XML tagged sentences, the range of changes can be easily identified (see, for example, red parts in FIG. 18).

For this reason, correction can be made easily by specifying a range with respect to a part of NAME part of anchor names, <w:bookmarkStart w:id=“Number” w:name=“NAME”/> surrounded by definite articles named bookmarks present in XML tags directly from XML sentences.

(5.93 Particular Remarks of the Currently being Prepared Names 72A; Saving Format)

The currently being prepared names 72A illustrated in FIG. 5 can be saved in an electronic file such as, for example, Excel files or text files. However, the currently being prepared names 72A may be saved in electronic files other than the above, or may be directly incorporated into the above-described dedicated program 55C. The dedicated program 55C may store a creation rule in advance, and, each time as needed, create and output the currently being prepared names 72A in accordance with the creation rule.

### 6. Description of the Processing of Names in the Name Control Unit

(6.00 Introduction)

Next, description will be provided below focusing on functional aspect of program creation in the name control unit 71 in FIG. 5. The description is also directed to general remarks in relation to respective processes as particular remarks discussed in the next Chapter 7. Names in Chapter 6 can refer to both apparent and underlying names, unlike the names in the above described Chapter 5. Further, when referring to a science in the setting region 3 in FIG. 1 in Chapter 6 or later, the science shall include a verbatim (the setting region 4 in FIG. 1) without a TOC link (the setting region B in FIG. 1) as an example.

(6.10 the Instruction Information Receiving Unit 73 in FIG. 5: General Remarks)

The instruction information receiving unit 73 receives from a user any of name generation instruction, region generation instruction of the setting regions (science, verbatim, and a part thereof) 3, 4 in FIG. 1, name saving instruction, proliferation instruction for names, name changing instruction (evacuation setting instruction, setting information changing instruction may be included), combining instruction, and final combining instruction. Further, the user can perform the above-described instructions from a UI screen (not illustrated) displayed by the dedicated program 55C. These instructions may be executed each time each instruction is inputted by a user directly operating a keyboard 60 or a mouse 61 to CPU 51 and executed in a batch. The reason why the name control unit 71 in FIG. 5 is not configured to have the name saving function is that the name storage unit 72 is provided separately, and the save instruction is described in the name proliferation unit 75.

(6.11 N−1 of Arrangement in the Setting Regions)

In a verbatim of the setting region 4 at page 2 of the electronic file 1 illustrated in FIG. 1, six links 1 through 6 that constitute a hyperlinks group (the setting region 5) are created in the setting regions 6, 7, 8, 9, 10, and 11 respectively, so that jumping can be performed among multinational treaties or conventions in seven languages for each article. FIG. 1 shows →E, →C, →J, →G, →R, →S as an example of the apparent names of the hyperlinks group. The anchor A is arranged subsequent to them. The number of the links 1 through 6 is six and less by one than the number of constituent languages, since the links allow a user to jump from one language to other languages. For example, →F is excluded from FIG. 1, since the science belongs to French material, and there is no need to jump to own language.

(6.12 Order Rule in Setting Regions)

Further, the links to seven languages have the order of →F, →E, →C, →J, →G, →R, based on the order rule that the anteroposterior relationship among the links does not change even if one link thereof is excluded to become the TOC link (the setting region B in FIG. 1). Further, the TOC link at the head refers to the table of contents in the same language as that of the material, which is the excluded language (e.g., ↑F in the above-described example) from the setting regions 6, 7, 8, 9, 10, and 11. Thus, as a whole, seven languages are suggested by the apparent names (FIG. 34A) and the underlying names (FIG. 34B) in the setting region 3 including the TOC link B. Also, the anchor arranged at the end, though not having an apparent name, has the underlying name suggesting the language of the material (French in the example of FIG. 34C).

(6.13 where to Place Anchors)

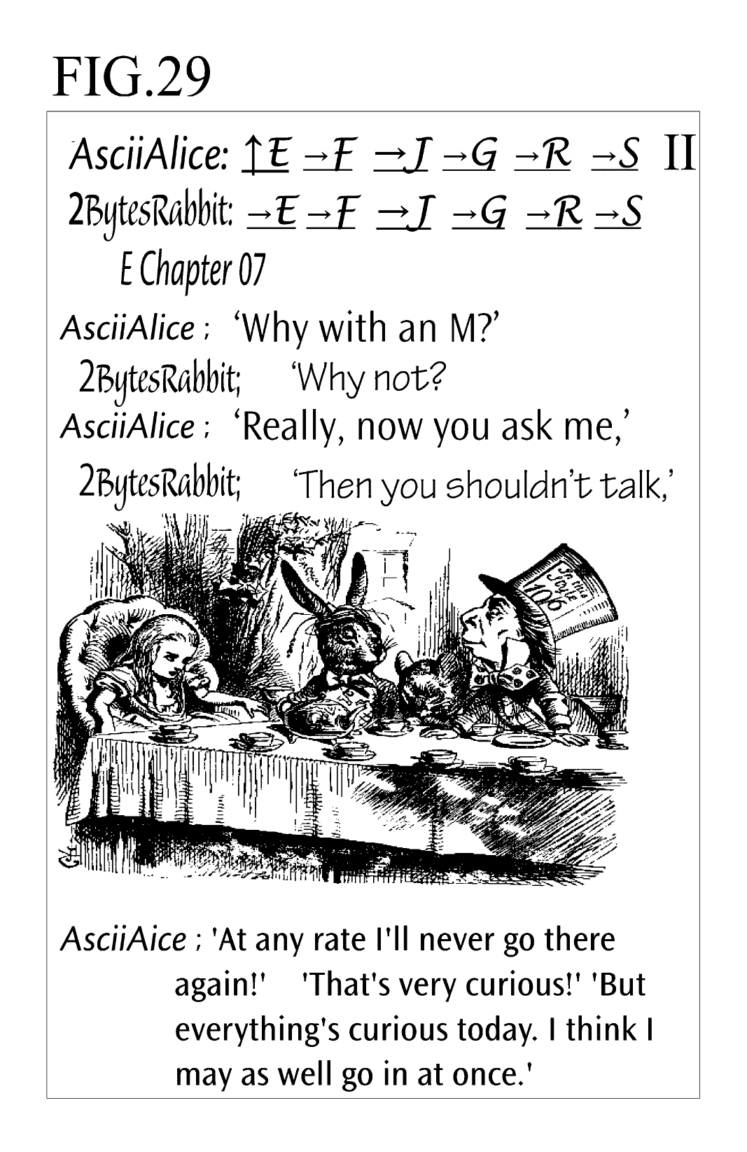

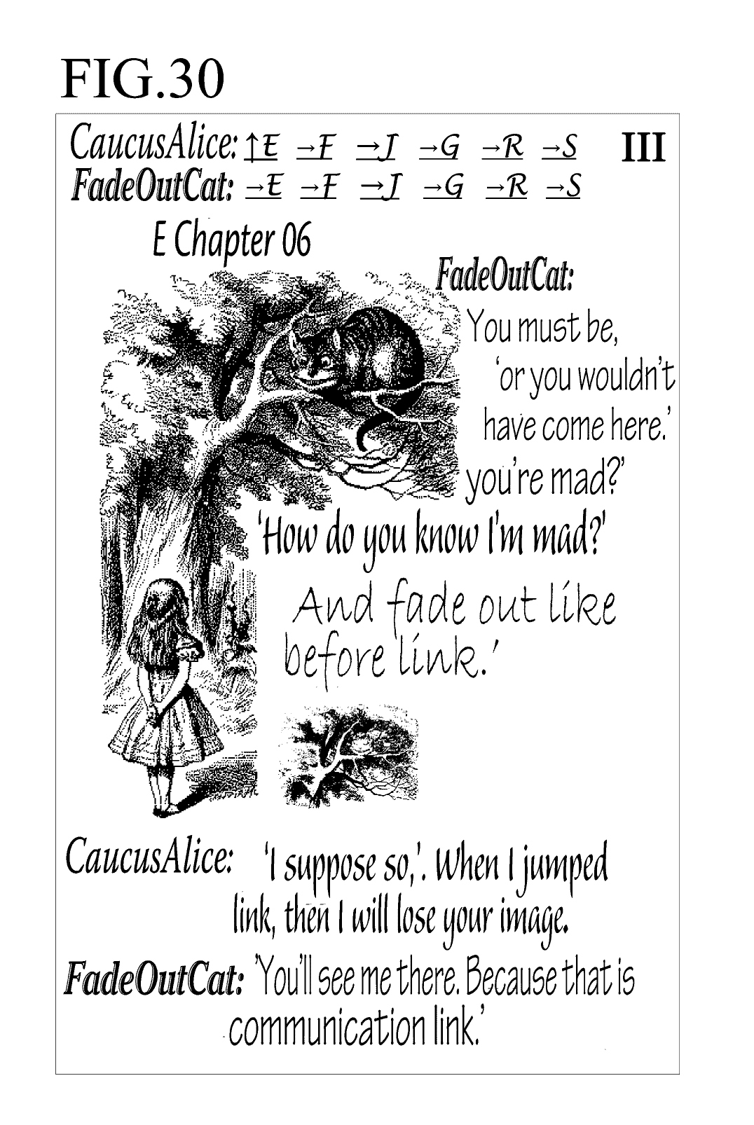

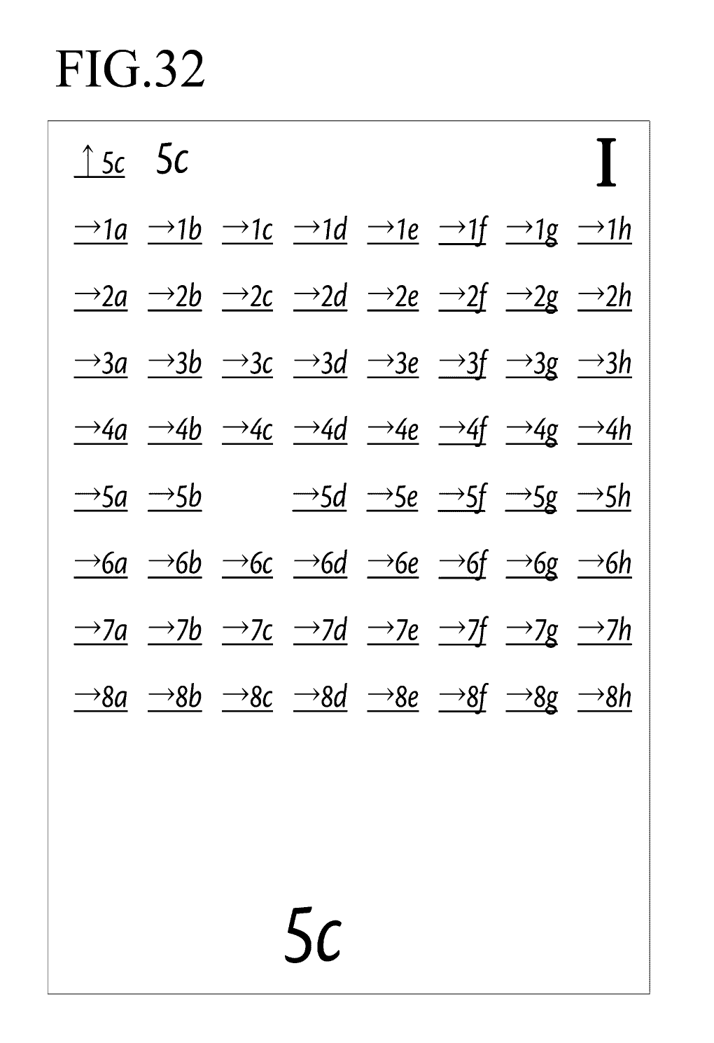

The anchor in the science has not to be placed in a line lower than the line where the apparent names of the hyperlinks are displayed. If an anchor is mistakenly placed lower than the line where the apparent names of the hyperlinks are displayed, when a user jumps to an anchor, some viewer software products allow a user to jump to the line where the anchor is displayed on a top of the screen. In this case, since the line of the science is scrolled out of view, it is bothersome to scroll back and find the science to jump back (especially in a case in which many hyperlinks are displayed as shown in FIG. 32). That is why the anchor is placed on the first line of the hyperlinks in FIGS. 29 and 30.

(6.14 Generation Instruction of Setting Region)

The name generation unit 74 generates at a predetermined position of a page included in an electronic file, at least a part of a science (the setting region 3) including a verbatim (the setting region 4) composed of hyperlinks for allowing a user to jump to anchors set up at other pages, and an anchor for allowing a user to be jumped back to from hyperlinks at the other pages.

(6.15 Proliferation Instruction of Names in Setting Regions)

The name generation unit 74, upon proliferating names to be arranged at positions of the sciences or the verbatims, can create a large number of different underlying names, although there are only several kinds of apparent names, like an example of the electronic file 1 illustrated in FIG. 1. Thereafter, the name generation unit 74 executes processing of proliferating (hereinafter, referred to as “proliferation processing”) sciences or verbatims in sequence at a predetermined page in the electronic file 72 according to a signal from the instruction information receiving unit 73 that has received generation instruction from a user.

(6.16 Generation of Underlying Names in Setting Regions)

Underlying names are also discussed in detail elsewhere, and therefore an overview will be given here for reminding purpose. It is preferable that the underlying name is generated so as to be able to suggest the corresponding apparent name, and segmented to represent the hierarchical layers. For example, human legible punctuations such as <°°><°><^{aa}><^{a}> are employed to divide the name into segments so that the respective segments are easily distinguished. Furthermore, since anchor names are arrayed only in the order of character codes in the hyperlink dialogue box, it is preferable to create the anchor names so that the location order coincides with the order of character codes thereof, thereby eliminating mistakes in creating hyperlinks byway of the hyperlink dialogue box.

(6.17 Uniqueness of the Anchor Name)

Further, when two separate files are combined into the single file, an anchor having already existing name will be automatically deleted. Accordingly, even in the files before being combined, it is necessary to assign different underlying names to anchors. Whereas, in the processing by the name generation unit 74 a plurality of hyperlinks can be created having the same underlying name, since “the name of the hyperlink” is a terminology for convenience particular to the present specification and is actually the name of the destination anchor. When two separate files are combined into the single file, the hyperlinks having the same name present in one file are not excluded.

(6.20 Saving Instruction)

The name proliferation unit 75 can create copies of sciences or verbatims created by the name generation unit 74 and can cause data of the copied sciences to be stored in the storage unit 72. The purpose of copying the names is to double the names, although the names are not only copied but also modified to be different names. For this reason, the above copying processing is not referred to as “duplication” but as “proliferation” in the present specification.

(6.30 Proliferation Instruction)

The name proliferation unit 75 proliferates in another electronic file, the setting region 3 or 4 generated by the name generation unit 74. The name proliferation unit 75 can also proliferate hyperlinks referring to and anchors referred to from other electronic files, which are not to be finally combined. For example, if the files are on the Internet, the link 1 in the setting region 5 in FIG. 5 may be defined as “http//:www.uspto.01.htm#NAME”, the part of “NAME” may be substituted with the URL encoded underlying name of the link 1 in accordance with the name rule and the order rule. The link 2 may be similarly defined as “http//:www.uspto.02.htm#NAME”, and the part of “NAME” may be similarly proliferated. In this case, the file including the above hyperlinks may be referred to as “http//:www.uspto.00.htm”, thereby making it possible for a user to jump among the above-described different files. Therefore, in this case, the above-described <#“°NAME”> referring to the different files will follow the name rules and the name orders.

(6.40 Name Changing Instruction)

The name changing unit 76 is adapted to change, in accordance with the predetermined name rule, names of hyperlinks and anchors included in the setting regions 3 proliferated by the name proliferation unit 75. As another application, in the case in which already-combined names 72C is required to be reused in another electronic file having a material of another multilateral convention, the name changing unit 76 can change the already-combined names 72C. If, for example, a segment <1‡°°> within an underlying name <1‡°°00°00> is selected as change target, and then, replaced with <7‡°°0>, the resultant segment becomes <7‡°°000°00>. This kind of replacement processing is useful for the case in which names for the European Patent Convention (EPC) made up of three-digit number of Articles are required to be generated on the basis of the already-combined names 72C used in the Patent Cooperation Treaty (PCT) covered by two-digit number of Rules, for example.

(6.50 Combination Instruction)

The name combining unit 78 is adapted to combine sciences proliferated by the name proliferation unit 75 into one electronic file. The “combine” means digital processing of copying sciences set up in other electronic files, onto a particular electronic file.

(6.51 Example of Combination Instruction)

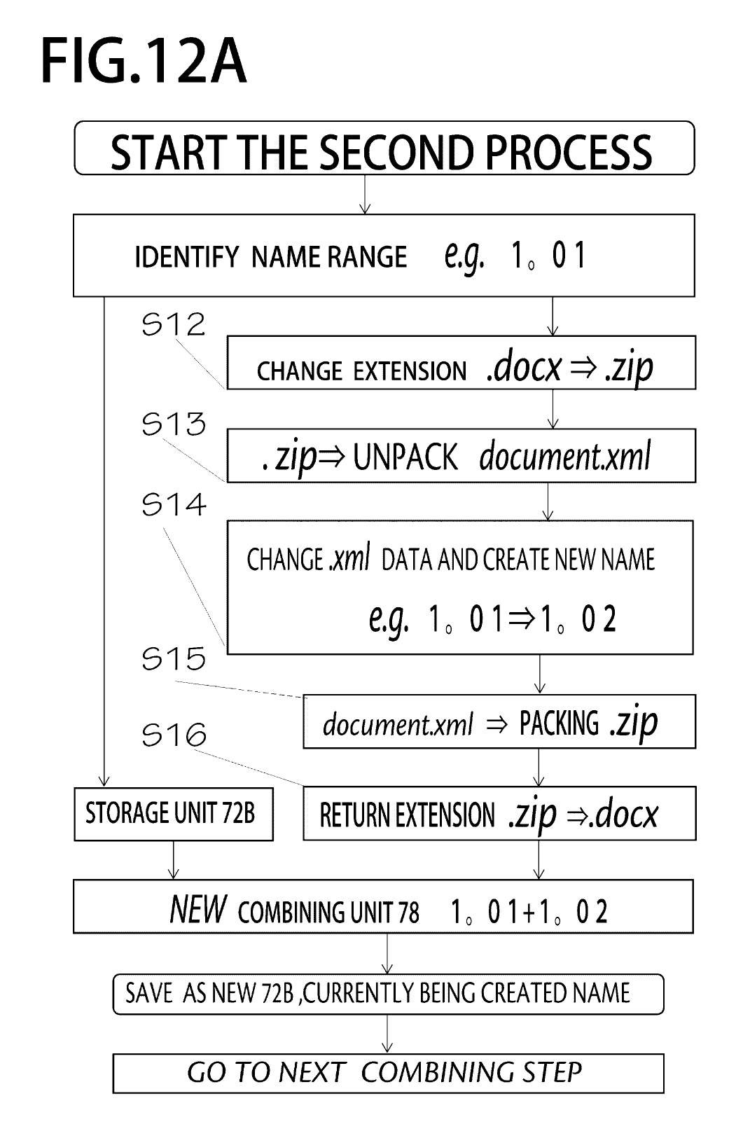

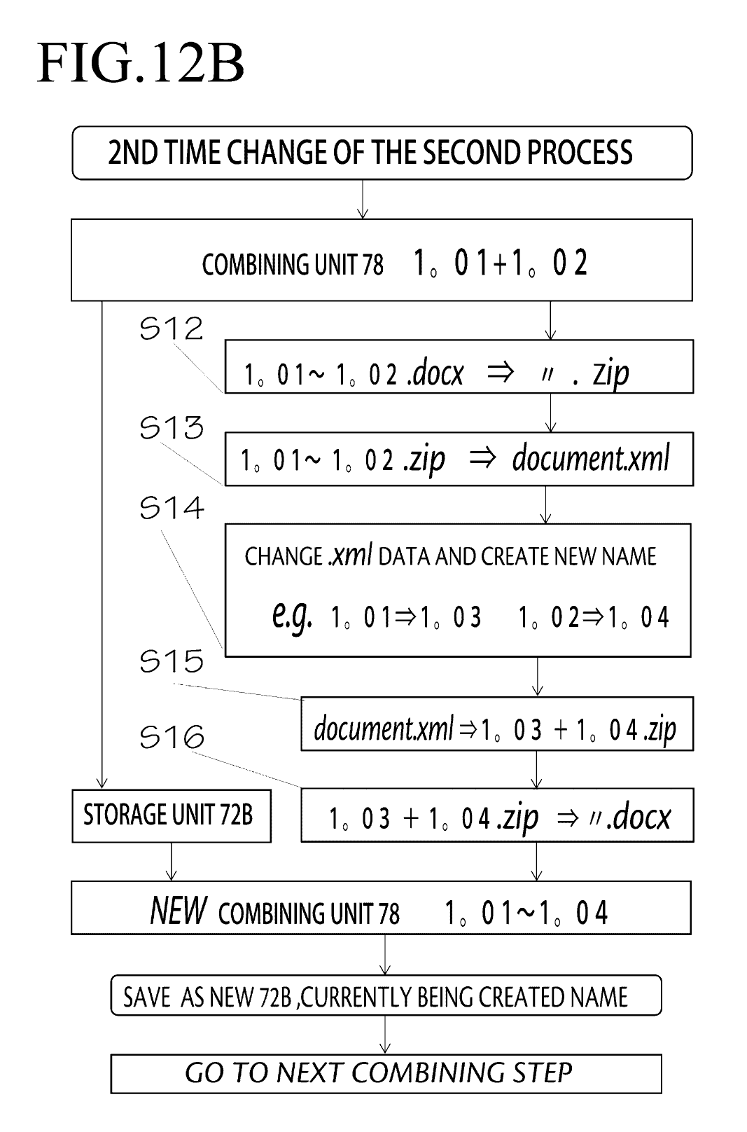

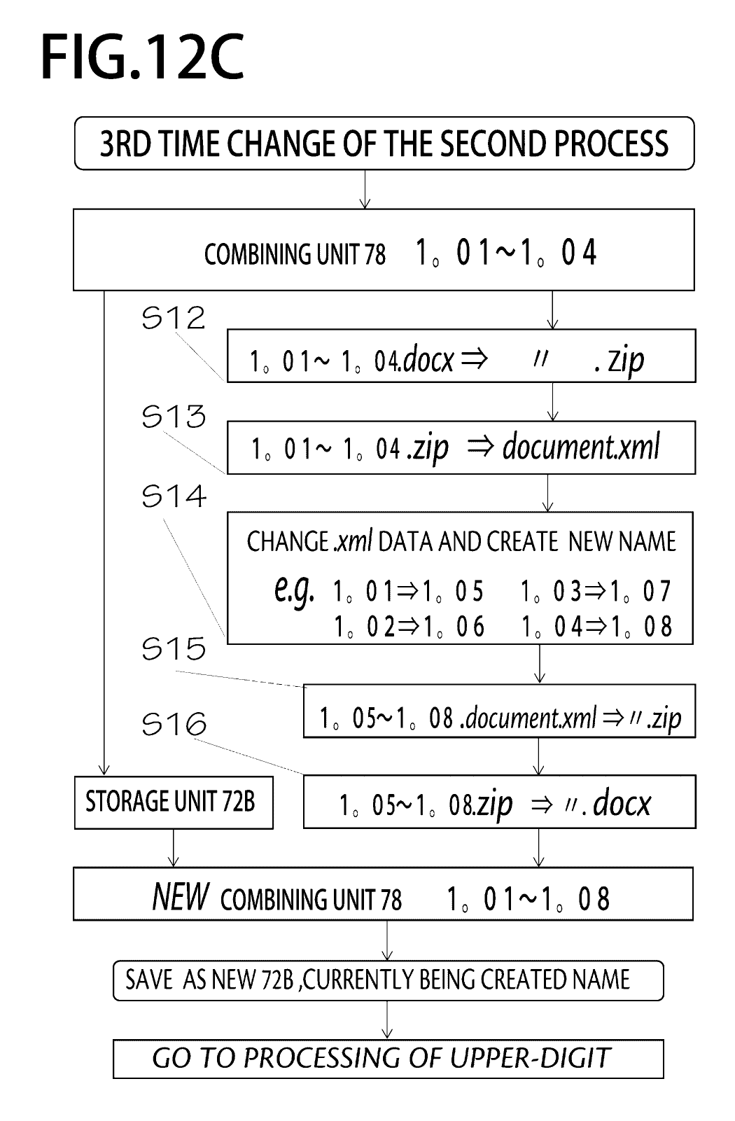

For example, the name combining unit 78 combines two files having the same apparent names “→E→C”, but also having the underlying names such as <°°01°01> and <°°01°02>, into one file (FIG. 12A) of which the first page is “→E→C” composed of only <°°01°01> and the second page is “→E→C” composed of only <°°01°02>.

(6.60 Evacuation Setting Instruction)

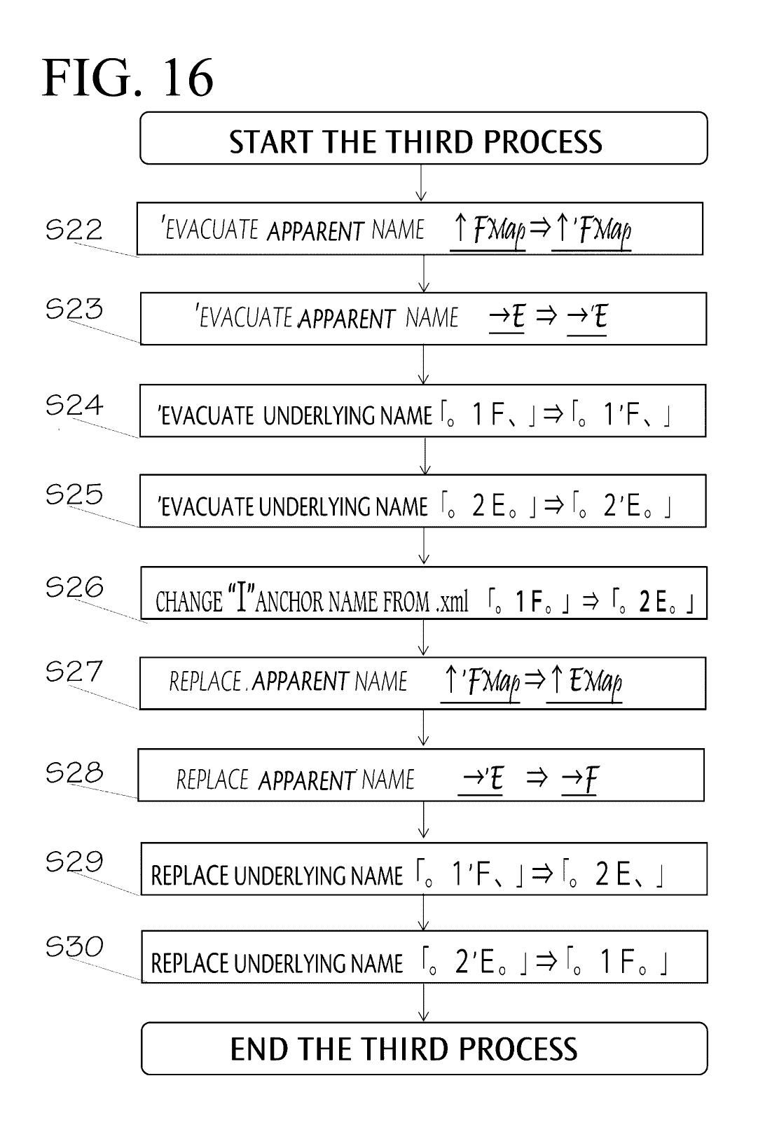

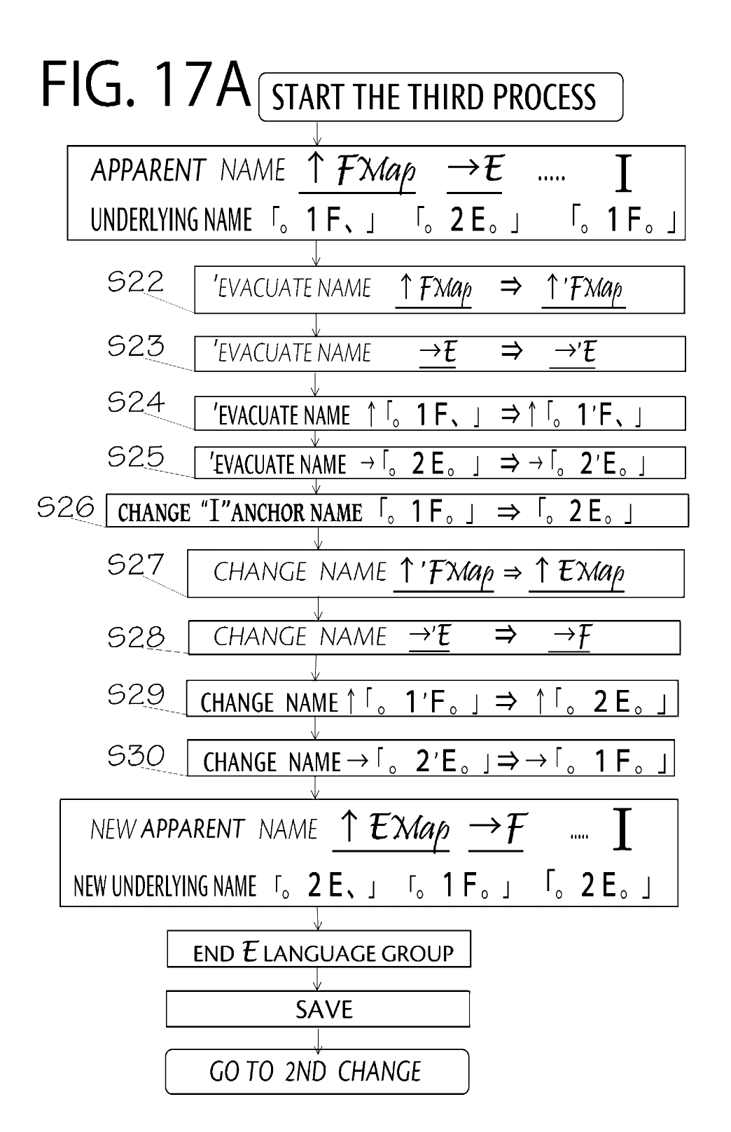

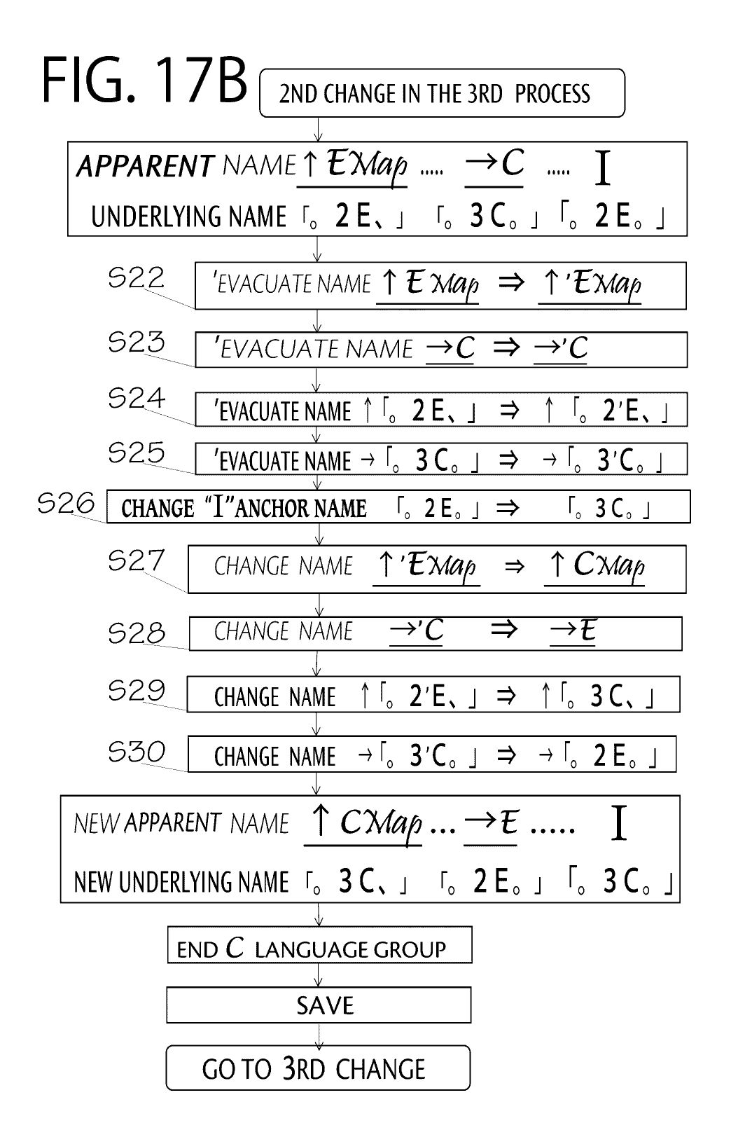

Before the name changing unit 76 changes apparent names and underlying names of links and an underlying name of an anchor belonging to a science starting with a TOC link in the setting regions 3, the name evacuation setting unit 77 is adapted to evacuate some segments of the names not intended to be changed by temporarily replacing them with other names. This means that the name evacuation setting unit 77 is adapted to evacuate both apparent names (for example, step S23 in FIG. 16) and underlying names (for example, step S25 in FIG. 16), and then, name changing instruction of intended anchor is performed, and thereafter, setting information changing instruction is performed.

(6.61 Apparent Name Evacuation Setting Instruction and Setting Information Changing Instruction)

For example, when the sciences of French version are copied and changed into those of English version, the parts “↑FMap” and “→E” in the apparent names are required to be changed into “↑EMap” and “→F”, which is a simple replacement between two letters “F” and “E”. However, the “Replace All” function of MS Word may replace any and all character strings regardless of whether texts are relevant or irrelevant to the target. In this sense, the “Replace All” function of MS Word is a double-edged sword and requires a special care not to destroy irrelevant texts. Therefore, in the present embodiment, the evacuation setting unit 77 performs following four steps of replacing: “↑FMap” with “↑′FMap”; “→E” with “→′E”; “↑′FMap” with “↑EMap”; and “→′E” with “→F” as shown in FIG. 16. The first two steps of temporarily replacing names will be referred to as “evacuation of names” hereinafter. Additional description using FIG. 16 is provided in 9.10.

(6.62 Underlying Name Evacuation Setting Instruction and Setting Information Changing Instruction)

For example, when the sciences of French version are copied and changed into those of English version, the parts <°1F> and <°2E> in the underlying names are to be replaced, and require the following four steps of “Replace All” function of MS Word, i.e., replacing: <°1F> with <°1′F>; <°2E> with <°2′E>; <°1′F> with <°2E>, and <°2′E> with <°1F> as shown in FIG. 16. In addition, actual changes combining the apparent names and underlying names will be described in 9.10 with reference to FIG. 16.

(6.70 Final Combining)

The final combining unit 7 combines the sciences or verbatims created by the name changing unit 76 in one electronic file so that the anchor names are arrayed in the order of character codes thereof. The leading sort key is the first letter of the highest segment 84 (FIGS. 6A and 6C), which is a numeral from 1 to 7. Therefore, combining is performed in the ascending order of the numeral, which will be <1F>, <2E>, <3C>, and so on. After being combined, the names are saved and become already-combined names 72C. In the case of the Third Process described below, it is only after the combining that the verbatims can refer to the destination anchors, and come to have a function as hyperlinks in a narrow sense. In the case of FIG. 2, the final combining unit 79 performs combining in the order of a material file in French having “→E→C”, a material file in English having “→F→C”, and a material file in Chinese having “→F→E”. Respective destination anchors are provided after the combining, thereby making it possible for a user to jump from the hyperlinks to the respective anchors.

### 7. Description of the First Process for Generation Processing

(7.00 General Remarks of the Processes)

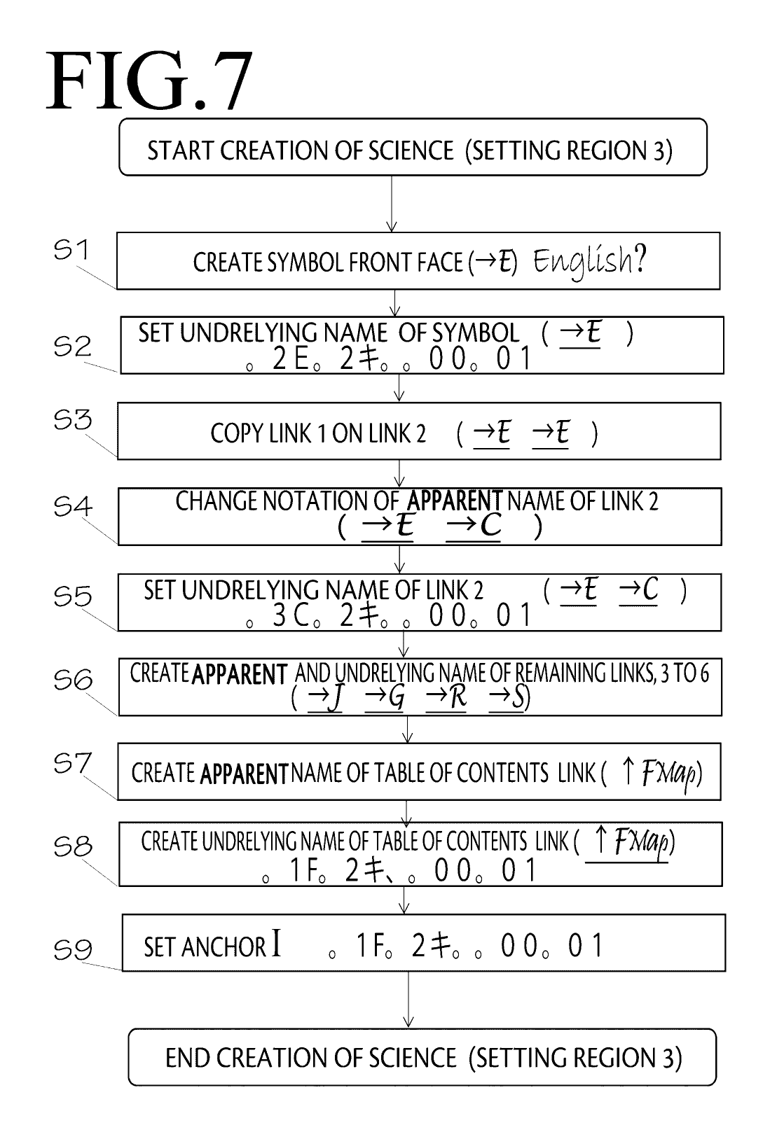

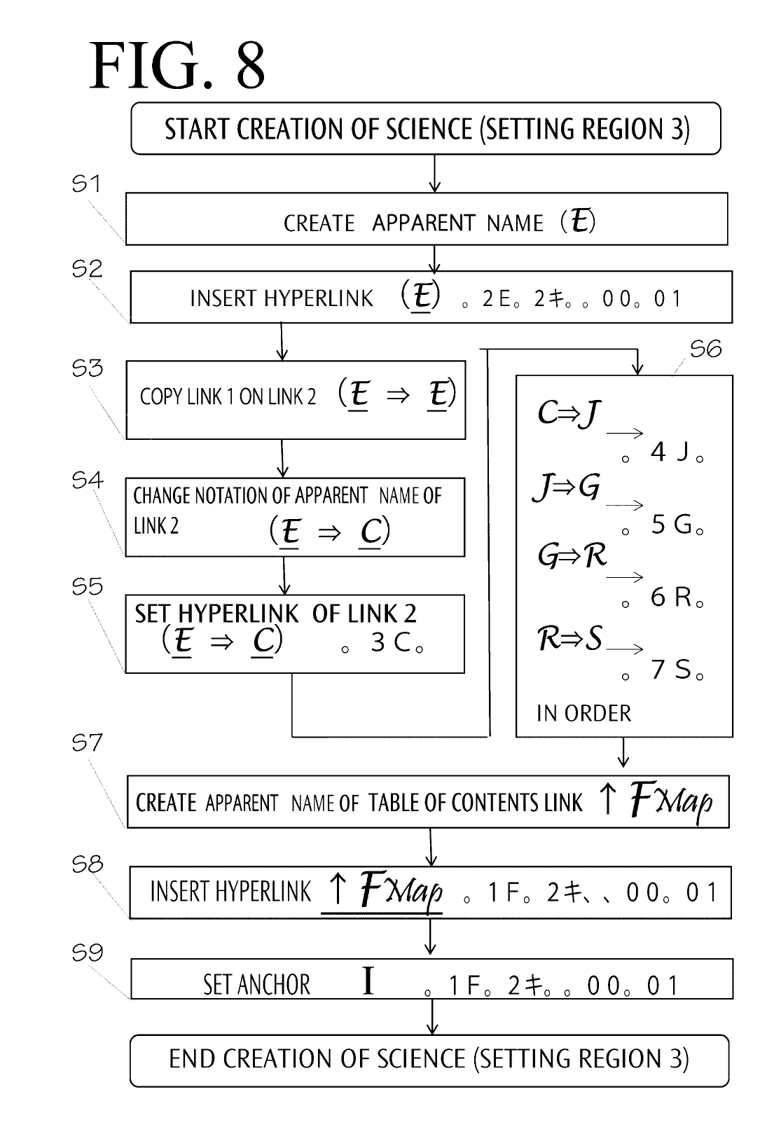

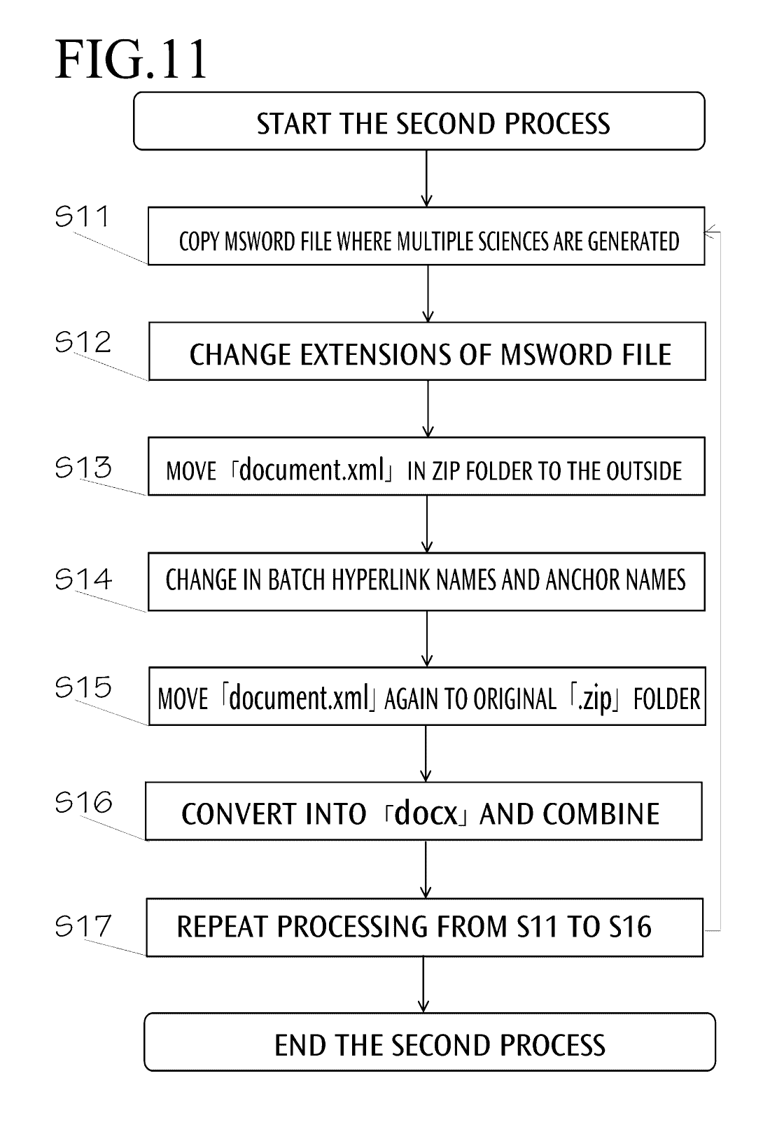

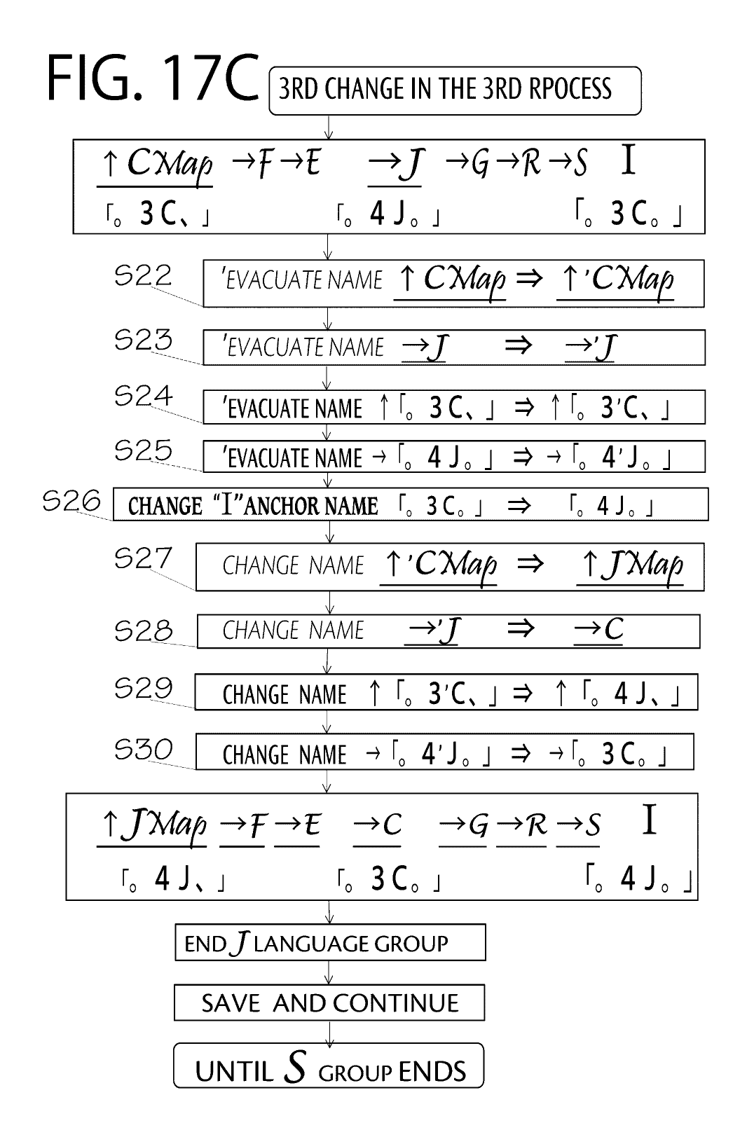

Subsequently, processing in which the generation apparatus 50 generates the electronic file 1 will be described in detail. The generation processing is composed of three processes when broadly classified. This means that the generation apparatus 50 performs three processes including: processing for generating one set of science as the First Process (FIG. 7, FIG. 8); processing for repeatedly proliferating the one set of science up to necessary number of sets of sciences for one language as the Second Process (FIG. 11, FIGS. 12A through 12C); and processing for changing the apparent names and underlying names respectively set up for the sciences as the Third Process (FIG. 16, FIGS. 17A through 17C), by partly replacing the names in accordance with the respective languages based on the order rule. As a result, these files are combined in accordance with the respective languages and the electronic file 1 is generated.

(7.01 Definition of Order Rule)

The order rule is a rule pertaining to an arraying order of hyperlinks. With respect to the apparent names, as can be seen from →F, →E in FIG. 2, a user can be aware that the hyperlinks are arrayed in a similar manner to one another in any language versions, and therefore it is easy for a user to repeatedly jump from any hyperlinks to respective anchors (array in each line in FIG. 6E). It is not allowed that hyperlinks are arrayed in a reversed order such as, for example, →E→F, in view of the order rule. According to the order rule, the first letter of the higher segment 84 of the underlying names of links shown in FIGS. 6A to 6D must be arrayed in the order of character code. The first letter of the highest segment 84 of the underlying name of each link serves as a sort key as shown in FIG. 6D.

(7.02 Example of Order Rule)

In the case of lines of hyperlinks shown in FIG. 6E, for example, in order for the hyperlinks of each of seven verbatims (the setting region 4 in FIG. 1) to be arrayed in the order from the setting region 6 to the setting region 11 in FIG. 1 according to the order rule, the first numeric digit of each setting region 84 in FIGS. 6A to 6D should serve as the sort key so that the hyperlinks are arrayed in the order from the setting region 6 to the setting region 11 as shown in FIG. 1. Furthermore, regarding underline names shown in FIG. 9G, for example, the underlying names of the setting regions 6 to 11 are required to be arrayed in the order of <2E>, <3C>, <5G>, <6R>, <7S>. In addition, it is important that the apparent name and underlying name of the same link are implicitly related to each other. Hereinafter, each processing process will be described in detail in relation with MS Word as an example. However, it is to be noted that the present invention is applicable to any product as long as similar functions are provided.

(7.02 Completion of the Currently being Prepared Names 72A)

The First Process is creation of a science arranged in a material as explained in the flowcharts in FIGS. 7 and 8. Hereinafter, the language in which the current material is written will be referred to as “the attention language”. It is assumed that, in the example illustrated with reference to FIGS. 7 and 8, the attention language is French. Firstly, the hyperlinks 1 to 6 (for the respective languages excluding the attention language) are arranged in a verbatim (the setting region 4 in FIG. 1). Subsequently, a TOC link (the setting region B in FIG. 1) is created. Finally, an anchor is arranged (the setting region A in FIG. 1). This means that, the First Process include the processing until the science (the first line shown in FIG. 6E) is completed. A plurality of different sciences from the second line to the final line in FIG. 6E will be created in the Third Process as will be described later.

(7.10 the First Process, Up to Completion of Single Science)

FIG. 7 and FIG. 8 are flowcharts illustrating one example of generation processing up to completion of one science executed by the generation apparatus 50 shown in FIG. 4. Then, FIGS. 9A through 9E are diagrams illustrating a progress in each process of the generation processing in FIG. 7. FIG. 9E is an example of the apparent names of the links 1 to 6. FIG. 9F and FIG. 34A are diagrams illustrating a state in which a TOC link has been placed at the head, and the First Process has been completed. Further, FIG. 9G and FIG. 34B illustrate the underlying names written in field codes behind the apparent names in FIG. 9F and FIG. 34A. In FIG. 9G, the names from the second line to the seventh line are <°2‡°°01°01>, and identical with one another except for the highest segment 84. The name of the anchor in FIG. 9F is <°1F°2‡°°01°01> in FIG. 34C, though not described in the field codes in FIG. 9G.

(7.11 Identical Lower Segments of Names)

As described above, the underlying names of hyperlinks illustrated in FIG. 34B and the underlying name of an anchor illustrated in FIG. 34C that collectively constitute a single verbatim (the setting region 4 in FIG. 1), include <°2‡°°01°01> at respective second lowest and lower segments and identical with one another except for the highest segment 84, since each hyperlink refers to the same materials in respective languages. Furthermore, <TABLE> in the TOC link (at the respective first lines in FIG. 9G and FIG. 34B) suggests the TOC link arranged in the setting region B in FIG. 1. Since <TABLE> is sorted before the full width characters <01> arranged in the same segment in the second line or later in FIG. 9G, the use of <TABLE> satisfies the order rule as well. Hereinafter, description will be made with reference to FIG. 7, but a flowchart illustrating the First Process is also shown in FIG. 8 by using the same step numbers. Therefore, users are expected to understand the process by replacing FIG. 7 with FIG. 8, as needed.

(7.20 One Symbol)

In step S1 in FIG. 7, the name generation unit 74 in FIG. 5 creates one symbol in the electronic file 1. For example, “→E” illustrated in FIG. 9A is created at a position of the link 1 in the setting region 6 in FIG. 1.

(7.21 Creating a Hyperlink Out of the Symbol)

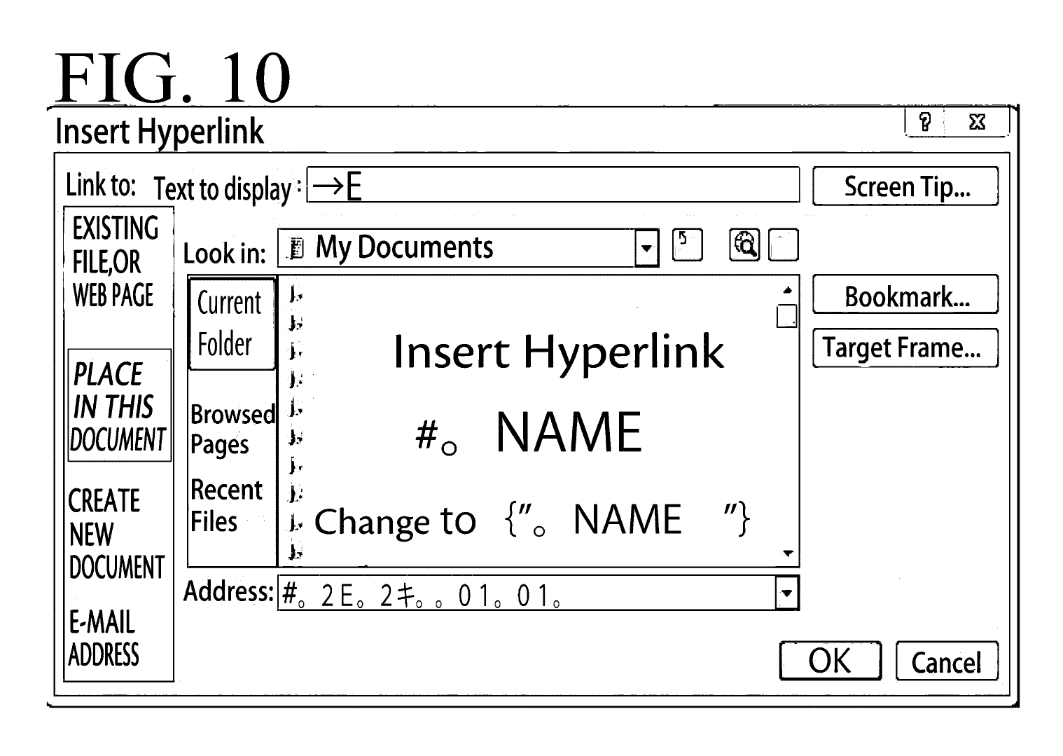

In step S2 of FIG. 7, the name generation unit 74 is adapted to create a hyperlink out of the symbol created in step S1. The name generation unit 74 is adapted to insert <#> at the head on an input screen (FIG. 10) of an edition dialog of the hyperlink upon setting up the hyperlink for the symbol, and thereafter input <°2E°2‡°°00°01> as shown in the second line of FIG. 9G. The <#> is inputted at the head because of the fact that an anchor which the hyperlink allows a user to jump to is not yet provided in the current file. However, although there may be a hyperlink having no anchor which the hyperlink can allow a user to jump to at this First Process, the name of the anchor which the hyperlink can allow a user to jump to will be created in a different file at the final Third Process. At the time when these files are combined after the end of the Third Process, all of the hyperlinks are enabled to allow a user to jump to respective anchors. This means that when the above-described name is inputted after <#> is inputted at the head as described above, the symbol “→E” is enabled to function as a hyperlink “→E”, as illustrated in FIG. 9A. If the field codes of this part are opened, it can be found that the name enclosed in double quotations is created as a hyperlink as illustrated in FIG. 9G.

(7.30 Duplication)

In step S3 in FIG. 7, the name proliferation unit 75 is adapted to duplicate the hyperlink. For example, the name proliferation unit 75 is adapted to add a copy of “→E” underlined as illustrated in FIG. 9B at a position of the link 2 of the setting region 7 in FIG. 1. However, at this stage, “→E” is merely a copy of the link 1 and not yet completed as the link 2.

(7.31 Creating Apparent Name of Link 2)

In step S4 in FIG. 7, the name changing unit 76 is adapted to change the apparent name of the hyperlink duplicated in step S3. For example, as illustrated in FIG. 9C, “E” which has been duplicated in step S3 is selected and turned gray. Then, “C” is inputted from the keyboard 60, thereby creating the apparent name “C” of the link 2 of the same font style as the link 1 as illustrated in FIG. 9D.

(7.32 Creating Underlying Name of Link 2)

In step S5 in FIG. 7, the name changing unit 76 is adapted to change the underlying name of the hyperlink, the apparent name of which has been created in step S4. For example, in step S5 in FIG. 8, the name changing unit 76 is adapted to select the part <°2E°> which is the underlying name of the hyperlink, and changes <°2E°> to <°3C°> (step S5 in FIG. 8). Alternatively, <#> is placed at the head from Insert Hyperlink dialog in FIG. 10, and subsequently all names are inserted as <°3C°2‡°°00°01>, for example.

(7.40 Creating Links of Verbatim)

In step S6 in FIG. 7, similarly, the name changing unit 76 is adapted to repeat steps S3, S4 and S5 in sequence with respect to each of the links 3 to 6 of the setting regions 8 to 11 in FIG. 1. Thus, as illustrated in FIG. 9E, the name changing unit 76 is adapted to create in a verbatim, i.e., the setting region 4, the links 1 to 6 of the setting regions 6 to 11 composed of the hyperlinks “→E”, “→C”, “→J”, “→G”, “→R”, “→S”.

(7.50 Creating Apparent Name of TOC Link)

In step S7 in FIG. 7, the name generation unit 74 is adapted to create an apparent name of a TOC link (the setting region B in FIG. 1) at the head of a line in which a plurality of links 1 to 6 created in step S6 are arrayed. The apparent name of the TOC link is “↑FMap”, as illustrated in FIG. 9E, for example.

(7.51 Highest Segment of Underlying Name of TOC Link)

In step S8 in FIG. 7, the name generation unit 74 creates an underlying name for the TOC link (the setting region B in FIG. 1) created in step S6. In the currently being created science, the TOC link at the head of the science and the anchor at the end of the science both relate to the same language (the attention language). Therefore, if the attention language is French, both the underlying names of the TOC link and the anchor have <1F> in common at the highest segment 84.

The relationship between the TOC link (the first line in FIG. 9G) and name of the anchor A for the subsequent verbatim parts (the second line onwards in FIG. 9G) is such that, since both the hyperlink in the TOC link and the anchor (the region A in FIG. 1) in the verbatim are for the attention language, as long as the anchor (the region A in FIG. 1) follows the name rule, the TOC link will be also affected by the name rule, and the both will use names that suggest the same language. For example, since the attention language in FIG. 9G is French suggested by <°1F> which is a segment of the name of the anchor, the segment of the name of the TOC link is affected by the attention language, and becomes the same <°1F> (FIG. 34C).

(7.51.01 Second Highest Segment of Underlying Name of TOC Link)

The entire links and the anchor in the currently being created science relate to the same convention, and therefore have <2‡> in common at the second highest segment 88, if the convention is Regulations under the PCT.

The relationship between underlying names attached to the anchor (the region A in FIG. 1) and the TOC link (the B in FIG. 1) in the same science is such that the TOC link will be created by assigning smaller character code to the TOC link, in order to allow a user to operate the TOC link to jump to the anchor on table of contents page which appears earlier. For example, if a segment of underlying name is created as <TABLE> in the TOC link, a character code of <TABLE> should start with a number earlier than full-width character <00>. For this reason, for all TOCs, TOCs are created by assigning characters or the like having numeric values in ascending order on columns of <TABLE> onwards. For example, even if TOC is varied as <TABLE°99°> or the like, The <TABLE°°99°> can be arrayed always orderly by assigning <TABLE°99°> onwards a number smaller than the full-width character <00°00> in ascending order.

(7.51.02 Second Lowest Segment of TOC Link's Underlying Name)

The underlying name of the TOC link is actually the underlying name of the anchor located in the table of contents, which the TOC link refers to. Therefore, the anchor located at the end of the current science, which is located subsequent to the tables of contents, should be placed in a position subsequent to the TOC link in the name order according to the name rule. For this reason, at the second lowest segment 86, the TOC link has an ASCII string such as <TABLE>, which is placed prior to a full width string such as <0 1> of the anchor in the name order.

(7.51.03 Lowest Segment of Underlying Name of TOC Link)

The lowest segment 87 of the TOC link represents the jump destination of the TOC link located in the table of contents. More particularly, the lowest segment 87 is Article number (in the case of PCT) or Rule number (in the case of Regulations under the PCT), which should be numbered in the location order and therefore should satisfy the name rule.

For this purpose, the relationship between the name of a TOC link and name of an anchor within the same science is such that, since both of them are related to the same convention, the names are required to be created as identical to each other in regards to section part of the subject region 81, of the names in FIGS. 6A and 6C. Then, furthermore, the TOC link within the same science is required to be smaller in character code than the anchor.

(7.51.04 Punctuation of Underlying Name of TOC Link)

Incidentally, the science located in the table of contents should also include the TOC link which allows a user to jump back to the anchor of the table of contents. In the present embodiment, the tables of contents are two layered as already described above. According to the name rule, the TOC links, which allow a user to jump back to Long Table of Contents, further to Short Table of Contents, and further to Title, should respectively have <°°>, <°^{a}>, and <^{aa}> at a position of the punctuations 85 of the underlying names thereof so as to be sorted by name in reverse order of the respective destinations of jumping as described above. Thus, the punctuation 85 serves as the sort key for the tables of contents.

This is because the TOC link allows a user to jump and return to the anchor of the table of contents. For example, the TOC link may be arranged in some cases on the same line with the anchor within the same science constituting the corresponding page, specific respective articles/clauses that were made public. However, the anchor of the table of contents is present in the table of contents, and in that page, the anchor is not followed by the provision specific respective Articles/Clauses and/or the like.

(7.51.05 Language Order in TOC Link)

Finally, among the languages, there should be a language order, which is determined by the first numeral digit of the highest segment 84 such as <1F>, <2E>, <3C>, <4J>, <5G>, <6R>, and <7S>. For example, in the case of French version, the entire anchors in the tables of contents and the material have <1F> at the highest segment 84 in common. In this manner, the entire anchors can be arrayed distinctly for respective languages.

Thus, for the TOC links present within the same science, the article/clause region 82 itself in FIGS. 6A and 6C is assigned with a character code smaller than the full-width character <00> similar to <table> on the first line in FIG. 9G. Otherwise, <^{a}> is used for any part of two digits of the punctuation 85 in FIGS. 6A and 6C located immediately prior to the start of the article/clause region 82. In this way, the TOC link can be kept to appear always prior to the name of the anchor which uses <°>. In this manner, the TOC link “↑FMap” is completed.

(7.51.06 Character Codes of TOC Link)

A brief explanation concerning the character codes of <^{a}> and <°> will be given below.

In the present specification, “names are the same” also means that numeric values thereof are equal to each other even though the names are replaced with character codes. PC employs a technology designed to replace numbers with characters and then display the characters. This means that <°> is also displayed after replacing number (character code) with character. Although there are various ways of grasping character codes, hereinafter an attempt is made to describe the character codes in the simplest manner.

(7.51.07 Simultaneous Pressing of ALT Key and X Key)

Upon selecting <°> on MS Word and simultaneously pressing ALT key and X key, <°> turns into a number 00B0. Similarly, upon selecting <^{a}> on MS Word and simultaneously pressing ALT key and X key, <^{a}> turns into a number 00AA. In this manner, it is possible to confirm that both <^{a0}> and <°^{a}> are sorted prior to <°°>.

By the same token, upon viewing the punctuation 85 of the FIGS. 6A and 6C, <°°> turns into <00B000B0>. When <^{a}> is used for a part of <°°> as described above, it turns into <°^{a}> or <^{a}°>. If they are replaced with character codes, they turn to <00B000AA>, <00AA00B0>, respectively. Therefore, any of <°^{a}>, <^{a}°> has a character code smaller than <00B000B0> of <°°>. Thus, when <°^{a}>, <^{a}°> are arrayed after sorting via spreadsheet software, they will be arrayed prior to <°°>.

(7.52 Second Highest Segment 84 which Deals with Multiple Conventions)

In a case of dealing with multiple conventions, the name rule should also be satisfied. For example, in a case in which each language material contains not only Regulations under the PCT but also PCT (Patent Cooperation Treaty), the second highest segment 88 is configured to be <1P> (not shown) for PCT, and <2‡> (FIG. 9G) for Regulations under the PCT, thereby making it possible for them to serve as the sort key to separate them from each other.

Even in the case that the number of hierarchies increases, it becomes necessary to retain their systematic uniformity for respective materials. For example, in a case in which one file is required to be created into which a plurality files containing respective languages versions of the PCT and Regulations under the PCT, which are multilingual international treaties, are combined, firstly, names should be divided into respective languages by using the highest segment 84 in FIG. 6C. Subsequently, names should be divided into respective materials by using the second highest segment 88 of the name. For example, in the case in which names having <°1P> (not illustrated) are related to PCT, and names having <°2‡> at a position where <°1P> is placed in the other name are related to material for Regulations under the PCT. Then, at a position between the end of the Patent Cooperation Treaty <°1P> and the start of <°2‡°°01°01> which is Rule 1.1 of Regulations under the Patent Cooperation Treaty, a table of contents for Rule 1.1 and the like are created.

(7.60 Setting-Up of Anchor)

In step S9 in FIG. 7, the name generation unit 74 sets up an anchor at a predetermined position of right side of a line in which the links 1 to 6 are arrayed, as illustrated in FIG. 9F, for example, and the processing is completed (END in FIG. 7). Although the anchor does not have an apparent name and cannot be seen in FIG. 9F, the underlying name of the anchor should be created at this stage to be the same name as the links 1 to 6 except for the highest segment 84, as already described above.

Numeric values other than those of the highest segments of the names should be equal to one another from the second line onwards as shown in FIG. 9G. Likewise, the corresponding segments of the anchor should be equal to each other. This is because the anchor is a part of components which allows a user to jump into verbatim.

(7.61 Names in Verbatim)

Therefore, <°1F°2‡°°01°01> is the underlying name of the anchor added to the verbatim in FIG. 9G. This means that, all names that belong to the same science (the setting region 3 in FIG. 1) are different from one another in the highest segment 84 such as <1F> and <2E> or the like, but are equal to one another in other segments (<°2‡°°01°01> in the example of FIG. 9G). The fact that the underlying names of the links and the anchor are equal to one another at the lower segments of the respective names leads to the fact that the lower segments can be automatically involved in the proliferation in the Third Process, which is the core idea of the present invention, and will be described below. The anchor is shown in FIG. 34C. Also, for comparison, FIG. 9F is shown again in FIG. 34A, and the hyperlinks in FIG. 9G are shown again in FIG. 34B.

(7.62 Position of Anchor)

Although the anchor is arranged at the end of the verbatim in the setting region 3 in FIG. 1, the position of the anchor is not limited to this. The anchor may be arranged at the head of the science. However, for the sake of avoiding confusion, it is not desirable to arrange the anchor in the middle of the science. Since an anchor is destination of jump function and a hyperlink is command button allowing a user to jump, it is necessary to separate them so as not to overlap one another.

### 8. Description of Second Process of Proliferation Processing

(8.00 Up to Completion of Entire Sciences in One Language)

Subsequently, the Second Process, i.e., the processing executed up to completion of the entire sciences in one language will be described. FIG. 11 and FIGS. 12A to 12C are flowcharts illustrating one example of the processing for proliferating one science generated in FIG. 7 and FIG. 8. The procedure for the proliferation will be described below. In FIGS. 12A to 12C, the same step numbers are given as those in FIG. 11. Assuming that m and n are respectively natural numbers not greater than 10, a file of names respectively having the lowest segment 87 being nn to mm is referred to as (nn:mm), and (nn:nn) is abbreviated as (nn). FIG. 12A illustrates the processing up to combination of two files (01) and (02), FIG. 12B illustrates the processing up to combination of two files (01:02) and (03:04), and FIG. 12C illustrates the processing up to combination of two files (01:04) and (05:08). Therefore, steps in FIG. 11 in the following can be replaced with steps in FIGS. 12A, 12B and 12C.

(8.10 Proliferation)

In step S11 in FIG. 11, the name proliferation unit 75 in FIG. 5 proliferates the science created in step S9 in FIG. 7. The science before proliferation is temporarily saved for the purpose of combining, separately from sciences after proliferation.

(8.11 Changing DOCX to ZIP)

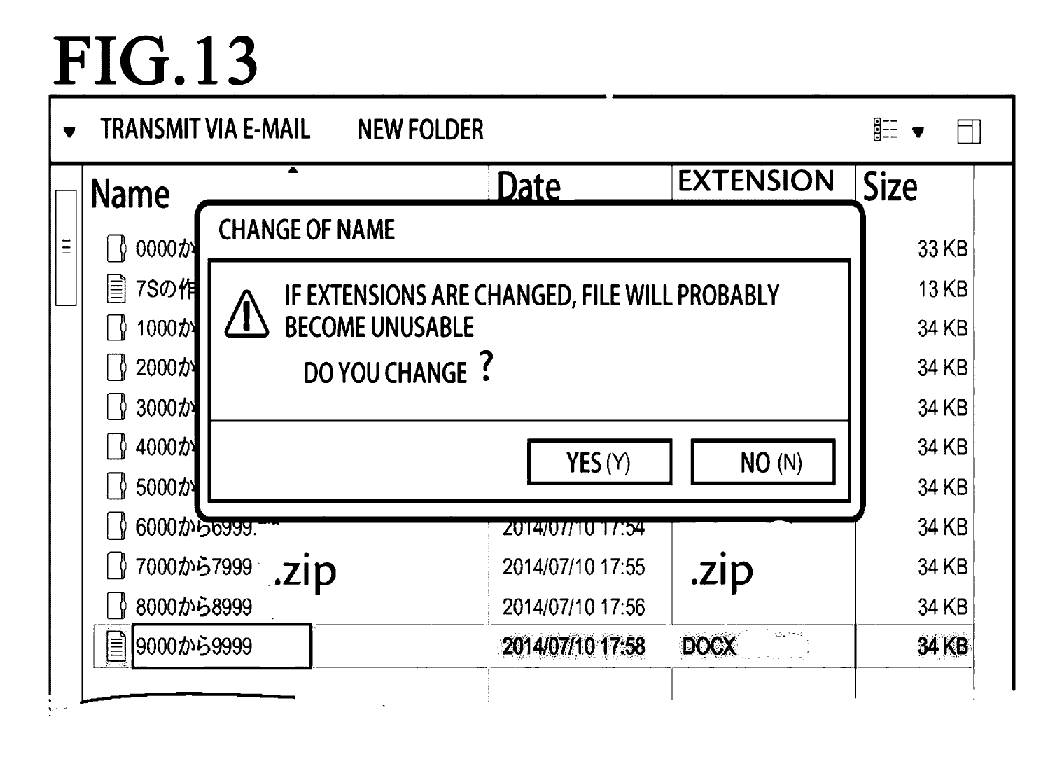

In step S12 in FIG. 11, the name changing unit 76 changes the extension of the file containing the names proliferated in the processing in step S11 from DOCX to ZIP, for example. Specific example of changing to the ZIP file will be described below with reference to FIG. 13.

(8.12 Extracting Document.xml from ZIP Archive)

In step S13 in FIG. 11, the name changing unit 76 extracts document.xml contained in the ZIP file of step S12. More particularly, the name proliferation unit 75 copies document.xml inside the ZIP file to an external folder. Step S13 will be described below with reference to FIG. 14 more particularly.

(8.13 Batch Changing of Names)

In step S14 in FIG. 11, the name changing unit 76 performs batch changing of the name segments of the hyperlinks and the anchors contained in document.xml. For example, the name changing unit 76 changes <°°01°01> in the names to <°°01°02>. Before “Replace All” is executed in the processing, as described above, the punctuations <°°> and <°> should be included in the selected target range to avoid replacement errors.

(8.14 FIG. 15 as Photograph Substituted for Drawing)

As will be described later, the processes of steps S11 to S16 are repeatedly executed many times, starting with replacement of the lowest segment 87, then the second lowest segment 86, and so forth. It should be noted that the following description of FIG. 15 relates to replacement of the second lowest segment 86 of the underlying names, which is executed after a several times of repetition. FIG. 15 is a photograph substituted for drawing representing a screen example after the processing in step S14 in FIG. 11 has been executed. The photograph is a screen shot of an image displayed when the names of hyperlinks and bookmarks are batch-changed while the document.xml file is opened. The photograph substituted for drawing in FIG. 15 is a screen shot captured after entire <°°0> found in the duplicated names related to Rules 1 to 9 of Regulations under the PCT are replaced with <°°1>, thereby acquiring names related to Rules 11 to 19. The total number of changes is 315, shown at the bottom of FIG. 15. In FIG. 15, portions underlined in red are changed portions of the names.

(8.14.01 Observation of FIG. 15)

In FIG. 15, six consecutive lines of hyperlink elements and one line of bookmark element are repeatedly shown. Every seven lines correspond to one verbatim. Among the seven lines, the six lines are the underlying names of the six hyperlinks 1 to 6, and the one line is the name of the anchor. The message in Japanese at the bottom of FIG. 15 indicates “Complete: 315 out of 315 items have been replaced in the current document”. More specifically, from the screen shot shown in FIG. 15, two patterns can be recognized. The first pattern is represented by the first line from the top including </w:t></w:r><w:hyperlink w:anchor=“°2E°2‡°°11°01”w:history=“1”. Another pattern is represented by the seventh line from the top, including w:id=“0” w:name=“1F°2‡°°11°01”/><w:bookmarkEnd w:id=“0”/. The second pattern is related to the anchor since “bookmark” is included therein. The first pattern is related to the hyperlink. Furthermore, since the numeric values of “w:id” on left and right sides of the seventh line are equal to “0”, it can be determined that a change has taken place at this location. On every seventh line, the similar patterns are repeated. The 7th anchor placed on 49th line from the top shown in FIG. 15 includes w:id=“6” w:name=“1F°2‡°°13°01”/><w:bookmarkEnd w:id=“6”/>. This means that 7 anchors partly replaced and having been changed are shown in FIG. 15. The result report message automatically created by the software, indicating “Completed: 315 items from among 315 items have been replaced within the present documents” is displayed at the bottom of the screen shot shown in FIG. 15.

(8.14.02 how to Read FIG. 15)

In view of the facts that the same change patterns appear at every seventh lines, and the total number of changes is 315, it can be found that 315/7=45 anchors have been replaced. The total number of lines in the column C in FIGS. 35A and 35B is 45 as shown in the last line of FIG. 35B, and thus it can be found that there is no error in replacement conversions. The number of seven agrees with the number of names appearing in the verbatim which is constituted by a combination of six hyperlinks and one anchor A in the setting region 4 in FIG. 1. However, the XML file actually includes eight names for each science, among which the name of the TOC link is excluded in the result above. A question arises as to why this difference has occurred.

(8.14.03 how to Read FIG. 15)

The reason is because the TOC links have the names such as <°1F°2‡°°TABLE°01>, which do not have any substring such as <°°0>, and consequently are not replaced with any character. TOC links, which are excluded from the replacement processing will be described below.

(8.15 Changing Document.xml to ZIP)

In step S15 in FIG. 11, the name changing unit 76 returns the document.xml, of which the change processing has been completed in step S14, to the inside of the original ZIP file.

(8.16 Changing ZIP to DOCX)

In step S16 in FIG. 11, the name combining unit 78 changes the extension of the ZIP file, which has been changed in step S15, to DOCX, thereby acquiring the MS Word file containing the changed underlying names. Subsequently, the contents of the acquired DOCX file are appended to the original DOCX file saved in step S11. Thus, at the end of the first time loop, an electronic file including two sciences is completed, in which the first science has the name <°°01°01> and the second science has the name <°°01°02>.

(8.20 Repetition)

In step S17 in FIG. 11, the name proliferation unit 75, the name changing unit 76, and the name combining unit 78 repeat the processing from step S11 to step S16, and ends the processing when the necessary number of sets of sciences are produced (END). Since the Second Process is combination of the two files before and after the name changing, respectively performed by the name proliferation unit 75, and the name changing unit 76, the contents of the resultant file are doubled each time repetition has been completed.

(8.21 Doubling by Repetition)

More particularly, assuming that a file of names respectively having the lowest segment 87 being nn to mm is referred to as (nn:mm), and (nn:nn) is abbreviated as (nn), as described above, in the first loop, the file (01) is duplicated, changed into a file (02), and the file (02) is added to the file (01). In the second loop, the resultant file (01:02) is duplicated, changed into a file (03:04), and the file (03:04) is added to the file (01:02). In the third loop, the resultant file (01:04) is duplicated, changed into a file (05:08), and the file (05:08) is added to a file (01:04), thereby acquiring the file (01:08). If the number of Clauses is eight, the proliferation related to Clauses is completed, and the proliferation of the second digit of the Rule number may begin, after which the first digit of the Rule number will be proliferated in the same manner. If Clause 9 is necessary, an extra loop is added after the third loop in which the original file (01) is duplicated, changed into a file (09), and the file (09) is added to the file (01:08) acquired in FIG. 12C.

More specifically, at the first time, a file has underlying names of <°°01°01> for existing portion and <°°01°02> for increased portion. Newly increased portion at the second time has underlying names <°°01°03> and <°°01°04> obtained by performing twice consecutive processing on the above underlying names by the name changing unit. After that, <°°01°03> and <°°01°04>┘ are combined with <°°01°01> and <°°01°02> before the change, and one file having four-line sciences from <°°01°01> to <°°01°04> is created. Furthermore, similarly, the third time processing is performed by the name changing unit to create one file having eight-line sciences from <°°01°01> to <°°01°08>. In this manner, when parts that correspond to Clauses are completed, similar processing is performed on parts that correspond to 1-digit Rules, and then parts of 2-digit Rules will be similarly performed. If Clause 9 is needed, a new name is created in such a manner that a file having <1°01> is changed to a file having <1°09> in step S14 in FIG. 12A, and added to the combined file having <°°01°01> to <°°01°08> in FIG. 12C.

(8.22 Features of Processing from the Lowest Segment)

The names completed in the level of Clause as described above are further proliferated in the level of Rule. For this purpose, the processes of steps S11 to S16 are similarly but slightly differently repeated as follows. In this case, a file (05) is prepared in advance by duplicating and changing the file (01). After the file (01) is quadrupled to a file (01:04), the file (01:04) is added to the file (05), and the resultant file (01:05) is doubled to acquire a file (01:10). Subsequently, the file (01:10) is doubled to be (01:20). Here, “Replace All” is performed twice: Firstly “10” to “20”, and secondly “0n” to “1n”, n being 1 to 9. The result of the latter is shown in FIG. 15. Similarly, (01:20) is twice doubled to be (01:80). To complete (01:99), a file (01:19) is duplicated, and changed to (81:99), and added to (01:80).

In general, unlike clauses, since texts include a larger number of Articles, typically include both Article 9 and Article 10, it is preferable to start with the creation from Article 0 to create 1-digit Articles, and then, to change and add names created elsewhere to a previously created appropriate 1-digit Article to create the Article 9. In the present embodiment, the processing is gradually transitioned from a lower level of a name to an intermediate or higher level of the name, and portions of the name processed at the lower level is slightly changed and recycled at the intermediate or higher level. The higher the level of names is concerned, the more number of times of processing is required. In view of this, in the case where Article/Clause material, which tends to have a large number of items, is required to be represented by numeric values in this manner, it is preferable to provide the name proliferation unit that can quickly produce the names in accordance with a scheme of utilizing a portion of a name.

(8.23 Features of Proliferation by Utilizing the Lower Level)

The processing described above starts with the proliferation at the lowest digit of the lowest segment 87 of a name. Once the proliferation directed to the lower level is completed, by the subsequent proliferation directed to the higher level, the result of the lower level is utilized and multiplied. Hereinafter, such a multiplication effect is referred to as “involvement of the lower level”. In FIG. 15, since the XML text has been obtained by selecting <°°0> and replacing <°0> with <°°1>, changed portions are indicated by <°°1> underlined in red.

It is to be understood that these changed portions are related to two-digit rule portions at the head columns of the segment 85 and the article/clause region 82 in FIG. 6C. This means that FIG. 15 is a screen shot of the scene where Rules 11 to 19 have been automatically generated utilizing one-digit Rule or less used for provisions of Regulations under the PCT from Rule 1 to Rule 9 as they are.

(8.30 Aligned Display of Underlying Names in Field Codes)

In regards to underlying names in the field codes, the example illustrated in FIG. 9G represents a page having a width of 320 points, a height of 480 points, and a narrow margin of 17 points on its left-right sides created by a word processor. When the page is viewed on a narrow screen of a smartphone, the string length of each line is suited to be aligned as illustrated in FIG. 9G and FIG. 34B.

(8.31 Aligned Display of Underlying Names by Indentation)

However, the method of alignment is not limited to the above. The line width can be adjusted by indentation as well. For example, a hanging indent may be set at one character. Under this condition alone, names in the field codes are not always aligned in a vertical array. This is because, for example, if the number of characters is made small, the names can be aligned in a vertical array in a similar manner by increasing numeric values of the hanging indent. In that case, the second line through the seventh line should be adjusted so as to be aligned in a vertical array. The first line and the second line are affected by the increased numeric values of the hanging indent, and thus blanks are formed at the left side.

(8.32 Names Vertically Aligned in Field Codes)

Owing to the fact that the underlying names can be displayed in alignment, it is easily possible to visually confirm the result of replacement. For example, if names are replaced by the names aligned in a vertical array in the field codes, the names will be replaced orderly as shown in FIG. 15 or FIG. 18, and it is possible to read replacing processing on software.

(8.40 Creation in Large Volume)

According to the processing described above, it is possible to consecutively double the number of the sciences. Incidentally, it has been described that the field codes are displayed such that one name is arranged in one line. However, the field codes including one name may be displayed in two or three lines. If sciences are created by a similar creation method described in the above processing, up to 8 sciences, for example, can be created, and 2 sciences can be added to the 8 sciences. This means that 10 or more sciences can be created. Furthermore, in this manner, sciences can be created efficiently in large volume. Hyperlinks in the sciences may not be necessarily aligned on the same single line, and may be aligned on two or more lines. FIGS. 12A to 12C illustrate processing examples similar to the processing illustrated in FIG. 11. The processing steps in FIG. 12A to FIG. 12C the same as the processing steps described in FIG. 11 are referred to by the same step numbers.

(Precautions in Step 2 (8.50 Warning of DOCX))

FIG. 13 is an example of a screen shot displayed when the extension of the electronic file 55A is changed from “DOCX” to “ZIP”. Although a warning message is displayed as shown in FIG. 13 when changing the extension, the extension should be changed by ignoring the warning message.

(8.60 Operation on Document.xml in ZIP Archive)

FIG. 14 is a diagram illustrating document.xml contained in the electronic file 55A after the extension has been changed to “ZIP”. As illustrated in FIG. 14, document.xml is always provided in the changed folder of the ZIP archive, the document.xml should be extracted to an appropriate folder outside of the ZIP archive. Otherwise, document.xml cannot be edited. The extension of document.xml is “XML”, which is preferably opened by a web page editor, for example. In order to prevent the processing of replacement from affecting irrelevant texts, the replacement target should be selected including the punctuations such as <°>. Subsequently, the result document.xml is saved and brought back into the ZIP archive. Finally, the extension “ZIP” is turned back to “DOCX”. In this manner, the result of proliferation is acquired. Not only anchors but also hyperlinks are proliferated in the Second Process.

(8.70 Errorless Replacement)

When the replacement is performed in the proliferation processing, it is desirable to select the replacement target including punctuations such as <°> or <°°>, and perform “Replace All”. This is to avoid irrelevant texts from being erroneously replaced.

(8.71 Example of Replacement Including the Punctuation 85)

For example, if <°°> (the punctuation 85 in FIG. 6A) is selected and replaced with <°00°°>, yet another new segment (the second highest segment 88 in FIG. 6C) can be created between the highest segment 84 and the second lowest segment 86. If by any chance there is provided an irrelevant text that is not intended to be changed but having a segment common with the segment intended to be changed such as, for example, <°°>, the irrelevant text should have been temporarily changed in advance so as to be not mistakenly changed (this temporary change is referred to as “evacuation” in the present specification), and restored after the replacement. This evaluation processing is applicable to not only hyperlinks and anchors having the same second lowest segment, but also any materials, prior to the replacement processing of the names, thereby making it possible for a user to create new names while preventing the irrelevant texts from being erroneously replaced. In this manner, if, for example, a part <°2‡°°> of <°4J°2‡°°01°01> is replaced with, for example, |°9‡°°0>, the result will be <°4J°9‡°°001°01>, which is an underlying name suitable for 3-digit Articles of EPC Rules, for example.

(8.71.1 Advantages and Disadvantages of Growth Point Scheme)

The method of replacement processing described above can be performed on XML files. The advantage of replacing the texts in XML is that both hyperlinks and anchors can be partially and simultaneously replaced in a simple and safe manner. For this purpose, growth point <°°> or the like, is used. While, on the other hand, the replacement processing may cause CPU to be heavily loaded and accordingly, a lot of time to be required owing to the fact that the amount of text information in XML is enormous.

(8.71.2 Choice Between the Growth Point Scheme and the Evacuation Scheme)

Therefore, in the case in which the replacement processing on XML is too heavy for the CPU, it is preferable to divide the Second Process into three stages in order to prevent CPU from being too much loaded and save time. In FIGS. 17A to 17C, a process performed in step S26 corresponds to the second stage, in which only the names of the anchors in document.xml are changed. Processes performed on the field codes before and after S26 respectively correspond to the first and the third stages.

(8.71.3 Embodiment of Three Stages)

The processing of the first stage is performed on the DOCX file. In the state in which the field codes are opened, the underlying names of hyperlinks are evacuated. For example, <°1F°> in each name is replaced with <°1′F°>, which is not included in the field codes and does not affect the underlying names of anchors. Subsequently, in the second stage, document.xml is opened, and <°1F°> is replaced with <°2E°> as shown in step S26 of FIG. 17A, which exclusively affects the underlying names of the anchors. Finally, in the third stage, DOCX is opened again, the field codes are opened, and <°1′F°> is replaced with <°2E°>, thereby restoring the underlying names of hyperlinks. This seems circuitous in comparison with the simultaneous changing of both hyperlinks and anchors on XML, but the processing time may be reduced.

(8.71.4 Choice Between Two Methods)

Depending upon the size of the XML file and operational preference, either of the above described one-stage method (growth point scheme) and three-stage method (evacuation scheme) may be selected.

(8.72 Changes of Names that Will not Influence on Materials)

In any case, the replacement target should be carefully selected so that the replacement should not affect any irrelevant texts in the XML file and the DOCX file. At least the characters such as <°> and <^{a}>, which seldom appear in ordinary texts, should be included in the selection in order to avoid conversion errors.

In the case described above, although the anchors and hyperlinks have names different from each other, after the replacement processing, the hyperlinks and the corresponding anchors have been partially and uniformly replaced with the same name of XML format. As a result thereof, the jump function is enabled after the final combining as will be described hereinafter, even if the hyperlinks and anchors are combined in one single file. Furthermore, after files before being changed and files after being changed are combined into one file, since the names of the files have been changed, the jump function is enabled. In this manner, if a character string containing <°°>, which is seldom used in Japan, is selected, even new hierarchies are created and added, conversion error in materials can be prevented.

(8.80 Definition and Significance of the Currently being Created Names 72B)

The currently being created names 72B in FIG. 5 are saved as a set of the sciences (the setting region 3) or a set of the verbatims (the setting region 4) generated during the proliferation processing upon receiving an instruction from the name control unit 71. However, similarly to the names 72A, the names 72B are composed of functionless hyperlinks in a broad sense that do not have jump destinations, although there is description of hyperlinks on the underlying names. Depending on the cases, a TOC link (the setting region B in FIG. 1) may or may not be created. Further, when the TOC link is created, the TOC link may fail to be replaced. Therefore, it should be confirmed how many names have been replaced in the proliferation processing. In the case of FIG. 15, at the bottom of the resultant screen, the number of required replacements and the number of already-performed replacements are written as “Complete. Out of 315 items, 315 items were replaced within the current document”.

(8.81 Creation Timing of a TOC Link)

In the case in which the TOC links have not been created in the Second Process, the TOC links should be preferably created before the start of the Third Process, after the Second Process is completed. Incidentally, the TOC links that have been failed to be replaced in FIG. 15 can be processed as follows. Assuming that the TOC links having <TABLE°01> to <TABLE°09> have been already duplicated, <TABLE°0> is selected to be replaced with <TABLE°1>, thereby acquiring the TOC links having <TABLE°11> to <TABLE°19>. In this manner, TOC links can be created for the corresponding texts from Article 10 to Article 19 while the lower segments thereof remain as they are.

Subsequently, jump function is enabled to jump to names of a hierarchy of the detailed table of contents. It is to be noted that the detailed table of contents also forms a science and has a TOC link, and the TOC link allows the names to be arranged so that jump function is enabled to Short Table of Contents of even higher level.

(8.90 Advantage of Removing the Variety of Font Styles)

Another processing desired to be processed before the start of the Third Process is hyperlink processing on Articles to be applied mutatis mutandis. The processing on the Articles to be applied mutatis mutandis is carried out such that an Article/Clause (e.g., Article 111) composed of one-byte characters in a material is converted into two-byte characters notation (e.g., change to Article 111 ( [symbol] ) in Japanese), then the two-byte characters notation is pasted to a file with the extensions of txt. At this stage, the font styles or the like are made equal to those of the material while the variety of font styles or the like appearing in Western sentences are removed. As a result thereof, if the conversion into xml is again performed, segmentation of characters/numeric values or the like by tags in xml syntax can be decreased, thereby enhancing the efficiency of conversion process.

### 9. Description of the Third Process for Generation Processing

(9:00 Up to Completion of Sciences for all Languages)

Subsequently, general remarks of the Third Process up to completion of sciences for all languages will be described. The Second Process so far is directed to proliferation of a science of only one language, whereas the Third Process is a final step of changing the sciences of one language in accordance with the requirements of the other languages and creating sciences of other languages.

(9.01 Drawings Illustrating the Processing)

Since the complete set of sciences for one language is already acquired in the Second Process, a complete set of sciences for a next language can be acquired by changing the highest segments 84 of three names in each science, i.e., names of the TOC link B, a next link among the links 6 to 11, and the anchor A in the setting region 3 in FIG. 1. Here, the next language is intended to mean the language aligned subsequent to the attention language in the language order, and the next link is intended to mean the link to the next language. In the new set of sciences for the next language, the next language becomes the next attention language. This means that the language referred to from the TOC link and the next links are exchanged for each other, as shown in FIG. 6E. Accordingly, one cycle of the Third Process can be conceived as a process of exchanging the current and next attention languages' names one after another in the entire sciences as shown in FIGS. 19A to 19D, in which the attention language is French, and therefore the next language is English, and so on. FIG. 16 and FIGS. 17A to 17C are flowcharts of the Third Process. The Third Process performs replacements of the highest segments (the segments 84 in FIGS. 6A through 6D) of underlying names. FIG. 16 and FIGS. 17A through 17C illustrate key points of replacements of the names in the hyperlinks and the anchors at the Third Process. Of the replacements performed during the processes shown in FIG. 16 and FIGS. 17A through 17C, the replacement of the setting region 6 in FIG. 1 are described with reference to FIGS. 19A through 19D. FIGS. 19A and 19B are diagrams illustrating actual examples of the processing of apparent names. FIGS. 19C and 19D are diagrams illustrating actual examples of the processing of underlying names. Furthermore, FIGS. 19A and 19C illustrate apparent and underlying names of the science in the process of the replacements, and FIGS. 19B and 19D illustrate apparent and underlying names of the science after the replacements.

(9.02 Repetition for all Languages)

The new set of sciences for the new attention language is saved, further duplicated, and changed to the set for the next language. The Third Process is repeated until the complete sets of sciences for the entire languages are acquired. Therefore, the cycle described in FIG. 16 and FIGS. 17A to 17C is repeated six times (for six languages except for French) as shown in FIG. 6E.

Replacements are performed on the following three portions: (1) the anchor A in the setting region 4; (2) one of hyperlinks in the setting regions 6 through 11; and (3) the TOC link B which belongs to a science in the setting region 3 in FIG. 1. When the replacements of three portions are completed, the newly created science is saved. Thereafter, the processing transitions to creation of a science for the next language. The processing of performing the replacement changes in sequence is illustrated in each line of FIG. 6E. As shown in FIG. 6E, there are seven lines, which will serve as sciences for seven languages, respectively.

(9.03 Relationship Between FIG. 16 and FIGS. 17A to 17C)

Meanwhile, description hereinafter is directed to processing of replacing the names of hyperlinks and anchors performed from steps S22 to S30 shown in FIG. 16. Furthermore, FIG. 17A is a flow chart illustrating the same processing explained with reference to FIG. 16. FIGS. 17B and 17C are flowcharts illustrating processing of creating sciences for languages other than French whereas the same step numbers are designated to identify the same processes illustrated in FIG. 16 and FIG. 17A. Therefore, if sciences are required to be created for languages other than French, descriptions of steps S22 to S30 in FIG. 16 can be referred to by replacing French with the concerned language in FIGS. 17B and 17C. It should be noted that three processes described later does not correspond to temporally preceding and succeeding relationship. This means that the following description will be given for each object of replacement not following the steps of the flowchart of FIG. 17A. The description following the flowchart of FIG. 17A will be given later.

(9.04 Replacing Names of Anchors)

Firstly, description with regard to the anchor A in FIG. 1 will be given. For example, after the anchors for French are created and proliferated in the First Process and the Second Process, in each cycle of the Third Process, the highest segment 84 of the underlying names of the anchors are underlying name replaced in sequence from initial <°1F°> to <°2E°>, <°3C°>, <°4J°>, <°5G°>, <°6R°>, and <°7S°> in this order for other respective languages, based on the name rule.

The above process is performed on the XML file. All pieces of XML data containing all hyperlinks in newly created files are searched, and all the names of the anchors having the concerned characters are replaced in sequence, and separate files having different names of the anchors are created in sequence.

(9.05. Replacing Names of Hyperlinks)

Next, the hyperlinks in the region 5 in FIG. 1 will be described. In The First Process and the Second Process, the first line of FIG. 6E is created, excluding French, which is the current attention language. In each cycle of the Third Process, each link (1 to 6) is changed in turn to refer to the previous attention language, and the language the link has been referring to is excluded and changed to the next attention language. Simply, the language of each link (1 to 6) and the previous attention language are exchanged (French to Russian) for each other in each cycle of the Third Process.

The Third Process includes the processing of searching all hyperlinks for a particular character in the files being created and replacing in sequence all the names having the corresponding characters each time the respective regions 6, 7, 8, 9, 10, 11 are replaced in this order, in compliant with the order rule on the basis of FIG. 6E, and creating different files each time one setting region is completed. Thus, replacements of the names of the hyperlinks in the Third Process will be performed on every region of the setting regions 6 through 11 in FIG. 1, for every language.

(9.05.1 Replacing Both Apparent and Underlying Names of Hyperlinks)

More particularly, upon creating the science of the second line of FIG. 6E from the science of the first line of FIG. 6E, the apparent name “→E” of the setting region 6 is replaced with “→F”. Furthermore, the underlying name <°2E°> shown in the second line of FIG. 34B is replaced with <°1F°>. “→′E” at the second column in FIG. 19A is a part of the apparent name being processed, and <°2′E°> at the second line in FIG. 19C is a part of the underlying name being processed. Both “→′E” and <°2′E°> are apparent and underlying names corresponding to each other.

(9.05.2 Similar Repetition Performed for the Other Languages)

The six dotted lines in FIG. 6E correspond to the six cycles of the Third Process, in which the attention language is changed in turn from French to English, Chinese, Japanese, German, Russian, and Spanish. For example, in the case in which the Third Process transitions from the first line to the second line in FIG. 6E, the setting region 6 is changed from “→E” to “→F”. Likewise, upon transitioning from the second line to the third line of FIG. 6E, the setting region 7 is changed from “→C” to “→E”. Upon transitioning from the third line to the fourth line of FIG. 6E, the setting region 8 is changed from “→J” to “→C”. Upon transitioning from the fourth line to the fifth line of FIG. 6E, the setting region 9 is changed from “→G” to “→J”. Upon transitioning from the fifth line to sixth line of FIG. 6E, the setting region 10 is changed from “→R” to “→G”. Upon transitioning from the sixth line to seventh line of FIG. 6E, the setting region 11 is changed from “→S” to “→R”. This means that, in the Third Process, each time of transition, the name of interest is caused to be excluded from the setting region 5 in FIG. 1, and the name prior to the excluded name is caused to be replenished into the setting region 5. In this manner different files are created. Herein, the setting regions 6 through 11 may be also referred to as the links 1 through 6.

(9.06 Replacing Names of TOC Links) Finally, the TOC link in the setting region B in FIG. 1 will be described hereinafter. The TOC link refers to the attention language and the other links refer to the rest of the seven languages. This means that languages referred to from the TOC link and the other links are in an exclusive relationship. Therefore, when the link “→E” is replaced with “→F” and excluded from the setting region 5 in the second line, the TOC link “↑FMap” is replaced with “↑EMap” in reverse. As well as the apparent name described above, the highest segment 84 of the underlying name of the TOC link <°1F°> is replaced with <°2E°>. In this manner, in each cycle of the Third Process, a new set of sciences for each language is completed and saved in each file. This means that, similar to the above hyperlinks, all hyperlinks in the same file are searched for particular characters, and hyperlinks that contain the same characters are replaced with hyperlinks having different characters. Then, if the TOC link of ↑F that suggests French is created in the First Process and the Second Process, then in the Third Process, different files are created, in which apparent names of the setting regions B are respectively replaced in sequence with ↑E, ↑C, ↑J, ↑G, ↑R, and ↑S according to the language order. When the apparent name “↑F” is placed at the first column of the first line of FIG. 6E, “↑F” is replaced with the apparent name “↑E” at the first column on the second line of FIG. 6E. Likewise, <°1F°> of the underlying name on the first line of FIG. 34 is replaced with <°2E°> of the underlying name on the first line of FIG. 19D.

(9.07 Replacement According to Language Order)

In the Third Process, the name rule should be strictly observed. This means that the languages should not be changed in an arbitrary order, but should be changed in accordance with the language order. Names of anchors should be replaced so that segments of the names of the anchors are replaced in the ascending order of character codes in accordance with the name rule, in such a manner that <°1F°> that suggests the language of interest is replaced with <°2E°>. Furthermore, as a result of the replacement, a hyperlink suggesting the name of the next attention language is excluded from the setting regions 6 through 11, another hyperlink having the name different from the next attention language is replenished within the setting regions 6 and 11, thereby forming the next six links. In this manner, a hyperlink is excluded from the setting region 5 and placed at the setting region B in ascending order of character codes. Each time a hyperlink is excluded from the setting region 5 and placed at the setting region B, another is replenished in the setting region 5, and hyperlinks are rearranged in ascending order of character codes within the setting region 5.

(9.08 Transition in Language Order)

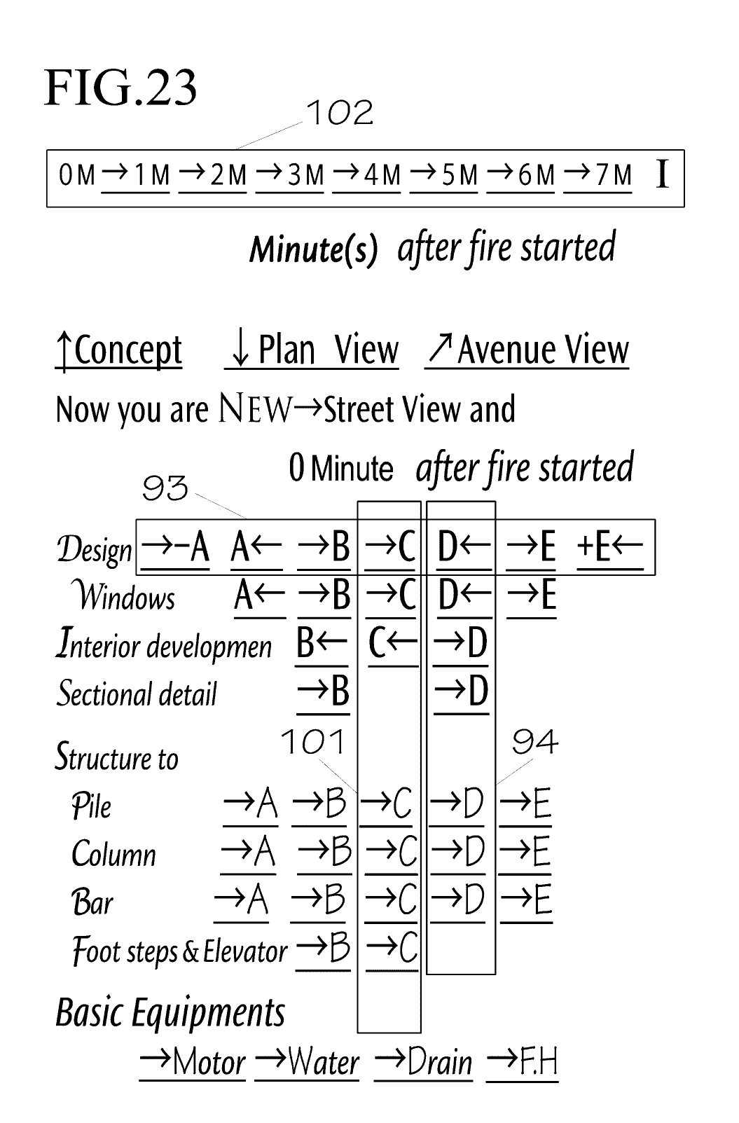

Therefore, as a result of the Third Process, the highest segment 84 of the underlying name of the TOC link changes in the order of <1F>, <2E>, <3C>, <4J>, <5G>, <6R>, and <7S>. Similarly, a transition of the apparent name of the TOC link is shown in FIG. 6E. For example, from among underlying names in the region 5 in FIG. 1, in which the hyperlinks are arrayed, the highest segment 84 of the underlying name of the TOC link is excluded from the setting region 5 in the order of <°2E°>, <°3C°>, <°4J°>, <°5G°>, <°6R°>, <°7S°> in sequence, as illustrated in the second line or later in FIG. 23, each time a different file is created, and another hyperlink is replenished so as to be arrayed in sequence according to the order rule as <°1F°>, <°2E°>, <°3C°>, <°4J°>, <°5G°>, <°6R°> in each of the files. Also, an apparent name is excluded from the setting region 5 in the order of E, C, J, G, R, S respectively specified by the languages of interest, as illustrated in the second line onwards of FIG. 6E. In turn, another hyperlinks F, E, C, J, G, and R are replenished in this order, as illustrated in the second line onwards of FIG. 6E. Description of replacement processing of the names of the TOC links has been described above, and therefore will be omitted.

(9:09 Up to Reaching the Already-Combined Names 72C)

In each cycle of the Third Process, the complete set of sciences for each language is saved in the file 72B in FIG. 5. Finally, the entire files 72B are combined and files 72B in which names have been replaced are saved by the final combining unit 79 as the already-combined name 72C (72B in FIG. 5) each time transition has been completed. Subsequently, transitions have been completed for all the languages of interest, the respective files will be saved as the already-combined names 72C by the final combining unit 79. As a result of this, the entire links have destination anchors thereof in the same file 72C and function as the hyperlinks in the narrow sense that can actually allow a user to jump from a hyperlink to the anchor. Therefore, when the files have been saved in the Third Process, any of the files serves as a cluster composed of sciences groups of the setting region 3, or verbatim groups of the setting region 4. Consequently, when the final combination has been completed, the hyperlinks have functions respectively allowing a user to jump to anchors. Now, particular remarks of the Third Process will be specifically described, following the steps of the flowchart in FIG. 16 in view of temporal preceding-succeeding relationship.

(9:10 Evacuation of Apparent Name of TOC Link)

In step S22 in FIG. 16, the name evacuation setting unit 77 performs batch changing to replace “↑FMap” in the apparent names of the TOC links with “↑′FMap” as shown in FIG. 19A. Through this processing, for example, as illustrated in FIG. 19A, the apparent name of hyperlink is changed to “↑′FMap”.

(9:11 Evacuation of Apparent Name of Next Link)

In step S23 in FIG. 16, the name evacuation setting unit 77 performs batch changing to replace “→E” in the apparent names of the next link with “→′E” as shown in FIG. 19A. Through this processing, for example, as illustrated in FIG. 19A, the apparent name of hyperlink is changed to “→′E”.

(9:12 Evacuation of Underlying Name of TOC Link)

In step S24 in FIG. 16, the field codes are opened, and in this state, the name evacuation setting unit 77 performs batch changing to replace <°1F°> in the underlying names of the TOC links with <°1′F°> as shown in FIG. 19C. Through this processing, for example, as illustrated in FIG. 19C, the name is changed to {HYPERLINK¥1“°1′F°2‡°°TABLE°01”}.

(9:13 Evacuation of Underlying Name of Next Link)

In step S25 in FIG. 16, in the state in which the field codes are open, the name evacuation setting unit 77 performs batch changing to replace <°2E°> in the underlying names of the next links with <°2′E°> as shown in FIG. 19C. Through this processing, for example, as illustrated in FIG. 19C, the name is changed to {HYPERLINK¥1“°2′E°2‡°°00°01”}.

(9:14 Changing Anchor Name)

In step S26 in FIG. 16, the DOCX file in step S25 is closed, and the name changing unit 76 is adapted to change the extension of DOCX file to ZIP, and extract document.xml in the ZIP archive to the outside. On this XML file, the names of the anchors are changed from <°1F°> to <°2E°> as shown in FIG. 18. Since the names of hyperlinks have been already evacuated, the changing of the names affects only the anchors.

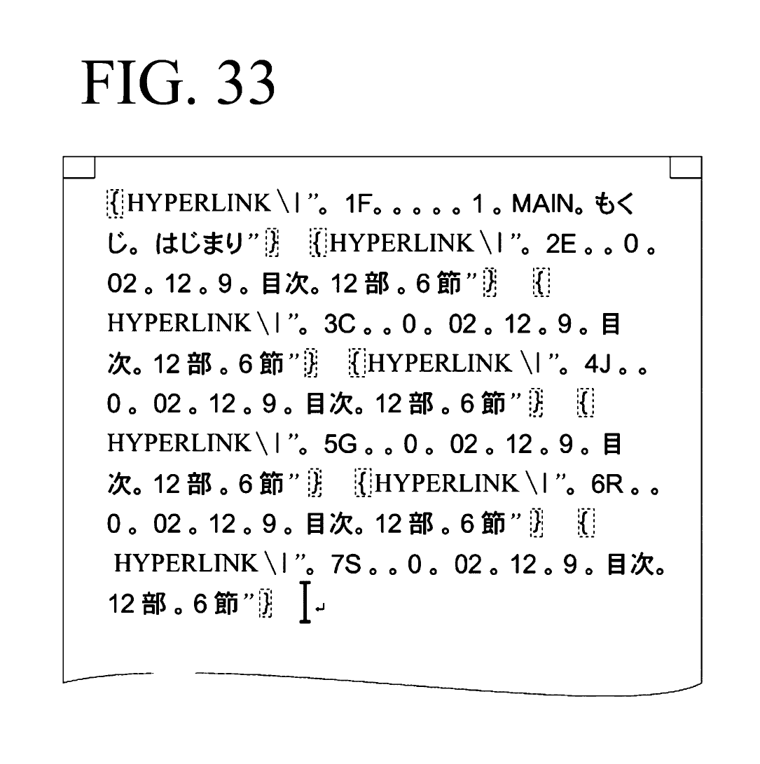

The example of photograph shown in FIG. 18 is a screen shot acquired when <°1F°> in the highest segments is changed into <°2E°>, and the <°2E°> thus changed are all underlined in red and displayed as <°2E°>. On the left side, as can be seen from the statements of w:bookmarkStart described in all lines, conversion processing has been performed only on bookmarks. This means that the names surrounded by definite articles of the anchors have been replaced. Since evacuation has been performed by affixing apostrophe to the names of the hyperlinks in advance, as described above, hyperlinks is not changed. For this reason, the evacuated names are not described in FIG. 18. At this time, the accuracy of operation in the XML text, which is more chaotic than the text in FIG. 33, can be improved if the range of change is selected by surrounding <4J> with <°> as shown in FIG. 6A or FIG. 6C.

(9.14.01 Changing the Highest Segments in FIG. 18)

In FIG. 18, the names <°2E°2‡°^{a}table> of the anchors in Short Table of Contents, the names <°2E°2‡°°TABLE> of the anchors in Long Table of Contents, and the names of the anchors in the material are arrayed in this order, which satisfies the name rule. After the anchors are changed, document.xml is brought back to the ZIP archive, and the extension is renamed to DOCX. The method of changing the extension from DOCX to ZIP, and the method of changing the extension from ZIP to DOCX can be performed just in a reversed manner to the methods explained with reference to FIGS. 13 and 14.

More specifically, the tables of contents are composed of two hierarchies since Regulations under the PCT has a large volume. As will be seen from FIG. 18, the names <°2E°2‡°^{a}table> of the anchors in Short Table of Contents is changed to <°2E°2‡°°TABLE> from the line indicated by w:id=“16”. It is to be understood that <°2E°2‡°°TABLE> is created by replacing <°^{a}> of <°2E°2‡°^{a}table> with <°°>. Therefore, <°2E°2‡°^{a}table> has <°^{a}> in the place of <°°> of <°2E°2‡°°TABLE>.

(9.15 Changing Apparent Name of TOC Link)

In step 27 in FIG. 16, the name evacuation setting unit 77 performs batch changing to replace “′F” with “E”. As a result thereof, “↑′FMap” in the apparent names of the TOC links is replaced with “↑EMap” as shown in FIG. 19B.

(9.16 Changing Apparent Name of Next Link)

In step S28 in FIG. 16, the name evacuation setting unit 77 performs batch changing to replace “→′E” in the apparent names of the next links with “→F” as shown in FIG. 19B. In this manner, the hyperlink apparent name is changed to “→F”, for example, as illustrated in FIG. 19B.

(9.17 Changing Underlying Name of TOC Link)

In step S29 in FIG. 16, the field codes are opened, and in this state, the name changing unit 76 performs batch changing to replace <°1′F°> in the underlying names of the TOC links with <°2E°> as shown in FIG. 19D. In this manner, the underlying name of the TOC link is changed to {HYPERLINK¥1“°2E°2‡°°TABLE°01”}, for example, as illustrated in FIG. 19D.

(9.18 Changing Underlying Name of Next Link)

In step S30 in FIG. 16, in the state in which the field codes are still open, the name changing unit 76 performs batch changing to replace <°2′E°> in the underlying names of the next links with <°1F°> as shown in FIG. 19D.

Meanwhile, the name changing unit 76 is adapted to replace the apparent names of the links with the apparent names of the preceding link one after another in such a manner as “→E” to “→F” for link 1 in the second line from the first line of FIG. 6E; “→C” to “→E”) for link 2 in the third line from the second line of FIG. 6E; (“→J” to “→C”) for link 3 in the fourth line from the third line of FIG. 6E; (“→G” to “→J”) for link 4 in the fifth line from the fourth line of FIG. 6E; (“→R” to “→G”), for link 5 in the sixth line from the fifth line of FIG. 6E; (“→S” to “→R”) for link 6 in the seventh line from the sixth line of FIG. 6E.

(9.18.01 Link to the Previous Attention Language)

As a result of step S30 of FIG. 16, in place of the next link, a link to the previous attention language is inserted. At this stage, the next link is no longer “the next link” but is to be called “the previous link”.

This means that the name changing unit 76 is adapted to replace the underlying names of the links at the start of respective steps S25 and at the end of respective steps S30 in FIGS. 17A, 17B, 17C one after another in such a reversed manner that <°2E°> is returned to <°1F°> for the link 1 in the second line from the first line of FIG. 6E; <°3C°> to <°2E°> for the link 2 in the third line from the second line of FIG. 6E; <°4J°> to <°3C°> for the link 3 in the fourth line from the third line of FIG. 6E. Hereinafter, though the underlying names are not shown, the names are replaced in such a reversed manner that <°5G°> to <°4J°> for the link 4 in the fifth line from the fourth line of FIG. 6E; <°6R°> to <°5G°> for the link 5 in the sixth line from the fifth line of FIG. 6E; <°7S°> to <°6R°> for the link 6 in the seventh line from the sixth line of FIG. 6E.

(9.18.02 Transition of Next Links)

Thus, the next link is replaced with the previous link in turn. This means that, in each cycle of the Third Process, the links in the setting region 5 is changed in turn in a manner such that the order of language order is decremented by one (such as <2E> to <1F>, <3C> to <2E>, and so forth).

This phenomenon occurs because, whenever a separate file is created, an anchor is replaced one after another, i.e., the anchors at right end on respective lines of FIG. 6E are replaced in ascending order of numeric values like (<1F>, <2E>, <3C>, <4D>, <5E>, <6R>, and <7S>. This means that each time a separate file is created, a link which does not allow a user to jump to the other file is generated if the link which allows a user to jump to the anchor of the same language remains. Accordingly, the link which relates to the same language with as the anchor is excluded and a link which refers to the previous language is enabled and added instead.

(9.20 Repetition for all Languages)

In the above, processes performed from steps S22 to S30 are described as the processes of changing from French to English, which constitute only one cycle of the Third Process. The Third Process is completed only after the cycle is repeated six times, as already describe above. Here, the name rule and the order rule should be strictly observed. Although it has been described that the replacement target is the highest segment 84 alone, the replacement target may include an arbitrary number of segments. For example, if the present invention is applied to patent-related treaties or conventions in multiple-languages, not only the highest segment 84 but also the second highest segment 88 may be included in the replacement target in the Third Process.

More specifically, when the above processing is performed, the TOC link is changed from “↑FMap” to “↑EMap”, and the processing ends (END). The name changing processing is actually performed such that the above step S22 through step S30 are performed (N−1) times, wherein the (N−1) is the number of links to be arrayed in the setting region 5. This means that respective positions of links of the TOC links and verbatims of in N−1 sciences are changed so that N kinds of the setting regions 3 in FIG. 1 are generated during the Third Process. N−1 is a formula to determine the number of times required to create N kinds of the setting regions 3. However, it is necessary to perform sequential changes in the order in which the anteroposterior relationship of links, i.e., “F”, “E”, “C”, “J”, “G”, “R”, and “S” in the setting regions 6 through 11 are maintained except for the setting region B in FIG. 1 (see each line shown in FIG. 6E). The processes described in FIG. 16, FIG. 17A through FIG. 17C, and FIGS. 19A through 19D are examples of name changing for segments including alphabet parts of the highest segment 84 of the currently being created names 72B illustrated in FIGS. 6A and 6C. On the other hand, these processes can be applied to the name changing processing on not only the highest segment 84 in FIGS. 6A and 6C, but also the intermediate segment (s), e.g., the second highest segment 88 in FIG. 6C depending on configurations of the materials (for example, materials multiple-languages such as patent-related treaties).

(9.21 Order of Final Combination)

At the last step, final combination is performed. The final combination is a process of completing the generation processing. In the First Process, hyperlinks are arrayed according to the order rule, and sciences are arrayed according to the name rule. In the Second Process, the sciences are proliferated in the ascending order of character codes. In the Third Process, the proliferated sciences are further proliferated in the language order in accordance with the name rule. For this reason, at the time of the final combination, it is required to combine the files 72B to the file 72C, shown in FIG. 5, in the language order, thereby arraying the entire sciences in accordance with the order rule and the name rule.

More specifically, during the final combination, combination of files is initiated so that the files having anchors are arrayed in the order of character codes of the respective anchors thereof, in accordance with the name rule. For example, in the case of the multinational treaties or conventions in seven languages, the currently being prepared names are defined, assuming that <1F> denotes French, <2 E> denotes English, <3C> denotes Chinese, <4 J> denotes Japanese, <5 G> denotes German, <6 R> denotes Russian, and <7 S> denotes Spanish. The final combination is performed so that the files are combined in such a manner that the file having the anchor with the smallest character code of 1 is arrayed first. Then, the ascending order of character codes of the anchors simultaneously coincides with the location order.

(9.22 Combination that Follows the Name Rule and the Order Rule)

In the whole process described above, any of the name generation unit, the name proliferation unit, the name changing unit, the name combining unit, and the final combining unit strictly follows the name rule and the order rule while creating underlying names of the anchors and hyperlinks and combining the files. Therefore, it is well considered that the generation method according to the present invention is quite simple, and the operation of names thereof is easy to learn and understand.

(9.30 Number of Times N of Changes)

FIGS. 17A to 17C are flowcharts respectively illustrating the replacement of the first to third lines shown in FIG. 6E. FIG. 17A illustrates the above processing of replacement up to the region 6 in FIG. 1, FIG. 17B illustrates the above processing of replacement up the region 7 in FIG. 1, and FIG. 17C illustrates the above processing of replacement up to the region 8 in FIG. 1. Since the set of sciences for French is already completed in the Second Process, the Third Process is repeated for the rest of the languages, i.e., six times, thereby acquiring seven files 72B. The final file 72C is completed by combining all of the seven files 72B.

More specifically, if the process for one attention language, for example, <F> is already completed at the time of the completion of the Second Process, the conversion will be initiated from the next to the attention language <F>. In this manner, assuming that N is the number of languages, the Third Process is completed if the processing of replacements is performed N−1 times as previously described. This means that it can be regarded that the Second Process is performed N times in total. When these files are combined for entire N languages, the creation of the targeted single file is completed.

(9.40 Effect 1 of the Generation Apparatus 50; Large-Volume Creation)

As described from the beginning, the generation apparatus 50 is provided with the name generation unit 74 in FIG. 5 that generates the setting region 3 (science) including the TOC link or the setting region 4 (verbatim). The generation apparatus 50 is provided with the name changing unit 76 that changes the setting region 3 or the setting region 4 generated by the name generation unit 74 based on the prescribed name rule. The generation apparatus 50 has a function of creating electronic files having the setting region 3 or the setting region 4 changed by the name changing unit 76. Furthermore, the generation apparatus 50 is configured to store the electronic files merged into one completed file by the final combining unit 79 in the electronic file 55A. In this manner, a user who intends to create the setting region 3 or the setting region 4 can create a large volume of electronic files by utilizing data-link structure of the setting region 3 or the setting region 4 contained in the electronic file 1, 55A, or 72A, without repeating the creation of hyperlinks and anchors from the beginning.

(9.50 Second Effect of the Generation Apparatus 50; Easy to Operate)

In view of the other perspective, the generation apparatus 50 is equipped with the instruction information receiving unit 73 that receives any one of setting region generation instruction, proliferation instruction, name changing instruction, and save instruction from a user. This configuration makes it possible for a user to construct the setting region 3 or the setting region 4 in the electronic file 1, 55A, or 72A, while directly reflecting an intention, an idea, a design or the like of the user at user's disposal, and thus even a user who does not have programming skill or the like can create the setting regions. Especially it is possible for a user to deal with a large volume of confidential documents without disclosing them to the outside experts.

(9.60 Significance of Storing Both Files 72B and 72C Separately)

The storage unit 72 in FIG. 5 may store separately the currently being created names 72B and the already-combined names 72C separately because they have both advantages and disadvantages. The advantages and disadvantages herein used are derived from the fact that the currently being created names 72B are ready to be further changed, and in contrast, the already-combined names 7C are already complete and hard to be changed. Therefore it is useful to store the resultant file 72B of each process that can be combined again in a different manner.

The name storage unit plays an important role, since it directly saves the files having new sciences composed of new anchors and new hyperlinks created by round robin proliferation, as the sets required for final combination.

(9.61 Disadvantage of the Already-Combined Names)

For example, a method for extracting document.xml from MS Word DOCX file and partly replacing the document.xml is disadvantageous in that any part of document.xml may be changed uniformly within the file only if the segments are matched with the key words regardless of whether the segments are intended to be changed or not. For this reason, evacuation measures are taken such as putting, for example, an apostrophe into parts which are not intended to be changed but would be otherwise replaced. However, in a case in which the final combining unit 79 has already combined the files, the names of the anchors and the hyperlinks in the file are diversified, and thus, it requires a lot of laborious efforts and time to evacuate the parts which are not intended to be changed.

(9.62 Advantage of the Already-Combined Names)

However, the already-combined names 72C are composed of science of the setting region 3 and verbatim of the setting region 4, in which jump functions have been already demonstrated. For example, when the number of Clauses such as 8 Clauses or 9 Clauses of Article of required portions is not provided in the currently being created names 72B, it is possible to utilize a part of the setting region 4.

### 10. Description of Other Embodiments

Description hereinafter is directed to another configuration examples other than an example of electronic files described so far described.

(10.00 Third Effect of the Electronic File Generation Apparatus 50: Reusability)

When the already-combined names 72C (e.g., in the state of science of the setting region 3, verbatim of the setting region 4 in FIG. 1), which have structures of hyperlinks, are copied on another electronic file different from the electronic file 1, 55A, or 72A, the setting regions 4 or the setting regions 4 of the electronic file 1, 55A, or 72A are also formed as they are in another electronic file. This enables the region 3 or the region 4 to be used as they are in other electronic files, in the case of electronic files, for example, where anchor information of the already-combined names 72C, setting (Add a Hyperlink) information of hyperlinks have similar configuration to those of the electronic file 1, 55A, or 72A. As a result of this, it is not necessary anymore to generate the region 3 or the region 4 from the beginning, and the reusability of data can be further enhanced. For example, in the case where a majority of treaties or conventions are composed only of Articles/Clauses without additional revisions such as the PCT, instead of Paris Conventions having Article 4 bis, reusability is enhanced for other files.

(10.10 Reusability of Partial Restructuring)

Furthermore, from the other points of view, the name changing unit 76 of the generation apparatus 50 is adapted to change names of anchors and names of respective hyperlinks indicative of jump destinations contained in the setting regions 3 or 4 proliferated by the name proliferation unit 75, with respect to the electronic file 1, 55A, or 72A, in accordance with the name rule depending on a material. This means that data structure of the setting regions 3 or 4 contained in electronic files can be restructured. For example, upon changing constituent seven languages and adding Arabic, official language of UN, or the like, the name changing unit 76 can change the links and anchors of the attention language in the sciences in accordance with the name rule.

(10.20 Jump Between Different Electronic Files)

Hereinabove, an exemplary embodiment of the present invention has been described, but the present invention is not limited to the above-described exemplary embodiment, but various changes can be made. Description hereinafter is directed to another embodiment according to the present invention. For example, in the above-described exemplary embodiment, an example of hyperlinks in the same electronic file (what is called “internal link”) has been described, but jump destinations of the hyperlinks may not be limited only in the same electric file. The jump destinations of the hyperlinks may include other electronic files as well. Furthermore, the number of links (i.e., N−1 sets) in verbatim of the setting region 5 illustrated in FIG. 1 is less than N sets which is the number of units of categories in the electronic file 72A. For example, in a case in which a material has been translated in seven languages, 6 links of the links 1 through 6 (the setting region 5 in FIG. 1) excluding the link of interest may be created.

(10.20.01 Verbatim Region where the Link of Interest is not Excluded)

Preferably, a screen on which hyperlinks (jump sources) are displayed and screens on which the jump destination of the hyperlink, i.e., anchor is displayed should be designed at positions substantially equal to each other with respect to the visual line of a user in order to enhance usability. This configuration makes it possible for a user to easily and immediately touch a hyperlink allowing the user to jump back to the screen of the jump source. In this case, for example, a TOC link in which the material of language of interest always appears at the head may not be excluded from the links but included in the links arrayed in the setting region 5. In this case, all the links may be fixedly arrayed in the Order in which the anteroposterior relationship of links, for example, “F”, “E”, “C”, “J”, “G”, “R”, and “S” in the setting regions 6 through 11 are always maintained.

(10.201 One Example of Replacement of Architectural Drawings)

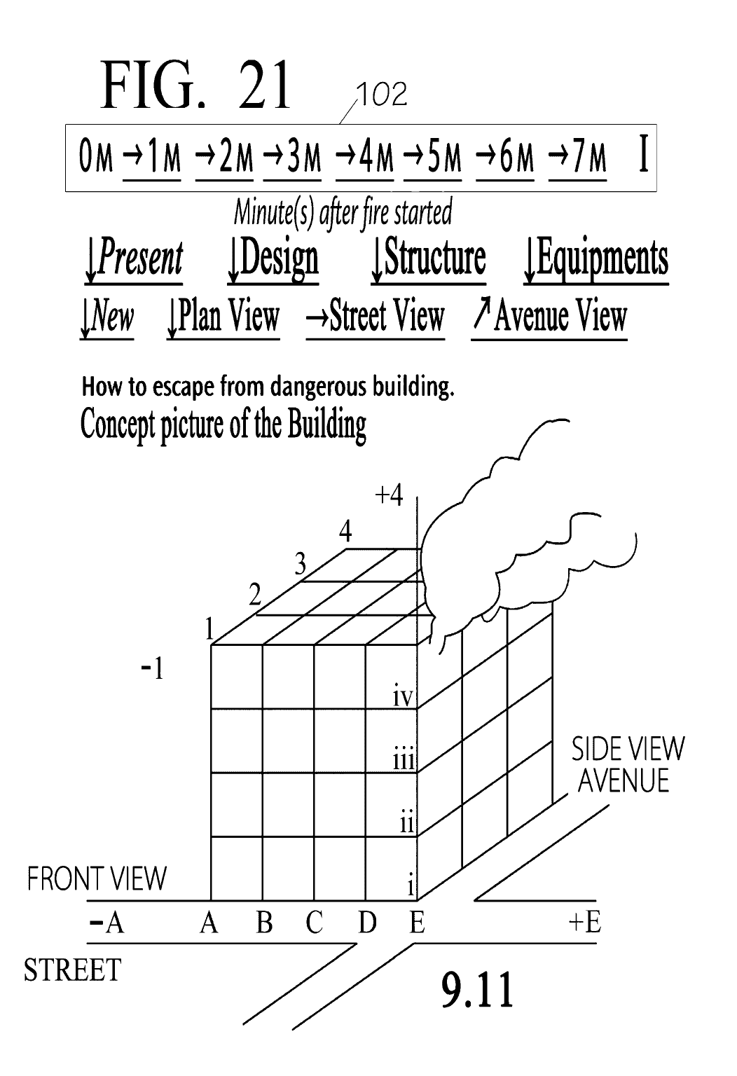

Unlike FIG. 1, FIG. 21 through FIG. 28 are diagrams illustrating an example of another electronic files for organizing architectural drawings. The completion drawings of the building (FIG. 21) is stitched in the configuration order of textile design, structure, and facility of completed building, based on the results of discussions conducted by a building constructor with a client and/or the results of discussions conducted by the building constructor with subcontractors for specific fields, and prepared a as contract completion report of construction contract documents.

(10.202 Necessity of Drawing Replacements)

However, when a resident would like to perform a remodeling work after the completion, the resident considers from his or her unique perspectives how the electricity, gas, water supply, drainage, wiring for Internet and the like should be laid out on a floor, how the floor should constructed, how the walls should be laid out. For this purpose, priority is placed in the order of a plan view, a front view, a side view of his or her own residence place. Furthermore, priority is placed on layer drawings such as, for example, drawings for respective constructions, thereby making it easier for a resident or a constructor to, for example, drive a nail.

(10.203 Replacement Method)

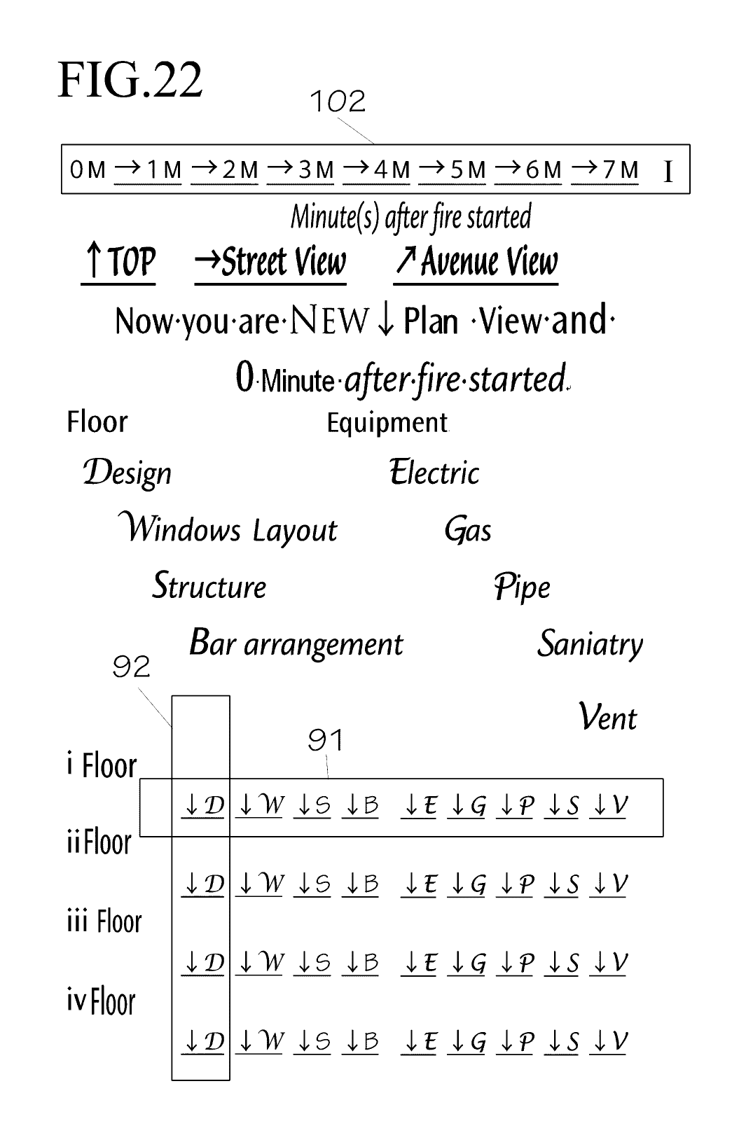

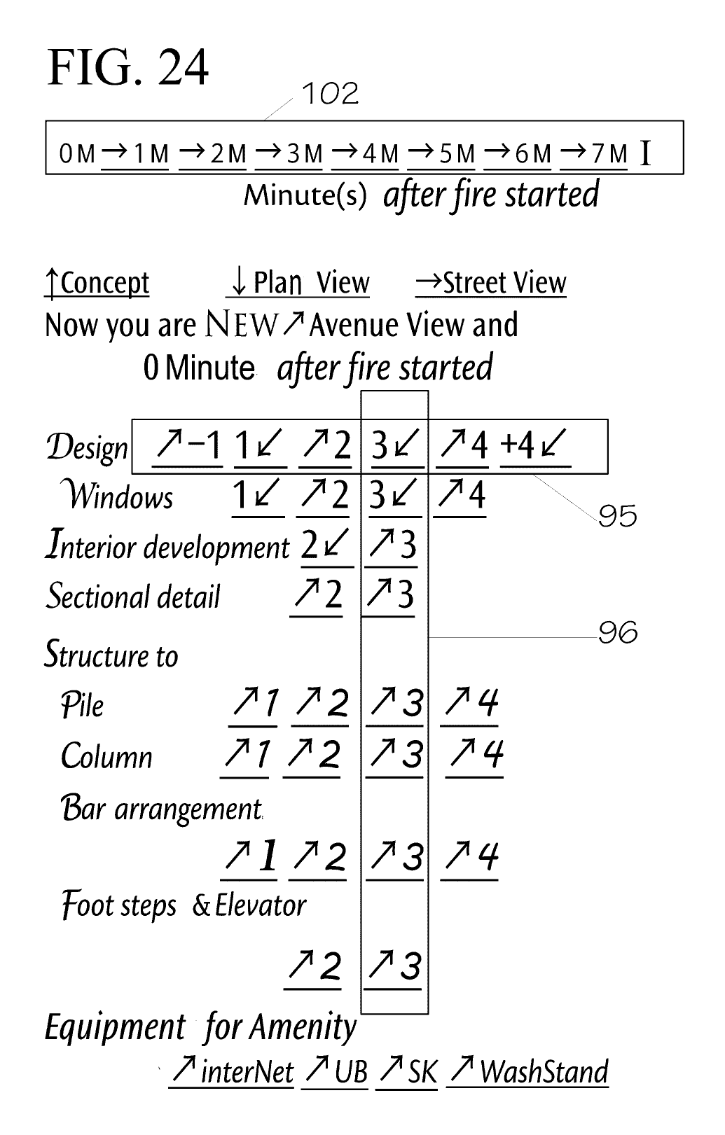

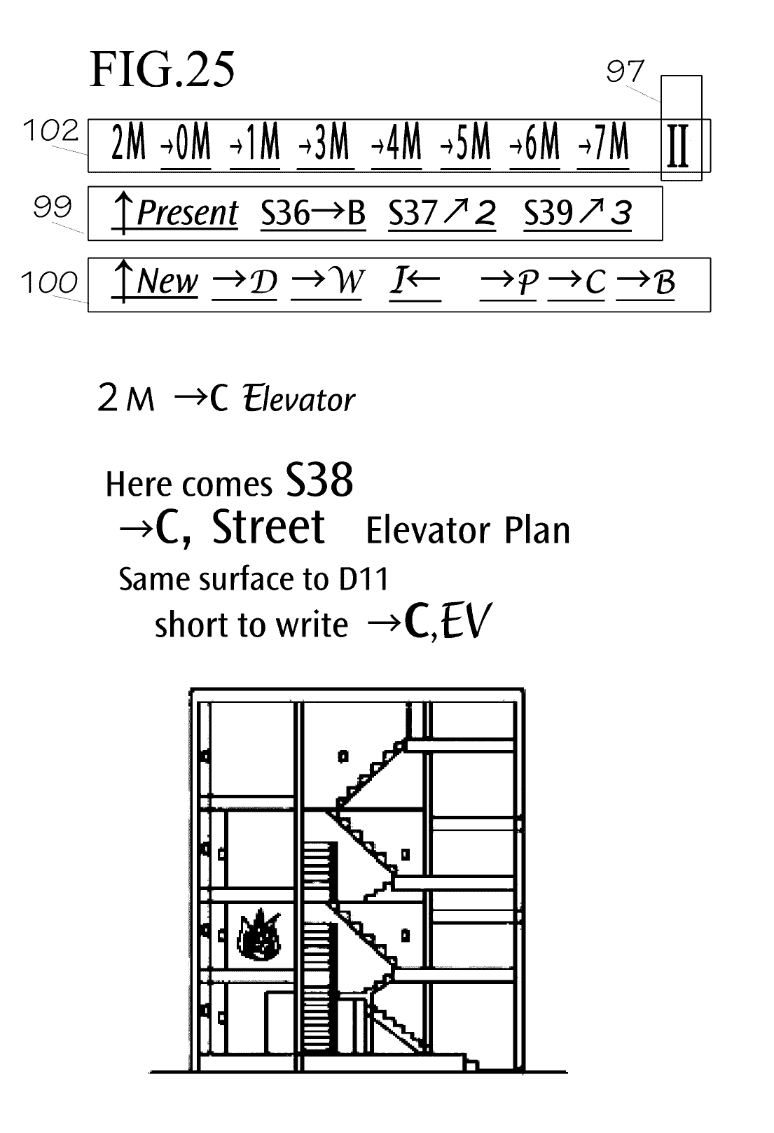

In order to create drawings, firstly, photographs of the building were taken with a digital camera for apparent conceptual drawings (FIG. 21). Secondly, photographs were also taken with the digital camera for completion drawings. Subsequently, the drawings including a plan view, a front view, and a side view were rearranged in classifications according to different projection methods of a plan projection, a front projection, and a side projection respectively indicating projection directions. Then, a table of contents of the plan projection method (FIG. 22), a table of contents of the front projection method (FIG. 23), and a table of contents of the side projection method (FIG. 24) were created separately from the classifications according to different projection methods, and jump functions from these newly created tables of contents to respective drawings were enabled. Further, jump functions (of the “Present” TOC link of the setting regions 99 from FIG. 25 to FIG. 28) from the Present TOC (not illustrated) to the drawings and from the drawings to the “Present” TOC link were enabled, thereby allowing a user to jump between the Present TOC link and the drawings on the respective pages and layers. Furthermore, jump functions (of “New” TOC link in the setting regions 100 from FIG. 25 to FIG. 28) from the “New” TOC link to the drawings and from the drawings to the “New” TOC link were enabled, thereby allowing a user to jump between the “New” TOC link and the drawings on the respective pages and layers.

(10.204 Effects)

The electronic files based on the new system thus completed allow a user to selectively view and extract the plan view, the front view, and the side view, and/or for example, drawings with respect to floors, Streets, and Avenues with ease. Therefore, this new system makes it possible to selectively extract and provide only required drawings, for example, drawings of rooms, to a resident of an apartment planning to repair his or her interior construction, thereby eliminating the needs of providing the complete set of drawings. Accordingly, the new system can protect the privacy of other residents, and provide conveniences for the resident who would like to confirm areas that need to be reformed since he or she can selectively and directly view and confirm necessary drawings with his or her own eyes. This leads to the fact that the resident can estimate costs required for reforming according to a category of constructions by directly viewing and confirming the drawings.

(10.209 not Illustrated; Stitching Order of Completion Drawings)

Now, again, in regards to order of procedures, the completion drawings handed over from an architectural contractor are laid out in the order of textile design drawings, structure drawings, and facility drawings, as described above. The textile design drawings are further divided into textile design drawings themselves, and window drawings. The textile design drawings are further divided into a plan textile design, a front textile design, and a side textile design. The plan textile design consists of a first floor plan view, a second floor plan view, a third floor plan view, and a fourth floor plan view. Next, the window drawings, i.e., joinery layout drawings are arrayed, and individual joinery tables are described, and then transitioned to a front view and a side view of the textile designs. Furthermore, the cross-sections and sectional details at respective base lines are arrayed in the order of “A”, “B”, “C”, “D”, and “E”, and/or “1”, “2”, “3”, and “4”. By this way, the textile design drawings end. Subsequently, the structure drawings are arrayed, and finally the facility drawings are arrayed, and all drawings are stitched together.

(10.210 not Illustrated, Disadvantage of Stitching Order of Completion Drawings)

This arrangement of drawings is often classified according to names in view of generally well-known types of contraction works, and thus users can gradually become accustomed to the order of the arrangement. However, a drawback is encountered that Structure Drawings (Structure), Steel Bar Arrangement Drawings (Bar Arrangement), Electrical Equipment Drawings (Electric Equipment), Gas Piping Drawings (Gas), Piping Drawings (Pipe), Sanitary Facility Drawings (Sanitary), and Venting Facility Drawings (Vent) each utilizing the first stage floor drawings (iFroor) in FIG. 22 are stitched respectively at positions away from one another, thereby making it difficult for a user to examine the respective drawings with one another.

(10.211 Replacement of Stitching Order of Plan Projection Method in FIG. 21)

In view of the aforementioned drawback, drawings are rearranged name by name so that a user can confirm which projection method is applied to the concerned drawing, and how the concerned section is cut off from the drawing. For this purpose, a projection method is described at the highest segment of the name so that a user can immediately recognize what projection method is applied to the concerned drawing, only by seeing names of drawings. Subsequently, from which part the concerned section of the drawing is cut off is described at the lower segment of the name so that a user can immediately recognize what from which part the concerned section of the drawing is cut off, only by seeing names of drawings. In this manner, the drawings are re-arrayed. For example, outside drawing of the building shown in in FIG. 21, in regards to apparent names, plan views for respective floors were expressed as i, ii, iii, iv, and the front view Street base lines were expressed as A, B, C, D, and side view Avenue base lines were expressed by 1, 2, 3, 4. The symbols −, + of the front view Street base lines mean exterior of the building. In addition, in this expression, the same shall also apply to the symbols −, + of the side view Avenue base lines.

(10.211.01 Replacement Example of Stitching Order of Plan Projection Method in FIG. 21)

Then, for example, <°1°1i°1Design>, was employed as a segment partly constituting an underlying name corresponding to the apparent name was employed since the segment suggests that the drawing consists of a plan projection method drawing <°1°> to be layered out firstly, a first floor <°1i°>, and a textile design drawing <1Design> to be layered out firstly. Similarly, <°2°2-°B2°Windows> was employed as a plurality of segments partly constituting a name since the segments suggest that the segments consist of a front projection method <°2-°> to be layered out secondly, a base line number <B>, and a joinery drawing <2°Windows> to be layered out secondly. Similarly, <°3/°23°Development> was employed as a plurality of segments partly constituting a name since the segments suggest that the segments consist of a side projection method <°3/°> to be layered out thirdly, a base line number <2>, and a development view <3°Development> to lay out thirdly.

(10.212 Horizontal Ordering on Plan Projection Method in FIG. 22)

Then, FIG. 22 illustrates tables of contents which allow a user to compare drawings arrayed on the same line. The drawings were created in accordance with the same projection methods respectively indicating the same projection direction. For example, on a line of the setting region 91 in FIG. 22 (iFloor in FIG. 22), the above various drawings represented by the plan projection method are all placed on one horizontal line 91, thereby making it possible for a user to easily compare and examine the drawings represented by the same projection method within a short period of time. This means that textile design drawings (Design), joinery drawings (Windows), structure drawings (Structure), bar arrangement drawings (Bar Arrangement), electrical equipment drawings (Electric Equipment), gas piping diagrams (Gas), piping diagrams (Pipe), sanitary facility drawings (Sanitary), and venting facility drawings (Vent) each utilizing the floor plan at the first floor (iFroor) are all plan views. Furthermore, these arrangements (the setting region 91) are the basis for creation of horizontal verbatims (the regions 100 from FIG. 25 to FIG. 28) at jump destinations.

(10.212.01 Two-Dimensional Table of Contents on Plan Projection Method in FIG. 22)

Furthermore, four sheets of Design drawings are placed vertically in the setting region 92, which is aligned perpendicular to the horizontal line 91, in the order of a floor plan on the first floor (i Floor), a floor plan on the second floor (ii Floor), a floor plan on the third floor (iii Floor), and a floor plan on the fourth floor (iv Floor), thereby allowing a user to jump one after another multilaterally and compare the respective drawings with ease. Especially the recent drawing preparation method of laying one layer upon another allows application drawings to be overlapped as layers on the same basic drawings, and makes it possible for a user to use a number of the same basic drawings in turn several times as different kinds of drawings. This means that the same basic drawings are employed while user's eye line can be maintained the same as described in the previous embodiment, the user's eye line is naturally directed to movement destination with attention before and after jumping, and thus the user's recognition ability will be enhanced. In this manner, the table shown in FIG. 22 is constituted by two-dimensional tables of contents including horizontal and vertical tables of contents.

(10.213 Horizontal Arrangement of Drawings Created by Front Projection Method in FIG. 23)

Next, building front views are similarly extracted from the completion drawings as illustrated in FIG. 23, in order to create tables of contents by placing priority to classification according to drawings at which positions of “A”, “B”, “C”, “D”, and “E”, each of which is a column base line that cuts Street, are designated. For example, when the building is cut from above at position D, the drawing of →D is a drawing cut at position D spot and viewed from C side having a light source from the base line of C. On the contrary, the drawing of D→ is a drawing cut at position D spot and viewed from E side having a light source from the base line of E. Further, these arrangements (the setting region 93) are also the basis for creating horizontal verbatims (the setting regions 100 from FIG. 25 to FIG. 28) at jump destinations

(10.213.01 Two-Dimensional Tables of Contents on Front Projection Method in FIG. 23)

Furthermore, FIG. 23 includes seven drawings (the region “D” in FIG. 23), which are cut at position D and vertically placed, in the order of design drawing (Design), joinery drawing (Windows), development view (Interior Development), detail drawing (Sectional Detail), pile drawing (Pile), column drawing (Column), and bar arrangement drawing (Bar). This means that FIG. 23 indicates a screen view configured such that these drawings cut at the same position are vertically arrayed (e.g., on the setting region 94) extending perpendicularly to the horizontal verbatims, thereby allowing a user to jump one after another and to easily compare the various drawings. FIG. 23 indicates a screen view also configured for two-dimensional tables of contents having horizontal and vertical tables of contents.

(10.214 Horizontal Ordering on Side Projection Method in FIG. 24)

Similarly, FIG. 24 indicates a screen view having tables of contents created by placing priority to classification according to drawings at which position of “1”, “2”, “3”, and “4”, each of which is a column base line that cuts Avenue in FIG. 21, are designated. For example, when the building is cut at position 3 from above, an oblique arrow mark of an obliquely extending leftward-downward arrow mark [Formula 1] indicates a light source from the base line of 4. 3 [Formula 1] indicates a drawing cut at a position 3 spot and viewed from 4 side. On the contrary, an oblique arrow mark of an obliquely rightward-upward arrow mark [Formula 2] indicates a light source from the base line of 2, and the drawing of [Formula 2] 3 is a drawing that is cut at a position 3 spot and is viewed from 2 side. The drawing attached with + and − in the setting region 95 is an outside drawing viewed from the outside of the building. Furthermore, these arrangements (e.g., in the setting region 95) serve as the basis for horizontal verbatims (the regions 100 from FIG. 25 to FIG. 28) at jump destinations.

[symbol]

[Formula 1]

[symbol]

[Formula 2]

(10.214.01 Two-Dimensional Tables of Contents on Side Projection Method in FIG. 24)

Furthermore, FIG. 24 indicates a screen view including eight sheets (the setting region 96), vertically arrayed and respectively indicative of drawings cut at position 3, consisting of design drawing (Design), joinery drawing (Windows), development view (Interior Development), detail drawing (Sectional Detail), pile drawing (Pile), column drawing (Column), bar arrangement drawing (Bar), and elevator drawing (Elevator). This means that FIG. 24 includes drawings configured such that the drawings cut at the same spot are vertically aligned (for example, in the setting region 96) in a manner extending perpendicularly to the horizontal verbatims, thereby allowing a user to jump one after another and to easily compare the drawings cut at the same spot. In this manner FIG. 24 indicates a screen view also configured as two-dimensional tables of contents having tables of contents arranged two-dimensionally.

(10.215 FIG. 25 Through FIG. 28)

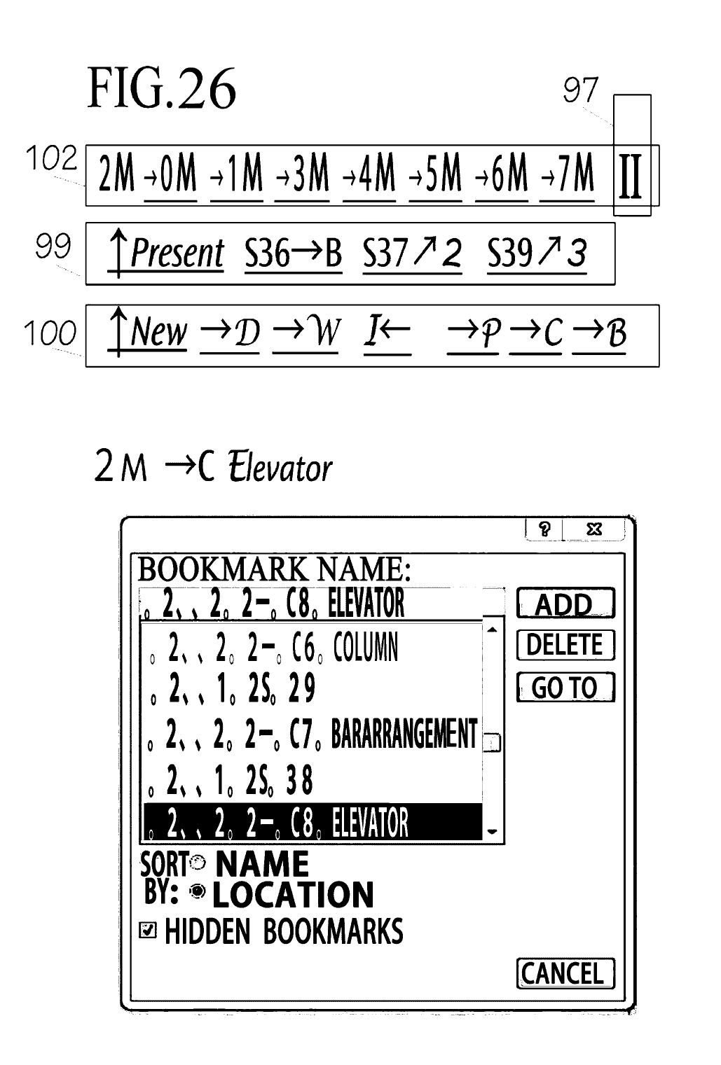

FIG. 25 to FIG. 28 are views of the same screens that allows a user to jump thereto from C Elevator provided at the bottom of the setting region 101 in FIG. 23 (front view). Among those, FIG. 25 is an inherent screen. Then, names of two anchors are assigned such that the left one of the two anchors provided at right-top in FIG. 25 allows a user to jump thereto from the present table of contents, and the right one allows a user to jump thereto from the new table of contents. For this reason, as illustrated in FIG. 26, if the names of anchors provided in the setting region 97 at right-top in FIG. 25 are placed in the location order, the names of anchors of two types of the present system and the new system will appear alternately. It is to be noted that in the three sheets shown in FIG. 26 to FIG. 28, the names start with <°2>. However, <°2> is a character added to the head of names to refer to a situation two minutes after the conversion to 4 dimension (hereinafter referred to as “4D”), which will describe at the Section (10.30). Therefore, description continue until the description of 4D (10.30) assuming that name begins with a growth point of <^{aa}>.

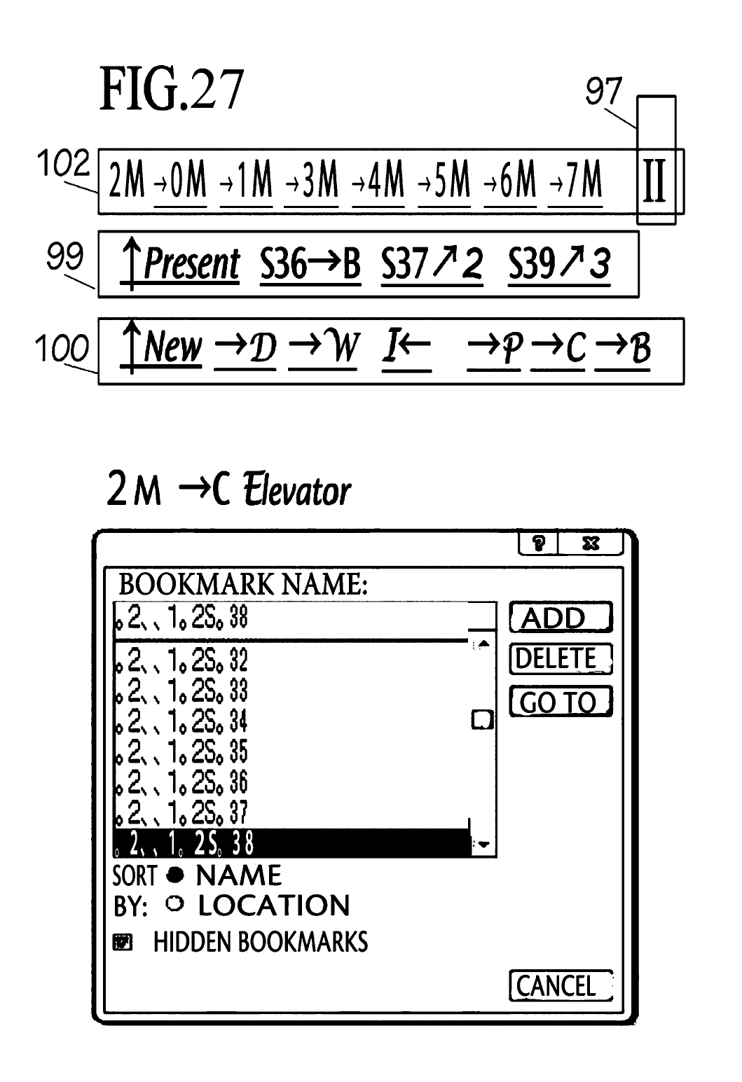

(10.216 FIG. 27)

FIG. 27 is a figure in which a left side anchor of two anchors (the setting region 97) located at right-top in FIG. 25 is selected and anchor names are placed in the name order in the arrangement of the Present completion drawings. A character of a segment of name of anchor allowing a user to jump to from the table of contents (not illustrated) of the Present completion drawings is set as <^{aa}1°>, and is distinguished from <^{aa}2°> which is a character of a segment of name of the anchor allowing a user to jump to from the table of contents of a new replacement system, so that character codes of the names assigned to the Present drawings are made always smaller than the anchor names assigned to the new replaced drawings.

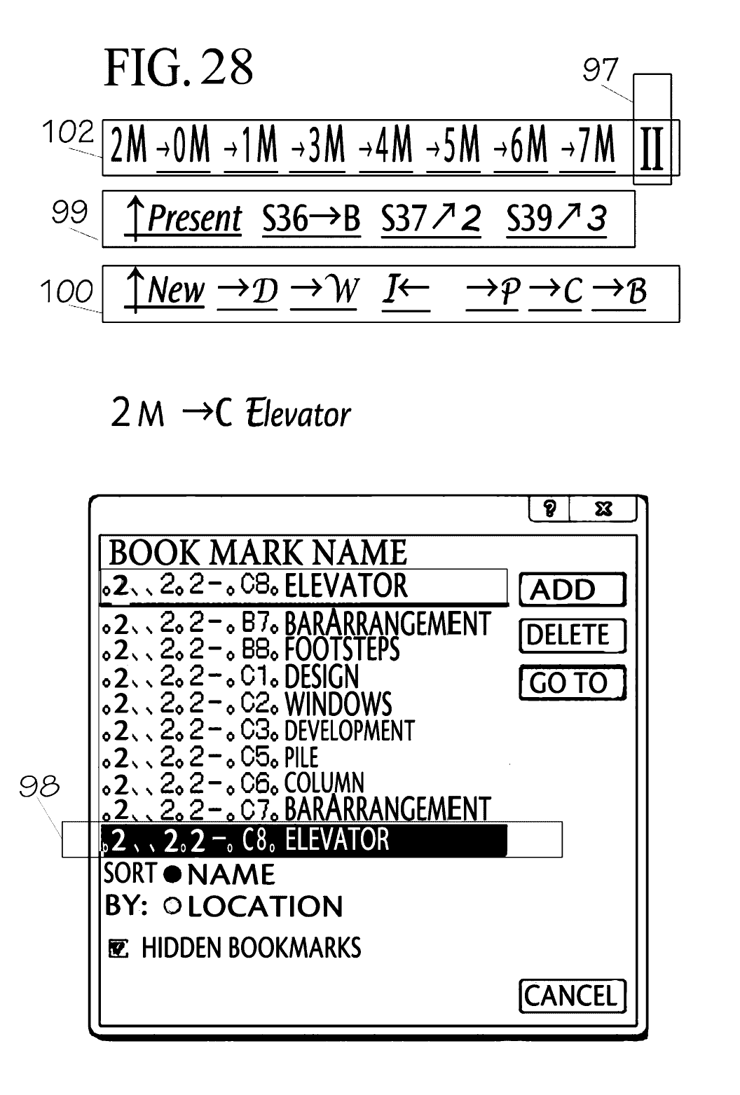

(10.217 Figures from Anchor in FIG. 28)

Finally, in FIG. 28, a right side anchor out of two anchors (the setting region 97) located at right-top is selected, and anchor names are placed in the name order, in the arrangement of drawing order after New replacements. The lower level part (the setting region 98) of the names is <2-°C8°ELEVATOR>, in which ┌<2-> is read. Symbol <-> is an abbreviation for a street front view, and <2> next to the plan view <1> which is the first drawing method is added as a control character of the front view which is the second drawing method. The next <C> is a number of Street, and the Elevator Drawing is relocated at the eighth place <8> of front views at <C>. This indicates that if Design of the setting region 101 in FIG. 23 is on the first line, C is present on the eighth line which is the final line, and the jump function is enabled from the Elevator.

(10.217.01 Description of the Second Lines in FIG. 25 Through FIG. 28)

The description hereinafter is directed to sciences on respective second lines (the setting regions 99) in FIG. 25 through FIG. 28. The sciences 99 shown in in FIG. 25 through FIG. 28 are equal to one another. However, anchors corresponding to the sciences on the respective second lines are located at left-hand side of the anchors of each of the first lines which are different from the first lines of respective drawings. This means that the anchor in the Present system is set up at the left side of the anchors on the first line.

(10.217.02 Description of Jump Function on the Second Lines in FIG. 25 Through FIG. 28)

The description hereinafter is directed to the jump function on the second lines (the setting regions 99) in FIG. 25 through FIG. 28. ↑Present at the top of the respective second lines allows a user to jump to the table of contents of the Present completion drawings (not illustrated). The next “S36→B” belonging to the same science allows a user to jump to “B” base line drawing of the “→B” front view Street of a structure drawing (Structure) which is the completion drawings having the sum total drawing numbers 36. The next [Formula 3], which has S37, 2, and an obliquely upward-rightward arrow mark intervening between S37 and 2, allows a user to jump to “2” base line drawing of [Formula 4] side view Avenue, which has an obliquely upward-rightward arrow mark, of a structure drawing (Structure) which is the completion drawings having the sum total drawing numbers of 37. The last [Formula 5], which has an obliquely upward-rightward arrow mark, allows a user to jump to “3” baseline drawing of [Formula 4] side view Avenue, which has an obliquely upward-rightward arrow mark, of a structure drawing (Structure) which is the completion drawings having the sum total drawing numbers of 39.

“S37 [symbol] 2” [Formula 3]

[symbol]

[Formula 4]

“S39 [symbol] 3” [Formula 5]

(10.217.03 Exclusion of the Link of Interest

At this stage, S38 is excluded since the drawing of interest is located below. From the fact that the arrangement of the second line is contiguous in terms of the present drawing numbers 36, 37, 39, as described above, it is to be understood that the setting region 99 is used for assisting a user in jumping to the drawings in the order of the present completion drawings. In the case in which the drawing of interest is located below, the drawing of interest is excluded from a science for the same reason as the case of international treaties or conventions.

(10.217.04 Jump Function for Return)

Though not illustrated, a science such as shown on the first line in FIG. 25 may be arrayed on the second line in the screen, and make it possible for a user to jump for returning from the other screen to the present screen.

(10.218 Description of the Third Lines in FIG. 25 Through FIG. 28)

The description hereinafter is directed to sciences on respective third lines (the setting regions 100) in FIG. 25 through FIG. 28. The sciences 100 shown in in FIG. 25 through FIG. 28 are equal to one another. However, anchors corresponding to the sciences on the respective third lines are located at right-hand side of the anchors of each of the first lines which are different from the third lines of respective drawings. This means that the anchor in the New system is set up at the right side of the anchors on the first line.

(10.218.01 Relationship Between Vertical C Array and the Third Line in FIG. 23)

Jump functions on the third lines in FIG. 25 through FIG. 28 allow a user to directly jump to respective jump destinations of vertical C array (the setting region 101) in FIG. 23 which is a table of contents, and to allow the user to compare one with another. This means that ↑New at the top of the respective third lines belonging to sciences in FIG. 25 through FIG. 28 is a TOC link for allowing a user to return to new table of contents and jump to a table of content of the front view in FIG. 23. The next →D allows a user to directly jump to a jump destination of →C in FIG. 23 without referring to any table of contents. Similarly, the next →W allows a user to directly jump to a jump destination of →C that is the joinery drawing (Windows) in FIG. 23 without referring to any table of contents. Similarly, the next l→ allows a user to directly jump to a jump destination of →C that is development view (Interior development) in FIG. 23 without referring to any table of contents. Similarly, the next →P allows a user to directly jump to a jumping destination of →C that is a pile drawing (Pile) in FIG. 23 without referring to any table of contents. Similarly, the next →C allows a user to directly jump to a jumping destination of →C that is a column drawing (Column) in FIG. 23 without referring to any table of contents. Similarly, the next →B allows a user to directly jump to a jumping destination of →C that is a bar arrangement drawing (Bar Arrangement) in FIG. 23 without referring to a table of contents.

(10.218.02 Exclusion of the Link of Interest)

When the drawing of interest is arranged below, the link of interest from the science is excluded in the same manner as the case of international treaties or conventions. This means that →C of Foot Step and Elevator in the region 101 in FIG. 23 is excluded from the region 100 in FIG. 25. Furthermore, though not illustrated, a science such as shown on the first line in FIG. 25 may be arrayed on the third line in the screen, and make it possible for a user to jump for returning from the other screen to the present screen.

(10.31 Creating New Highest Segment Forward of the Highest Segment of Name)

In respective drawings shown in FIGS. 25 through 28, a new verbatim, i.e., a new hyperlink structure according to the present patent application is used in the new first lines of the setting regions 102. More specifically, in the previous description referring to FIG. 21 through FIG. 24, only anchor was placed in the setting region 102. On the other hand, the present description referring to FIG. 25 through FIG. 28, two anchors for hyperlinks of the second line and the third line are provided on the first line, and hyperlinks for the first line were not provided in the first lines in FIG. 25 through FIG. 28. If conversion to 4D is performed, hyperlinks having a concept of time are placed on the first lines in all drawings from FIG. 21 to FIG. 28 to form a new verbatim (corresponding to the setting region 4 in FIG. 1). Thus, hereinafter, a creation method thereof will be described.

(10.32 Features of New Names)

The first line of the new verbatim, focused on apparent names thereof, has a concept of time such as 0M, 1M, and 2M, viz., 0 minute, 1 minute and 2 minutes (the setting regions 102 in FIGS. 21 through 28). Furthermore, it is to be understood that alignment of the names created as a result of combination and addition have in the field code the highest segments indicative of time (e.g., <°2> after 2 minutes). For example, FIG. 26 shows name of anchors having <°2, 2°2-°C8°ELEVATOR> that is formed by adding <°2>, which suggests 2 minute, to higher segments of the name of the anchor <^{aa}2°2-°C8°ELEVATOR> attached to the material of interest. Before adding <°2> to the higher segments, the leading control regions of underlying names of anchors had growth points of <^{aa}> (<^{aa}> in FIGS. 26 through 28).

(10.33 Advance Processing on Existing Second and Third Lines)

At the time of creation, a double continuous growth point of <^{aa}>, which is even solecism according to the Japanese grammar, and usually never exists in XML statements in other areas, are selected to ensure errorless replacement utilizing the growth point. This means that while the growth point remains attached, for example, while <°0^{aa}> is replaced with <0> minute at the highest segments of the names. Through this replacement, <0> minute is added. As a result thereof, the highest segments of new underlying names of sciences in an old system and in a new system are added to underlying names of all hyperlinks and anchors in a file which are provided as shown in FIG. 25 through FIG. 28. Here, the old system consists of a plurality of hyperlinks group on the second line and an anchor at the left side of the anchors on the first line, and the science in a new system consists of a hyperlinks group on the third line and an anchor at the right side of the anchors on the first line, which are existing, in FIG. 25 through FIG. 28, are added to underlying names of all hyperlinks and anchors in a file. Furthermore, since this replacement applies to the whole files, the anchors on the first lines of the existing table of contents parts from FIG. 21 to FIG. 24 changes as well.

(10.34 A Method of Changing Names which does not Burden on PC)

Certainly, batch changing can be performed from XML to the names of all hyperlinks and anchors in the file. However, in some cases, it is preferable to divide the processing into several steps in order to reduce the load of personal computer (herein simply referred to as “PC”) and to shorten the time required for processing. This is because even in the case of processing the same underlying names, the processing for replacing the names while field code side is opened causes less load of PC than the processing for replacing the names while XML side is opened regardless of whether the underlying names of hyperlinks or anchors.

(10.35 Method of Changing Names Using Growth Points)

Thus, the procedure for the processing is divided into several steps. First, when <°0> is added to the new highest segment of the underlying names of hyperlinks after the field codes are opened by simultaneous pressing ALT+F9, a check mark “ambiguous search” is removed, and growth points are attached. This means that <^{aa}> is attached before replacement and <°0^{a}′^{a}> is attached after replacement. Here, an apostrophe is used for the sake of improving the reliability of replacement.

After completing evacuations of the second line and the third line by this processing, <^{aa}> before replacement, and <°0^{aa}> after replacement are attached to the two anchors of interest arrayed in first line (the regions 97 in FIG. 25 through FIG. 28) respectively corresponding to the second line and third line and changing material from docx format to zip format, zip format to document.xml format. In this manner, the two anchors should be changed simultaneously.

(10.36 Method of Changing Names Performing Evacuations)

As already described, when underlying names of hyperlinks are partially replaced, an apostrophe <′> is added. For example, <°0^{aa}> should be changed to <°0^{a}′^{a}>. If a material is partially replaced with certain characters as a key, the replacement is carried out on the material uniformly regardless of whether the concerned characters constitute a part of the hyperlinks or the anchors. This means that any names appearing in document.xml will be partially replaced if the names include the concerned characters. In order to avoid erroneous replacement from occurring, names having the concerned segments but not intended to be changed should have been evacuated in advance so that only the conversion target should be replaced from the document.xml. Upon completion of replacing only the names of anchors, the process returns to the processing of restoring the hyperlinks. The apostrophe is removed from <°0^{a}′^{a}>. This means that, similar to the previous processing, for example, after the field codes are opened by simultaneous pressing ALT+F9, <°0^{a}′^{a}> is replaced with <°0^{aa}>. Then, <°0> is added to the names as the new highest segment. In this manner, the names are arrayed on the second line and the third line, and, to the state before <°0> is added, the jump function is established.

(10.37 Combining Names in the New Verbatim on the First Line)

The above-described processing is completed, by adding <°0> to anchors (two anchors in the regions 97) as the new highest segment. Then, a hyperlinks group is created. On the hyperlinks group, apparent names “→1M” to “→7M” except for anchors in verbatim regions in the first lines in FIG. 21 to FIG. 28 and the underlying names added with <°1> to <°7> other than <°0> at the new highest segment respectively suggesting different times are created. At this time, only an apparent name of the name of “0M” is created. The hyperlinks thus created are arrayed on the first line. In this case, as described earlier, it is only necessary to create the combined name added with new time at the higher segment (10.32).

(10.38 Method of Creating Combined Names)

Now, in regards to a method of creating the above-described combined underlying names, firstly, apparent names of 0M to 7M of a hyperlinks group are created in the regions 102 from FIG. 21 to FIG. 28 in 0 min state since fire breaks out are created in advance. Then, by using adjacent left and right cells in the spreadsheet software, <°1> is set to the name to be added at the highest segment of the anchor for the left cell, and existing names are copied in the name order, as the name of the right anchor in the region 97 in FIG. 28 is selected, into the right cell thereof. In order to create names respectively indicative of different times, after inputting, for example, as <^{aa}2°2-°C8°ELEVATOR>, seven same names are created by copying <^{aa}2°²-°C8°ELEVATOR>, and then, the numeric values <°1> to <°7> are attached thereto while <^{aa}2°2-°C8°ELEVATOR> is remained as it is. The names thus created are copied as only text format with no style. These procedures are worked on the Word format (the Registered Tradename Word of Microsoft). Subsequently, the names continue to be created in such a manner that left and right segments are combined on the Word format. Then, the names thus created are arrayed one after another as underlying names of →1M through →7M in the regions 102 in FIG. 21 through FIG. 28.

(10.38.01 Completing One File for 0 Minute at the Time when Fire Broke Out)

In this manner, firstly, one file in a state of 0 minute is completed. In the file, names composed of <°1^{aa}2°2-°C8°ELEVATOR> through <°7^{aa}2°2-°C8°ELEVATOR> are arranged as underlying names of links respectively representing 1 to 7 minutes after fire broke out in verbatims. Minute 0 represent a time at which fire broke out. The new first line verbatim could be called a verbatim in a narrow sense in comparison with a science in a narrow sense in which two anchors are arranged. However, the new first line thus created does not yet have any jump destination.

(10.39 the Effect of the Highest Segments of Names Spreading to the Second Line and the Third Line)

Once one file is completed including a verbatim region in a narrow sense in which two anchors having 0 minute as basic are arranged, based on this file, it is possible to perform transitions in sequence from 0 minute to seven minutes, by using the scheme completing one-round method of changing the highest segment of names, i.e., “changing underlying name of next link” (9.18, 12.25) which is the Third Process (9.00). This scheme is applicable to processing of creating a new verbatim while performing evacuations by using the scheme for completing one-round method of changing the highest segment of names (which will be described below 12.20). This schema is also applicable to processing of opening the field codes and adding the same new highest segment uniformly to the same names provided in the same file.

(10.40 Spreading Effects)

Therefore, owing to processing scheme to open the field codes and replacing the segments, it should be noted that the effects are concurrently exerted on respective second lines (the setting regions 99) and respective third lines in FIG. 25 through FIG. 28. Since time is not represented in apparent names of hyperlinks, a user may be puzzled. Certainly, unlike on the apparent names of the respective first lines in FIG. 22 through FIG. 28, 0 min or 1 min indicative of the time is not described in the apparent names of the respective second lines (the setting regions 99) and the respective third lines (the setting regions 99) in FIG. 25 through FIG. 28. However, upon creating different files by the scheme for completing one-round method of changing the highest segment of names (which will be described below 12.25), the highest segments of the underlying names of each file are changed such that not only the first lines, but also, the respective second lines and the respective third lines provided in the same file, having growth points <^{aa}> are changed. For this reason, upon opening the field codes, and selecting <°0^{aa}>, and replacing <°0^{aa}> with <°1^{aa}>, the effects of the changes are uniformly and simultaneously exerted on the respective second lines and the respective third lines. As a result thereof, names of jump destinations are uniformly attached at the higher segments of underlying names. Description directed to evacuation of the names performed in the process of replacing will be omitted.

(10.41 Features of Jump Function Caused by New First Lines)

In this way, owing to the scheme for completing one-round method of changing the highest segment of names, when different files are created, because they were copied while the arrangement remains as it is, even if →1M on the first lines causes a user to jump to →2M, the arrangements of sciences of the respective second lines and the respective third lines remain the same as they are before and after the jump operation. Similarly, before and after a jump operation from a hyperlink of the respective second lines or the respective third lines, apparent names remain the same before and after the jump operation because the new first lines are created. Furthermore, since segments of the names which are the same as the first lines are added to even the second lines and third lines, even when a hyperlink of the second lines and the third lines is caused a user to jump, the user can jump to a destination not exceeding the range of an elapsed time of →1M or →2M indicated on the apparent names arranged on the same first lines. In order to allow a user to jump to a destination in which different elapsed time is indicated, it is necessary to change a verbatim link on the first lines to links other than the link of interest.

(10.42 Converting Non-Science Lines into Science(s))

FIG. 21 through FIG. 28 show an example in which regions of sciences can be created, if a predetermined replacement is performed to a material of a field other than multi-language international treaties or conventions. Unlike the case of international treaties or conventions, it may be more often the case in which, like architectural drawings, the lower segments of names are not numerals, the number of characters is also not the same, and it is difficult to proliferate the names by the Second Process. Therefore, significance of discovery would be great such that there is a margin within which sciences can be created with respect to any material other than Articles/Clauses in which the lower segments of names of international treaties or conventions are comprised merely of numeric values. Even if it is difficult to proliferate the names by the Second Process, executing the Third Process using the scheme for completing one-round method of changing the highest segment of names is quite effective and can greatly shorten the time required to create hyperlinks.

(10.50 Example of Electronic File Having a Story)

An electronic file having data link structure generated by the above-described generation apparatus 50 can change story configuration of not only language books but also books of other fields. Unlike FIG. 1, FIG. 29 and FIG. 30 show one example of other electronic files having a material having a story line. In the electronic files illustrated in FIG. 29 and FIG. 30, respective sciences make it possible for a user to compare translations of respective languages. Unlike the electronic files illustrated in FIG. 29 and FIG. 30, a plurality of sciences may be provided separately so that a user can jump to a screen describing a story different from or further deepened from the present story.

(10.51 Reedition of Tables of Contents of Books)

Furthermore, it is also convenient for conversation or exchanging information to collect different versions of travel guide books in respective languages and make files out of them in the form of verbatims. For this purpose, the arrangement of verbatims in new first lines shown in FIG. 21 through FIG. 28 is applicable. Furthermore, other than tables of contents that are edited only for the sake of travel destinations, tables of contents can be created in the order of time and seasons, for the various purposes of travels such as SPA hot spring or fishing or entertainments, Such tables of contents allow a traveler to sequentially and directly jump from one topic to another on the materials, and make it possible for a traveler to be introduced into different versions or editions although the same books are utilized. It is also possible to create a number of different stories in respective languages in connection with the existing books and make it possible for a reader to compare them with one another (FIG. 29, FIG. 30). Furthermore, it is also possible to isolate different systems one from another by using two different anchors on the new first lines in FIG. 25 through FIG. 28. By using a technique of the second lines or the third lines in FIG. 25 through FIG. 28 each time the purpose of edition changes, sciences may be also created separately at respective pages according to the purpose of editions and provide a user various kinds of sciences allowing the user to jump to a various kinds of anchors thereby improving user's convenience. If there arises any differences between requests from an author and a reader, the author may attempt to explain the reader the whole editions of the material and his (or her) proposal, and make the reader compare the editions and the proposal. In this manner, the author and the reader may reach the mutual understanding on the final edition, thereby increasing customer's satisfaction can be increased.

(10.52 Replacing Basically Arrangement Order of Materials of Books)

According to the present invention, for example, in a case of a lawbook, categories of definitions, requirements, purport, effects, and the like conventionally described separately from one another can be combined with one another by the verbatims in the order of, for example, definitions, requirements, purports, effects, and the like. The verbatims make it possible for a user to selectively refer to and utilize each category for specific purposes and/or applications at the disposal of the user.

(10.53 Saving Method Having a High Effect Per Processing Time)

Furthermore, company manuals can be also combined with one another by the verbatims so that a user can selectively refer to and compare respective parts of company manuals. Using this system, a user can create a report and send the report to a customer in a short time since the user can promptly find and collect concerned information with ease.

(10.60 Hyperlinks for Preventing Falsification)

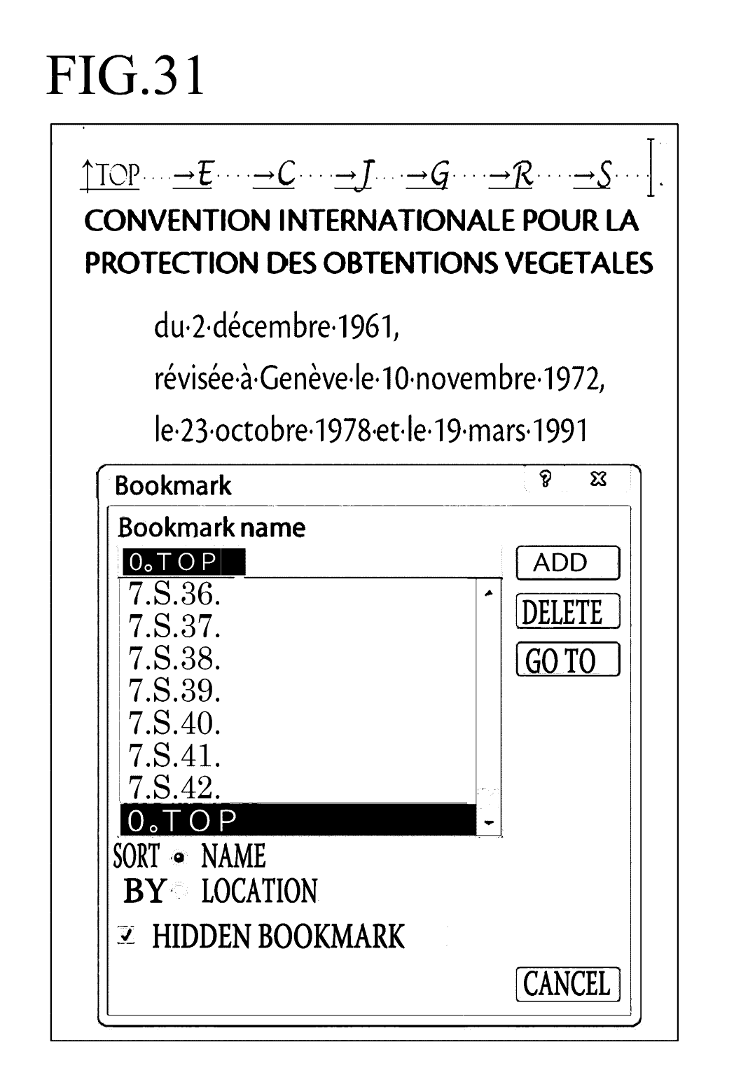

It is possible to directly change a document.xml without evacuating any data link structures comprised of a combination of hyperlinks and anchors included in the already-combined names 72C in FIG. 5, which the generation apparatus 50 has executed, and utilize the changed document.xml for another purpose. For example, if the hyperlink structure in a file is created by converting full width characters into half width characters from the document.xml, using characters such as, for example, dots or dashes that cannot be created, for example, from MS Word as a word processor, the file thus created can be convenient since such the links can be prevented from being modified by an unauthorized person. The names described with characters such as, for example, dots or dashes are convenient because it is difficult to insert such characters from the state in which extension is docx, and therefore, it is possible to prevent any kinds of falsification of anchor names from occurring. More detail will be described hereinafter with reference to FIG. 31.

(10.61 Embodiment for Preventing Falsification; UVOP)

For example, the electronic file illustrated in FIG. 31 has UPOV Convention (International Union for the Protection of New Varieties of Plants) as a material, and anchor names included in this electronic file are operated from xml. Firstly, extensions of docx are converted into zip, and extracted “document.xml” from a folder to the outside, and conversion is performed using Web page creation software.

(10.61.01 Effect of Preventing Falsification)

In this case, it is possible to input names, for example, names starting with half-width numeric values, which cannot be input as an anchor name in the operation of ordinary MS Word. Then, even when the names abruptly start with numeric values, there is a phenomenon that MS Word which is the same product as a document browsing viewer software can display the names. Furthermore, in regards to input of dots, if the dots are inputted to a place other than the leading control region (83 in FIGS. 6A through 6D), then jump function is enabled. Even in such a state, the jump function can be confirmed by MS Word as the viewer software. In addition, in the case of PDF, jumping is established. Then, in this manner, if a character or character type which is prohibited by World Wide Web Consortium is employed as characters which divide segments of underlying names of both anchors and hyperlinks, it is possible to prevent hyperlinks of documents from being falsified. Since <0°> in FIG. 31 is full-width unlike half-width <0°>, it is displayed at the end in the name order. In FIG. 31, the names were created in a purposeful manner so that a user can find that half width characters are placed in the preceding line followed by an anchor of <0> of full width character and <0°> is arranged at the end.

(10.62 Modification which Violates the Name Rules or the Name Eligibility)

The electronic file 1, which was created as a result of combining a plurality of files into one file by the final combining unit (79 in FIG. 5), can be modified, by replacing, for example, 1 with Japanese one “ [symbol] ”, 2 with Japanese two “ [symbol] ”, and 3 with Japanese three “ [symbol] ” by editing document.xml. Then, when the order of Japanese one, two, and three viz., “ [symbol] ”, “ [symbol] ”, and “ [symbol] ” is sorted by spreadsheet software, they are sorted in the order of “ [symbol] ”, “ [symbol] ”, and “ [symbol] ”, and jump functions are enabled. Furthermore, batch deletion of <°> cannot be done from document.XML since <°> is used in Japanese materials. However, <°> can be deleted from document.XML since <°> is not used in Western sentences and jump functions of hyperlinks are enabled except for the TOC link. This means that names that cannot be divided into segments are created if, for example, <°> is employed. Further, even if a full width character is changed to a half width character (FIG. 31), a jump function is enabled. This means that it is possible to modify verbatims so that the verbatims do not follow the name rules or the name eligibility after completion of the verbatims. However, since it is difficult to return to the former state after the modification because the modification is irreversible change similarly to a case of UVOP, the present embodiment is useful for preventing falsification.

(10.70 One Example of an Electronic File for Comparing Many People's Opinions)

FIG. 32 shows one example of another electronic file having verbatims or sciences for comparing many kinds of information, unlike FIG. 1, and FIG. 29 through FIG. 31. This kind of verbatim or science makes it possible for a user to compare, for example, images of respective facets of a diamond with one another. This means that, in a case of, for example, a brilliant-cut diamond having 58 facets, images of respective facets can be located at respective pages. The verbatim or science shown in FIG. 32 allows one facet to show on a page with hyperlinks group referring to another facets linked through the verbatim or science, thereby assisting a user in minutely analyzing and comparing one facet with another linked through the verbatim or science. In this way, reflections, colors, flaws, workmanship of cuts of the respective facets of the diamond can be carefully assessed along with their images, and the grade of the diamond can be accurately determined. This kind of electronic file can be created, by firstly creating 64 sets of hyperlinks, and thereafter, decreasing 64 sets of hyperlinks to 58 sets, then completing the setting regions having the hyperlinks referring to respective faces of the diamond, so as to be suitable when images are compared in the respective faces.

Likewise, this kind of the electronic file thus created can be employed as an assessment tool for analyzing many people's opinions for the purpose of, for example, administrative management. The verbatim or science shown in FIG. 32 allows opinions of respective persons to display on respective pages linked one another through the verbatim or science, and makes it possible for a user to accurately analyze and compare an opinion of one person with another.

### 11. Precautions about Electronic File Creations

Precautions about creations of electronic files will be described hereinafter.

(11.00 Edition on Field Codes)

FIG. 33 is a display example when edition is performed on field codes. If ALT+F9 buttons are pressed simultaneously on MS Word, the field codes are opened, and names of hyperlinks can be edited. Here, “Fuzzy Search” should be disabled. If replacement is performed on the field codes including the hyperlink names in the already-created names 72C, CPU will be less loaded, and it will become possible to perform batch changing of several thousands of hyperlink names within only a few seconds.

(11.10 Aligned Display of Field Codes)

However, in the screen illustrated in FIG. 33, it is very hard to read due to disordered display of field codes. Therefore, in the electronic file 1, 55A, or 72A, for the purpose of aligned display of underlying names of links in the setting region 3, the names should be preferably constant in string length. In this case, by adjusting indentation, it is possible to display the names in alignment, and it becomes easy to maintain and reuse the hyperlinks. For example, while browsing the electronic file 1, 55A, or 72A using a small-sized smartphone screen, the auto word wrapping function is available to display the field codes vertically in alignment by setting the line length as appropriate. Thus, it becomes possible to easily and rapidly recognize whether the hyperlinks are correctly arranged, and the names can be displayed distinctively and intelligibly. Thus, when checking whether the hyperlinks are generated properly and orderly, a user may easily check if sequence of the names is correct in terms of order, with direct and visual check only, without using any technique of mouse-over. Further, if this principle is applied, the names of the hyperlinks can be confirmed within a short time using the whole of a display area in a wider range than the mouse-over.

(11.20 Efficiency of Proliferation)

Here, “proliferation” is intended to mean a process of duplicating an entire set of sciences acquired as a result of proliferating segments lower than a particular segment, and changing the particular segment to a next value. Therefore, each time of proliferation, the number of entire sciences is doubled. Thus, the higher the particular segment is, the more efficient the proliferation can be performed.

Furthermore, processing of replacing <°1F°°> with <°2°°> is faster than processing of replacing <°1F°°01°01> with <°2E°°01°01>. While generating names the burden of PC can be decreased if the least number of characters are selected, and then, names of anchors and hyperlinks are changed and saved using different names. In this manner, the considerable number of changes can be performed.

(11.21 Merits and Demerits of XML Texts)

In the proliferation processing, CPU is less loaded if the least number of target characters are selected, which enables quick replacement of many names. As described above, for example, if <°1F> is selected to be replaced with <°2E>, processing time will be reduced in comparison with a case in which <°1F°°01°01> is selected to be replaced with <°2E°°01°01>. However, the proliferation performed on document.xml has both merits and demerits. One of the merits is that both hyperlinks and anchors can be proliferated at once. On the other hand, one of the demerits is that XML includes variety of ASCII characters, and accordingly, replacing ASCII characters has a risk of conversion error. Therefore, by using full width characters for the names, it is possible to eliminate the risk of conversion error.

(11.22 Full Width Characters to Prevent Erroneous Conversion)

In the present embodiment, a single quotation (apostrophe) is employed as an evacuation character to be inserted into a name to be evacuated. However, any character may be employed as the evacuation character, since the evacuation is only a temporary change and eventually restored. Accordingly, the role of preventing erroneous conversion can be served not by the evacuation character described in the present application. Any kinds of unusual characters and/or letters can serve the role of preventing erroneous conversion, and therefore, should be always included in the replacement target. Here, “always” is intended to mean “before and after the evacuation”. Therefore, only the punctuations such as <°>, which are full width characters rare to be found in XML texts, can serve the role of preventing erroneous conversion.

(11.30 Conscious Input of Full Width Characters is Needed)

When full width characters are inputted, Auto Correct function of MS Word should be disabled. Otherwise, full width alphanumeric characters will be replaced with ASCII characters, which will constitute a different name. The same is true when any other word processor having similar function is employed.

(11.40 Batch Changing of Names)

The XML file includes both hyperlinks and anchors, which are simultaneously changed by means of “Replace All” function. The above effect is convenient for doubling the sciences in the Second Process. However, in the Third Process, in which the TOC link and the next link are exchanged, it is required to perform “Replace All” function with special care.

(11.50 Creation of TOC Link)

In the Third Process, in which a plurality of language versions are proliferated, a first set of sciences for a particular language (e.g., French) version is completed, and the first set is proliferated six times to acquire seven sets for seven languages. In the first place, the tables of contents are created, and the TOC links are enabled to jump to the tables of contents, which means the completion of the first set of sciences.

(11.60 Names of TOC Links and Anchors)

Although, in FIG. 18, FIGS. 19C and 19D, FIG. 34B, and FIG. 35A and 35B, it has been described that the underlying name of the TOC link starts with <°1F°> (for the French version), the underlying name of the TOC link may start with <°1F^{a}>, as can be assumed from FIG. 16 and FIGS. 17A to 17C. While, on the other hand, the underlying name of the anchor of the material always starts with <°1F°>. Here, <^{a}> plays two roles. Firstly, <^{a}> can serve a role of the sort key to cause the anchors of the tables of contents to precede the anchors of the material in the name order. Secondly, <^{a}> can serve a role of clearly distinguishing the names of the TOC link and the anchor in one science.

(11.70 Roles of Punctuation 85)

The punctuation 85 also serves the roles of the sort key and of distinguishing the segments of the names. In addition, the punctuation 85 has another important role. By replacing <°°> with <°00°°>, a new segment can be added. This means that, similar to the growth point of plants, the punctuation 85 plays a role of the growth point. Therefore, the punctuation 85 may also be referred to as “the growth point”.

(11.80 Editor for Editing XML Files)

To edit the XML files, it is not necessarily required to use MS Word. A web editor may be employed to quickly edit the XML files.

(11.81 the Purpose of Substitute Photographs)

The pictures substituted for drawings (FIGS. 15 and 18) show how XML actually manages names of hyperlinks and anchors. FIG. 15 proves that it is possible to proliferate the names of hyperlinks and anchors simultaneously, and FIG. 18 proves that it is possible to proliferate the names of anchors alone.

(11.90 Manual Creation of Sciences)

In the above-described embodiment, names are to generated by utilizing the dedicated program 55C which has been installed in the HD 55 of the generation apparatus 50 in FIG. 4, and the already-combined names 72C. However, names may be generated manually in accordance with inputs from users, without using the dedicated program 55C and the already-combined names 72C. In this case, In this case, as the number of anchors is increased, time required to select an anchor is increased. On the other hand, the anchors have to be associated without fail. The procedure which satisfies the both requirements will be given as below.

(11.91 Anchors should be Prepared in Advance)

There are four prerequisite conditions for the manual creation of the sciences. In the first place, the entire anchors are already arrayed in one file in accordance with the name rule. In the second place, the sciences at the four turning points are already created for all languages, i.e., the apparent names of the hyperlinks are created as shown in FIG. 6E, and the underlying names of the hyperlinks are created for each turning point. In the third place, the anteroposterior relationship among the links is maintained the same throughout the entire verbatims. In the fourth place, the TOC link of the language that is excluded from the links in the verbatim is created so as to be arrayed at the head of the science. Subsequently, simple work is started by copying one set of the science except for the anchor to the next location.

(11.91.01 Replacing Anchor with the Next Anchor)

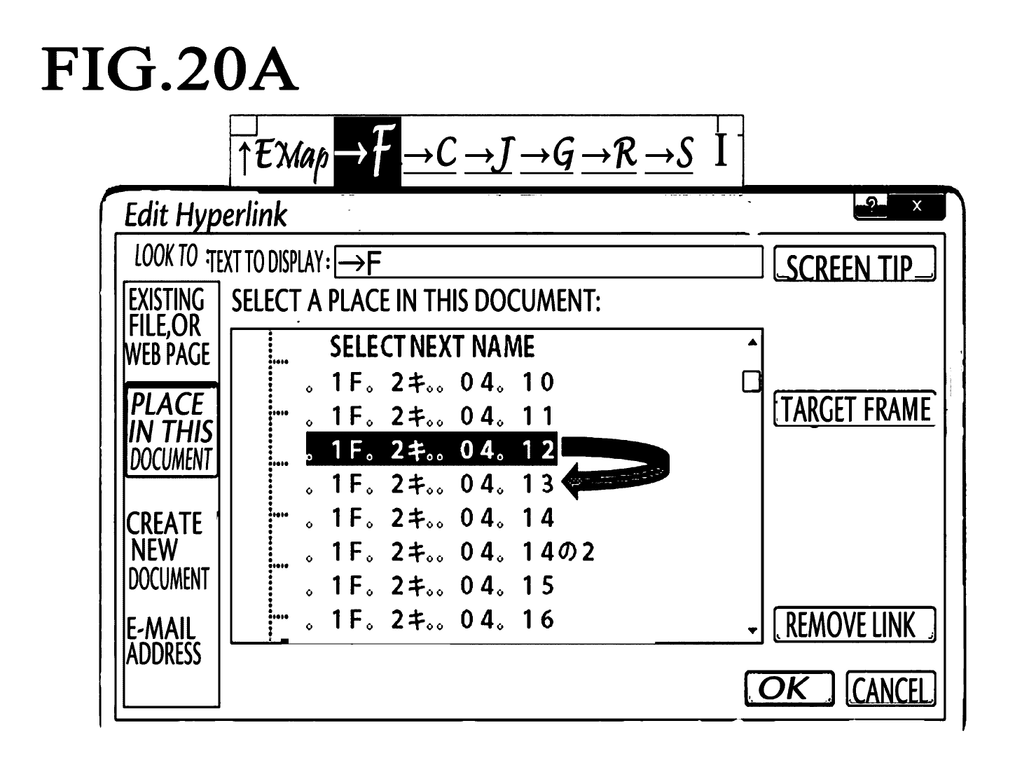

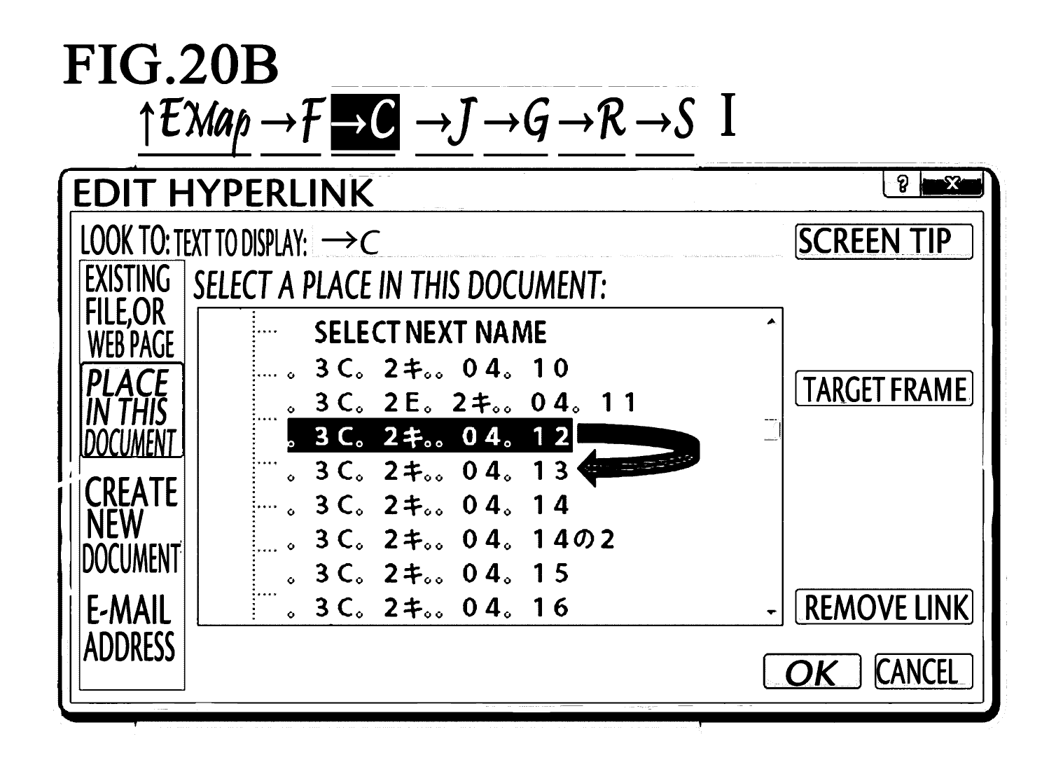

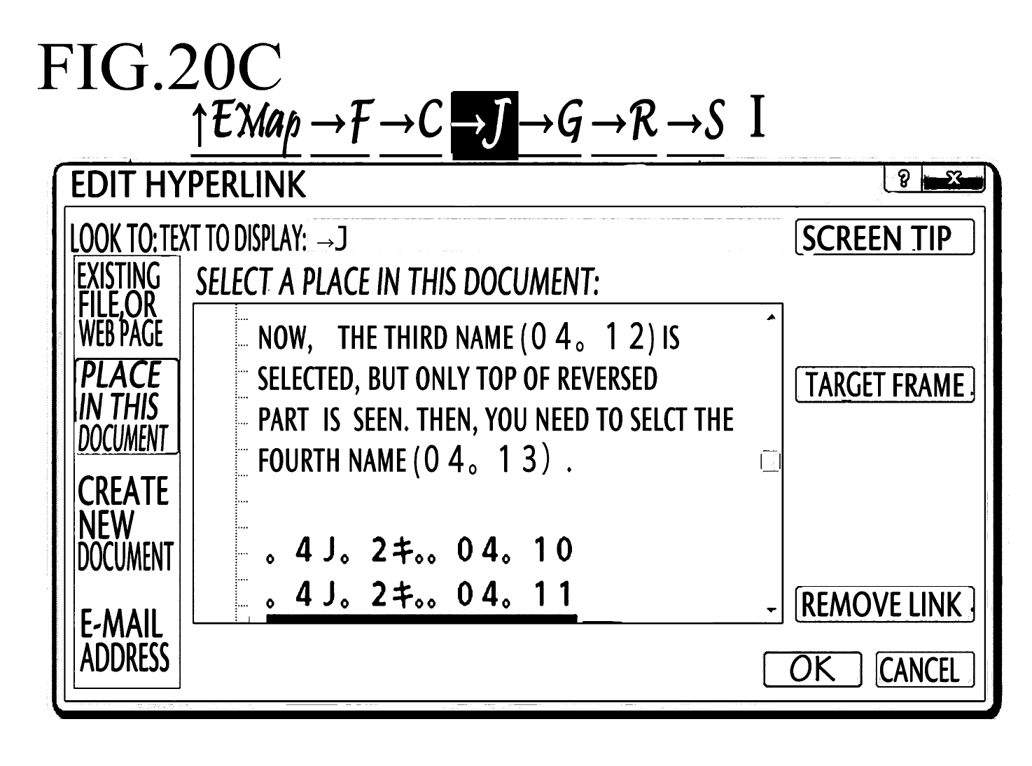

Subsequently, for each link in the copied science, the destination anchor is replaced with the anchor listed next as shown in FIGS. 20A to 20C. When “Edit Hyperlink” screen is opened, the current destination anchor is selected as default. According to the name rule, the name order, in which the anchors are listed, in accordance with the location order, and the copied science is created for the next location. Accordingly, the new name to be selected for the copied link is the anchor listed next. To replace the anchor for French version, since the default selection is Regulations under the PCT Rule 4.12 for French, it suffices to select the next Rule 4.13 as shown in FIG. 20A, and click “OK”. Similar operations are applicable to Chinese version as shown in FIG. 20B, and for Japanese version as shown in FIG. 20C. Thus, it is very easy to replace the destinations correctly in respective languages.

(11.92 Consistency of Names to be Checked)

Needless to mention, it is required to carefully change the link destinations. However, even if a link should be mistakenly changed, as long as the links to other languages are correctly changed, the resultant science will not be consistent any more, and as a result, it can be recognized that the Article/Clause regions of the names are not the same as the other links. Therefore, it is easy to find any mistake.

(11.93 Supplementary Creation by Manual Operation)

However, the above described manual operation will only be required to supplement the sciences. For example, location intervals of sciences have been determined initially in view of the lengths of sentences of Chinese or Japanese texts of a material. However, it has been found out that the lengths of sentences of corresponding German or Russian texts of the same material are very long. As a result, there arises a need for supplementary sciences. In that case, to support the manual operation, the instruction information receiving unit (the region 73 in FIG. 5) that receives any of setting region generation instruction, proliferation instruction, name changing instruction, save instruction, final combination instruction, and/or the like, from users, will be used.

### 12. Summary of Name Proliferation

In the following, the creation of the electronic file by way of proliferation will be summarized.

(12.00 Processing by the Name Changing Unit 76)

The proliferation processing of names by the name changing unit 76 is largely divided into two parts: one is to replace higher segments (the highest segment 84 representing languages and the second highest segment 88 representing conventions); and the other is to replace the lower segments representing Rules and Clauses.

(12.10 Processing of Lower Segments)

The processing by the name changing unit 76 starts with the processing on the lower segments, in which the sciences are repeatedly doubled until the required amount of sciences are acquired.

(12.11 Methods of Proliferating Lower Segments)

The name changing unit 76 may employ a few different methods of proliferating the lower segments (the second lowest segment 86 and the lowest segment 87 in FIGS. 6A and 6C) of the names.

(12.12 Single Digit Proliferation)

If the number of Clauses is single digit, the method of proliferation is very simple. For example, assuming that a set of names respectively having the lowest digit of the lowest segment 87 being n to m is referred to as (n:m), and (n:n) is abbreviated as (n), a set (1) is repeatedly doubled to (1:2), (1:4), and (1:8). In the last case of proliferation, “Replace” is repeated four times, i.e., the numbers 1 to 4 are respectively replaced with 5 to 8. If the number 9 is needed, the original set (1) is duplicated, changed into (9), and added to (1:8), thereby acquiring (1:9). However, if the number of Clauses is ten or more, it is preferable to employ different methods as described below.

(12.13 Decimal Method of Proliferation)

To cope with multiple digit numbers, the number of digits should be determined in the first place. If the number of Clauses does not exceed 99, the lowest segment 87 having two digits may suffice. Here, one method of proliferating two digit numbers is as follows. Assuming that a set of names respectively having the lowest segment 87 being nn to mm is referred to as (nn:mm), and (nn:nn) is abbreviated as (nn), after a set (01) is twice doubled to (01:04), the original set (01) is duplicated, changed into (05), and added to (01:04). The resultant (01:05) is doubled to (01:10), which is repeatedly doubled to (01:20), (01:40), and (01:80). More particularly, in the last case, when acquiring (41:80) from (01:40), “Replace All” is repeated five times, i.e., 40 is replaced with 80, and the numbers 0 to 3 in the first digit are respectively replaced with 4 to 7. Incidentally, to complete (01:99), a subset (01:19) is duplicated, changed into (81:99), and added to (01:80).

(12.14 Hexadecimal Method of Proliferation)

However, the above described method is strongly confined by a decimal way of thinking. For example, using hexadecimal numbers, and starting the number with 00, it becomes possible to more efficiently proliferate the numbers. More particularly, if a first set (00) is doubled four times, the result is (00:0F). Here, 00 represents Clause 1, and 0F represents Clause 16. A name is only a sign, and it suffices as long as a one-to-one mapping is possible between the name and the number represented by the name (in this case, the hexadecimal name is to be converted into decimal and incremented by 1). Furthermore, by doubling four more times, it is possible to acquire (00:FF). Here, the final proliferation to acquire (80:FF) from (00:7F) requires only eight times of “Replace All” processing, i.e., the numbers 0 to 7 in the first digit are respectively replaced with 8 to F. This means that the lowest segment 87 can express up to Clause 256 by using only two digits, if the hexadecimal number system is employed.

(12.15 Processing of Second Lowest Segment)

The second lowest segment 86 represents Rule numbers. A method of proliferating Rule numbers is similarly understood from the foregoing described method. The only difference is that “Replace All” should be performed in place of “Replace” when proliferating the lower digit of the second lowest segment 86, since the replacement target is not only one but the entire sciences that has been proliferated as described above.

(12.20.01 Processing of Highest Segment)

After the proliferation of the lower segments is completed, the highest segment 84 is to be proliferated, which is no longer a matter of simply doubling of numbers. It is required to add the six language versions one by one to the first language (French) version.

(12.20.02 Processing of Second Highest Segment)

Before starting the proliferation of the highest segment 84 (representative of languages), the second highest segment 88 (representative of treaties or conventions) may be proliferated in a case in which a plurality of treaties are to be combined together. Since different treaties have different contents, the result of the Second Process with regard to a treaty can only partially be reused in proliferating with regard to another treaty. This means that the Second Process should be carried out over again each time of proliferating the second highest segment 88.

(12.20.03 Order of Processing of Highest and Second Highest Segments)

Since languages and treaties are not hierarchically layered, there is no order between proliferation of the highest segment 84 and proliferation of the second highest segment 88. If the second highest segment 88 is proliferated first, then a complete set of entire treaties is acquired for each language. As a result, the complete set is proliferated for the entire languages. While, on the other hand, if the highest segment 84 may be proliferated first, then a complete set of entire language materials may be acquired for each treaty, and then the complete set may be proliferated for the entire treaties. Thus, the order may be determined based on the purpose of editing the finally combined file.

(12.20.04 Definition of Round Robin Proliferation)

Here, the term “round robin” will be defined for descriptive convenience. Using a set of sciences for a previous attention language, another set of sciences for a next attention language is proliferated in a manner such that, in the name of the TOC link and the name of the anchor, the highest segment 84, representative of the previous attention language, is changed so as to represent the next attention language, and in the name of the hyperlink that has been referring to the next attention language, the highest segment 84 is changed so as to refer to the previous attention language. Furthermore, the above process is repeated for the entire languages. Hereinafter, the entire repetition of the proliferation will be simply referred to as “a round robin proliferation of the highest segment 84”.

(12.21.05 Full Set of Hyperlinks as Alternative to Hyperlinks Group)

It has been described that the hyperlinks group is acquired by excluding one link from a full set of hyperlinks. Here, the “full set of hyperlinks” is intended to mean the links to materials of the entire seven languages. Furthermore, the “one link” is the hyperlink referring to the attention language and will be referred to as “the self-referential link” hereinafter. However, the exclusion of the self-referential link is not necessarily required, and the full set of hyperlinks may be arranged in the setting region 5 of each verbatim.

(12.21.06 Merit of Full Set of Hyperlinks)

In this case, the verbatims before and after jumping will appear identical regardless of what language is currently displayed. As a result of this, the jumping operation becomes easier, since a link to a specific language appears always at a same position.

(12.21.07 Self-Referential Link May be Grayed Out)

The self-referential link causes a jump to own location thereof and apparently doesn't function at all. Although it is harmless, it may be required to indicate that the self-referential link doesn't function. For example, the self-referential link may be grayed out, which has a side effect of causing the user to be aware of the attention language (i.e., which language material the user is in).

(12.21 Self-Referential Link May be Deleted)

Alternatively, the self-referential link, which actually doesn't function, may be simply deleted, the result of which is equivalent to the hyperlinks group of the present embodiment. However, a timing of the deletion makes a big difference. For example, if the self-referential link is not deleted until the Third Process, the description of the Third Process will be very simple. In this case, the full set of hyperlinks are prepared in the First Process and proliferated in the Second Process, and the resultant names are saved in a file, which will be referred to as “the original full set file” hereinafter. Henceforth starts the Third Process, which greatly differs from the present embodiment and therefore will be referred to “the alternative third process” hereinafter.

(12.21.01 Alternative Third Process)

In the alternative third process, the complete set of sciences for each language version is created from the original full set file. This means that, the proliferation of the highest segment 85 is repeated for seven languages (French to Spanish). Each time the attention language is sequentially switched from among the seven languages, the names of the TOC link and the anchor are changed so as to refer to the new attention language, the new self-referential link (referring to the new attention language) is deleted, and the resultant names are saved as the currently being created names 72B for each language.

(12.21.02 Demerit of Alternative Third Process)

Since the result is equivalent, the alternative third process described above, which is easier to understand, may have been employed in place of the Third Process. However, the alternative third process has a demerit in that it requires to save the original full set file, and to repeat the proliferation seven times.

(12.22 Reconsidering of Third Process)

The Third Process of the present embodiment can be conceived as a result of eliminating the need of saving the original full set file and the first time proliferation (of the French version). The Third Process of the present embodiment can be conceived of the following process: Using the currently being created names 72B for French, the original full set file can be restored by inserting the previous self-referential link (referring to the French material). Subsequently, the next self-referential link (referring to the English material) is deleted, thereby acquiring the currently being created names 72B for English. Actually, the insertion and deletion can be performed at once by changing the hyperlink referring to the next attention language (English) so as to refer to the previous attention language (French).

(12.22.01 how to Describe Third Process)

Hence the description of the Third Process of the present embodiment as the round robin proliferation: While an attention language is sequentially switched among the entire languages, the language in the names of the TOC link and the anchor in each verbatim are changed from the previous attention language to the next attention language, the hyperlink referring to the next attention language is changed so as to refer to the previous attention language, and the resultant set of sciences is saved as a new electronic file in sequence.

(12.22.02 Reason to Employ Third Process)

It is not so easy to understand the above description of the Third Process as the clear description of the alternative third process. However, it has been already proven that both are equivalent. This is the reason why the Third Process, which has no need of the original full set file and the first time proliferation (for French), is employed in the present embodiment.

(12.22.03 Deletion and Restoration of Hyperlinks)

As an anchor is transitioned in such a manner that a segment of the underlying name of the anchor is incremented by one, for example, 1F to 2E, a hyperlink replenished in correspondence to the anchor is restored in such a manner that a segment of the underlying name of the hyperlink corresponding to the anchor is decremented by one, for example, 2E to 1F. This means that apparent names and underlying names are both changed in the similar way.

(12.22.04)

(12.40)

(12.50 Unique Names)

Conventionally, it has been extremely difficult to replace a great number of character strings without any errors, especially in a case in which an enormous amount of texts of XML file is to be replaced. However, in the present invention, by inserting scarcely used characters such as full width characters into the name of the anchor, it becomes possible to eliminate erroneous replacement.

(12.60 Replacements of Higher Segments of Names)

The description so far has been directed to replacement of the highest segments of names. However, the present invention is limited to the highest segments of names. In place of the highest segments of names, for example, intermediate segments of names may be replaced in a round robin manner. This means it is possible to replace the highest segments of names, for example, respectively indicative of languages, and intermediate segments of names, for example, respectively indicative of articles, paragraphs, or the like in a round robin manner as long as lower segments of the names remain the same. Therefore, in place of “replacement of highest segments in a round robin manner”, or “replacing highest segments in a round robin manner, “replacement of higher segments in a round robin manner”, or “replacing higher segments in a round robin manner is applicable.

(13.00 the Fourth Process)

In the present application, description has been provided by dividing the process into three parts. However, there is an additional process of combining different files into one file upon the completion of three processes. This process is named as the “Fourth Process”. The Fourth Process is carried out at the end of the First Process for creating one line of science or verbatim, the Second Process of proliferating names by proliferating lower segments of the names of the science or verbatim, and the Third Process of replacing higher segments of the names thus proliferated. The feature of the Fourth Process is that each time a file is combined in the ascending order of the character codes of names of anchors in accordance with the name rule, the number of jump destinations increases. For example, when two different files are combined together, two jump destinations are established and the total number of jump destinations can be calculated by 2(2−1). This means that assuming that N stands for the number of files, and N files are combined together, the total number of jump destinations, which one sciences or one verbatim provides, can be calculated based on the formula of N (N−1). Thus, when 64 files are combined together, for example, in a case shown in FIG. 32, the total number of the jump destinations, which one science or one verbatim provides, can be calculated by 64(64−1). This means that 4032 jump destinations will be established as a result of combining 64 files for each science or verbatim. According to the present embodiment, as shown in FIG. 32, extremely large number, i.e., 4032 of links can be established among 64 files.

(13.10 Automatic Duplication)

As for hyperlinks, as long as names of the hyperlinks are properly described, a jump function can be established, and a process of replacing names of the Third Process represented with dotted lines in FIG. 6E are performed only on a part of a verbatim or science. In that case, “a part of” used herein does not mean a segment of a name, but refers to each link unit of a plurality of links in the region of a science or a verbatim. For example, when a science in which “F” on the first line of FIG. 6E is a TOC link is replaced with a science in which “E” on the second line of FIG. 6E is a TOC link, “↑F” is replaced with “→F”, and “→E” is replaced with “↑E”, but other links, i.e., →C, →J, →G, →R, →S links remain the same. In this manner, a science on the second line of FIG. 6E is created. This means that →C, →J, →G, →R, and →S of the second line are created merely by duplicating →C, →J, →G, →R, and →S of the first line as they are. When the previous link of interest, for example, “E” is replaced with a new link, an anchor of “E” is created based on the new link by replacing a higher segment of a name of the second line of the new link, i.e., “E” is replaced accordingly. This principle is applicable to an example shown in FIG. 32.

(13.20 Hyperlinks to be Automatically Duplicated)

In an example case described with reference to FIG. 6E, transitions are performed six times after the first science has been created. If the first science having, for example, 64 hyperlinks is created, the Third Process of replacing only two parts is performed 63 times. This means that by only performing Third Process 63 times, jump functions to all files will be established. In this case, while remaining the names of the hyperlinks as they are, 63 hyperlinks are copied on different files. Each time a files having 64 different anchors is combined with another file, new jump destinations appear on the same file, the jump functions are enabled, and the number of jump destinations is increased. Then, in the Fourth Process, the number of jump functions thus enabled is increased according to the formula of N (N−1) for one science or verbatim, wherein N stands for the number of files. After the completion of combining 64 files, 4032 jump destinations are established and 4032 jump functions are enabled for one science or verbatim.

(13.30 Features of Hyperlinks)

As will be understood from the foregoing description, new hyperlinks are established and jump functions are enabled only by copying both apparent and underlying names of the hyperlinks and partially replacing the apparent and underlying names of the hyperlinks.

(13.40 Other Embodiments)

According to the present invention, various kinds of embodiments may be possible. Especially for materials which require a user to review a large amount of volume and compare cross-references, according to the present invention, a user can easily review and compare the materials in small details while a visual line of the user is kept stable. For example, according to the present invention, error numeric values sent from a specular reflection target for error measurement pasted on a prototype antenna of telescope can be managed with respect to names for each reflection target. In this case, higher segments of the names may be respectively assigned to the specular reflection targets and lower segments of the names may be assigned to locations where error measurements are stored or listed. Sometimes, a large number of targets, e.g., 256 reflection targets may be managed. Even if data of the reflection targets is transferred to a relational DB and processed with a super computer, the data will be simply partitioned target by target, and the measured results will be stored. On the other hand, according to the present invention, specular reflection targets and error measurements can be well viewed and compared. Therefore, abnormal numeric values can be selectively discarded or reprocessed, and thus, distortions of all the targets can be more easily corrected, thereby making it possible for a super-computer to process them far more efficiently in sequence and to provide appropriate results. In this case, the present invention provides a preservation frame and a fetch frame. Also, precautions made up of long sentences can be recorded as character information so that they can be easily viewed and compared in a manner not available by the relational DB,

(13.50 Implementing on Measuring Instruments)

Furthermore, according to the present invention, regardless of applications, every measurement result can be preserved and referred to so as to cover all of the measurement results. At that time, since the principle is simple such that names are arrayed in the Order (in character code order) in accordance with the name rule (character code order), and a plurality of files are combined in name order (in character code order) of anchors, it is possible to give birth to software of new measuring instruments. Architectural drawings can be also verified from a plurality of points of view, by placing a plurality of anchors on the name system.

(13.60 Implementing on Document.htm)

Furthermore, the present specification has been described as document.xml, but it is possible to implement on the whole regions handling hyperlinks and anchors, and as a result, it is, of course, possible to implement on document.htm.

(13.70 Embodiment in which Exclusion of the Link of Interest is not Executed)

The various embodiments have been described focused on cases in which the exclusion of the link of interest is executed. However, the present invention is not limited thereto. According to the present invention, the link of interest may remain in the verbatim part as it is without being excluded from the verbatim part (setting region 4) and placed at a position of the TOC link (setting region B). In this case, the embodiments described with reference to FIG. 16, FIGS. 17A, 17B, and 17C may be modified, for example, in such a manner that steps S22, S24, S27, and S29 required for placing the link of interest at the position of the TOC link and the steps S23 and S28 required for excluding the link of interest from the verbatim part are omitted, and the remaining three steps S25, S26 and S30 are executed. This means “′” is inserted into segments of any and all similar underlying names from the field code in step S25 only for the purpose of securely replacing the names of the anchors in the step S26, and in the step S26, the names of the concerned anchors are uniformly changed. After the names of the concerned anchors are changed, “′” is removed in step S30. Since the link of interest has not been excluded, it is not necessary to restore the names of the hyperlinks. In this manner, higher segments of the names of the anchors are replaced, and the anchors are transitioned for all of the verbatims.

### DESCRIPTION OF REFERENCE NUMERALS

1, 55A, 72A . . . electronic file
A . . . anchor
B . . . TOC link
3 . . . science
4 . . . verbatim
5 . . . hyperlinks group
6 through 11 . . . link 1 through link 6
50 . . . electronic file generation apparatus
71 . . . name control unit
72 . . . storage unit
72A . . . currently being prepared names
72B . . . currently being created names
72C . . . already-combined names
73 . . . instruction information receiving unit
74 . . . name generation unit
75 . . . name proliferation unit
76 . . . name changing unit
77 . . . name evacuation setting unit
78 . . . name combining unit
79 . . . final combining unit
81 . . . subject region
82 . . . Article/Clause region
83 . . . leading Punctuation (leading control region)
84 . . . highest Segment
85 . . . punctuation (growth point)
86 . . . second Lowest Segment (lower level region)
87 . . . lowest Segment
88 . . . second Highest Segment (intermediate segment, intermediate region)

1. An electronic file structure configured to include a setting region having a name of an anchor indicative of a predetermined location, and a name of a hyperlink that refers to the anchor, which are not present on the same file at an initial stage of generation, the setting region is independent from a material, wherein
a verbatim jump is enabled by combining a plurality of different electronic files respectively having higher segments of names of the hyperlinks and the anchors replaced in a round robin manner into one.

2. The electronic file structure according to claim 1, wherein
by utilizing the fact that names of the anchors and the names of the hyperlinks are divided into several segments and having growth points, when the segment of the name is changed, an existing segment is changed by selecting the segment having the growth point, and adding a new segment thereto.

3. The electronic file structure according to claim 1, wherein
when the names of the hyperlinks in verbatim regions are opened from field code side, character strings of the names of hyperlinks are aligned by means of auto word wrap function so that the differences among the character strings are properly laid out.

4. The electronic file structure according to claim 1, wherein
a part of the names of anchors and a part of the names of hyperlinks in verbatim regions employ character types the use of which is prohibited by World Wide Web Consortium.

5. A non-transitory computer-readable storage medium for storing a computer program for controlling an electronic file generation apparatus operative to generate an electronic file structure configured to include a setting region having a name of an anchor indicative of a predetermined location, and a name of a hyperlink that refers to the anchor, which are not present on the same file at an initial stage of generation, the setting region is independent from a material, wherein
a verbatim jump is enabled by combining a plurality of different electronic files respectively having higher segments of names of the hyperlinks and the anchors replaced in a round robin manner into one.

6. The non-transitory computer-readable storage medium for storing the computer program for controlling the electronic file generation apparatus according to claim 5, wherein
a part of names of anchors and a part of names of hyperlinks in a verbatim region employ character types the use of which is prohibited by World Wide Web Consortium.

7. An electronic file generation apparatus operative to combine a plurality of electronic files into one, thereby enabling a verbatim jump multilaterally, wherein
the electronic file generation apparatus comprising:
a name generation unit operative to generate, in a source electronic file, a verbatim setting region having a name of an anchor allowing a user to be jumped to from a hyperlink to be set up in a destination electronic file that is not yet created at an initial state, but will be combined with the source electronic file into one through final combination, and a name of a hyperlink allowing a user to jump to the destination electronic file that is not yet created at the initial state, but will be combined into one through the final combination;
a name proliferation unit;
a name changing unit operative to execute round robin proliferation of higher segment to the names;
a storage unit operative to store a plurality of electronic files that have been changed by the name changing unit; and
a final combining unit operative to execute final combination of the plurality of the electronic files stored in the storage unit into one electronic file, wherein
upon the final combination, the names of the hyperlinks and the names of the anchors are combined with each other, thereby enabling verbatim jumping among the setting regions.

8. The electronic file generation apparatus according to claim 7, further comprising:
an instruction information receiving unit operative to receive any of a setting region generation instruction, a proliferation instruction, a name changing instruction, an evacuation setting instruction, a save instruction, a combination instruction, and a final combination instruction from a user.

9. The electronic file generation apparatus according to claim 7, wherein
while the round robin proliferation of higher segment is executed by the name changing unit, the names of the hyperlinks belonging to a hyperlink groups in the verbatim region excluding a link of interest are replaced in a manner such that,
a name of a hyperlink which becomes the same as a name of an anchor is excluded from the hyperlinks group and a name of a hyperlink which has been previously excluded from the hyperlinks group is restored at a position at which the previously excluded hyperlink has been placed upon processing carried out in an increasing order of aft character code of the hyperlinks group of the verbatim, and
a new verbatim is created sequentially on a new electronic file while the hyperlinks are excluded and restored one after another.

10. The electronic file generation apparatus according to claim 7, wherein
the verbatim setting region is copied to another file in a manner that the hyperlinks are arrayed in an order that anteroposterior relationship among the hyperlinks in the setting region is not reversed.

11. The electronic file generation apparatus according to claim 7, wherein
a part of the names of anchors and a part of the names of hyperlinks in verbatim regions employ character types the use of which is prohibited by World Wide Web Consortium.

12. The electronic file generation apparatus according to claim 7, further comprising:
a name proliferation unit operative to create one file by combining data before change and data after change.

13. An electronic file generation method comprising the steps of:
generating, in a source electronic file, a verbatim setting region having a name of an anchor allowing a user to be jumped to from a hyperlink to be set up in a destination electronic file that is not yet created at an initial state, but will be combined with the source electronic file into one through final combination, and a name of a hyperlink allowing a user to jump to the destination electronic file that is not yet created at the initial state, but will be combined into one through the final combination;
proliferating names;
executing round robin proliferation of higher segment to the names;
storing a plurality of electronic files that have been changed by the name changing unit; and
executing final combination of the plurality of the electronic files stored in the storage unit into one electronic file, wherein
upon the final combination, the names of the hyperlinks and the names of the anchors are combined with each other, thereby enabling verbatim jumping among the setting regions.

14. An electronic file which is generated in accordance with the electronic file structure according to claims 1 to 4.

15. An electronic file generated by executing the computer program stored in the non-transitory computer readable storage medium according to claims 5 to 6.

16. An electronic file generated by the electronic file generation apparatus according to claims 7 to 12.

17. An electronic file generated by the electronic file generation method according to claim 13.
